(19) United States
(12) Patent Application Publication
(10) Pub. No.: US 2024/0092655 A1
(43) Pub. Date: Mar. 21, 2024

(54) METHOD FOR FORMING POSITIVE ELECTRODE ACTIVE MATERIAL AND SECONDARY BATTERY AND VEHICLE

(71) Applicant: SEMICONDUCTOR ENERGY LABORATORY CO., LTD., Atsugi-shi, Kanagawa-ken (JP)

(72) Inventors: Shunpei YAMAZAKI, Setagaya, Tokyo (JP); Yusuke YOSHITANI, Isehara, Kanagawa (JP); Yohei MOMMA, Isehara, Kanagawa (JP); Kunihiro FUKUSHIMA, Isehara, Kanagawa (JP); Tetsuya KAKEHATA, Isehara, Kanagawa (JP)

(21) Appl. No.: 18/263,740

(22) PCT Filed: Jan. 21, 2022
(86) PCT No.: PCT/IB2022/050496

§ 371 Date: Aug. 1, 2023

(30) Foreign Application Priority Data
Feb. 5, 2021 (JP) 2021-017337

(51) Int. Cl. C01G 51/00

(52) U.S. Cl. CPC C01G 51/42

(57) ABSTRACT

A novel method for forming a positive electrode active material is provided. In the method for forming a positive electrode active material, a cobalt source and an additive element source are mixed to form an acidic solution; the acidic solution and an alkaline solution are made to react to form a cobalt compound; the cobalt compound and a lithium source are mixed to form a mixture; and the mixture is heated. The additive element source is a compound containing one or more selected from gallium, aluminum, boron, nickel, and indium.

### TECHNICAL FIELD

One embodiment of the present invention relates to a method for forming a positive electrode active material. Another embodiment of the present invention relates a method for forming a positive electrode. Another embodiment of the present invention relates a method for forming a secondary battery. Another embodiment of the present invention relates to a portable information terminal, a power storage system, a vehicle, and the like each including a secondary battery.

One embodiment of the present invention relates to an object, a method, or a manufacturing method. Alternatively, the present invention relates to a process, a machine, manufacture, or a composition of matter. One embodiment of the present invention relates to a semiconductor device, a display device, a light-emitting device, a power storage device, a lighting device, an electronic device, or a manufacturing method thereof. Note that one embodiment of the present invention particularly relates to a method for forming a positive electrode active material or the positive electrode active material. Alternatively, one embodiment of the present invention particularly relates to a method for forming a positive electrode or the positive electrode. Alternatively, one embodiment of the present invention particularly relates to a method for forming a secondary battery or the secondary battery.

Note that semiconductor devices in this specification mean all devices that can function by utilizing semiconductor characteristics, and an electro-optical device, a semiconductor circuit, and an electronic device are all semiconductor devices.

Note that electronic devices in this specification mean all devices including positive electrode active materials, secondary batteries, or power storage devices, and electro-optical devices including positive electrode active materials, positive electrodes, secondary batteries, or power storage devices, information terminal devices including power storage devices, and the like are all electronic devices.

Note that power storage devices in this specification refer to any elements and devices having a function of storing power. For example, a power storage device (also referred to as a secondary battery) such as a lithium-ion secondary battery, a lithium-ion capacitor, and an electric double layer capacitor are included.

### BACKGROUND ART

In recent years, a variety of power storage devices such as lithium-ion secondary batteries, lithium-ion capacitors, and air batteries have been actively developed. In particular, demands for lithium-ion secondary batteries with high output and high energy density have rapidly grown with the development of the semiconductor industry, for portable information terminals such as mobile phones, smartphones, and laptop computers, portable music players, digital cameras, medical equipment, home power storage systems, industrial power storage systems, next-generation clean energy vehicles such as hybrid electric vehicles (HVs), electric vehicles (EVs), and plug-in hybrid electric vehicles (PHVs), and the like, and the lithium-ion secondary batteries are essential as rechargeable energy supply sources for today's information society.

Above all, composite oxides having a layered rock salt structure, such as lithium cobalt oxide and lithium nickel-cobalt-manganese oxide, are widely used. These materials have characteristics of high capacity and high discharge voltage, which are useful for active materials for power storage devices; to exhibit high capacity, a positive electrode needs to be charged to a high potential in charging. In such a high potential state, release of a large amount of lithium might cause a reduction in stability of the crystal structure to cause significant deterioration in charge and discharge cycles. In the aforementioned background, improvements of positive electrode active materials included in positive electrodes of secondary batteries are actively conducted so as to achieve highly stable secondary batteries with high capacity (e.g., Patent Document 1 to Patent Document 3).

### REFERENCES

### Patent Documents

[Patent Document 1] Japanese Published Patent Application No. 2018-088400

[Patent Document 2] International Publication No. WO2018/203168 Pamphlet

[Patent Document 3] Japanese Published Patent Application No. 2020-140954

### SUMMARY OF THE INVENTION

### Problems to be Solved by the Invention

In spite of the active improvements of positive electrode active materials conducted in Patent Document 1 to Patent Document 3, development of lithium-ion secondary batteries and positive electrode active materials used therein has room for improvement in terms of charge and discharge capacity, cycle performance, reliability, safety, cost, and the like.

In view of the above, an object of one embodiment of the present invention is to provide a method for forming a positive electrode active material that is stable in a high potential state (also referred to as a high-voltage charged state) and/or a high temperature state. Another object is to provide a method for forming a positive electrode active material whose crystal structure is not easily broken even when charge and discharge are repeated. Another object is to provide a method for forming a positive electrode active material with excellent charge and discharge cycle performance. Another object is to provide a method for forming a positive electrode active material with high charge and discharge capacity. Another object is to provide a highly reliable or safe secondary battery.

An object of one embodiment of the present invention is to provide a method for forming a positive electrode that is stable in a high potential state and/or a high temperature state. Another object is to provide a method for forming a positive electrode with excellent charge and discharge cycle performance. Another object is to provide a method for forming a positive electrode with high charge and discharge capacity. Another object is to provide a highly reliable or safe secondary battery.

Another object of one embodiment of the present invention is to provide a novel material, novel active material particles, a novel electrode, a novel secondary battery, a novel power storage device, or a formation method thereof. Another object of one embodiment of the present invention is to provide a method for forming a secondary battery having one or more of characteristics selected from increased purity, improved performance, and increased reliability or to provide the secondary battery.

Note that the description of these objects does not preclude the existence of other objects. One embodiment of the present invention does not have to achieve all of these objects. Other objects can be derived from the description of the specification, the drawings, and the claims.

### Means for Solving the Problems

One embodiment of the present invention is a method for forming a positive electrode active material in which a cobalt source and an additive element source are mixed to form an acidic solution; the acidic solution and an alkaline solution are made to react to form a cobalt compound; the cobalt compound and a lithium source are mixed to form a mixture; and the mixture is heated. The additive element source contains one or more selected from gallium, aluminum, boron, nickel, and indium.

One embodiment of the present invention is a method for forming a positive electrode active material in which a cobalt source and an alkaline solution are made to react to form a cobalt compound; the cobalt compound, a lithium source, and an additive element source are mixed to form a mixture; and the mixture is heated. The additive element source contains one or more selected from gallium, aluminum, boron, nickel, and indium.

One embodiment of the present invention is a method for forming a positive electrode active material in which a cobalt source and an alkaline solution are made to react to form a cobalt compound; the cobalt compound and a lithium source are mixed to form a first mixture; the first mixture is heated to form a composite oxide; the composite oxide and an additive element source are mixed to form a second mixture; and the second mixture is heated. The additive element source contains one or more selected from gallium, aluminum, boron, nickel, and indium.

One embodiment of the present invention is a method for forming a positive electrode active material in which a cobalt source and a first additive element source are mixed to form an acidic solution; the acidic solution and an alkaline solution are made to react to form a cobalt compound; the cobalt compound and a lithium source are mixed to form a first mixture; the first mixture is heated to form a composite oxide; the composite oxide and a second additive element source are mixed to form a second mixture; and the second mixture is heated. The first additive element source contains one or more selected from gallium, aluminum, boron, nickel, and indium. The second additive element source contains one or more selected from nickel, cobalt, magnesium, calcium, fluorine, aluminum, manganese, titanium, zirconium, yttrium, vanadium, chromium, niobium, lanthanum, hafnium, zinc, silicon, sulfur, phosphorus, and boron.

One embodiment of the present invention is a method for forming a positive electrode active material in which a cobalt source and an alkaline solution are made to react to form a cobalt compound; the cobalt compound and a lithium source are mixed to form a first mixture; the first mixture is heated to form a composite oxide; the composite oxide, a first additive element source, and a second additive element source are mixed to form a second mixture; and the second mixture is heated. The first additive element source contains one or more selected from gallium, aluminum, boron, nickel, and indium. The second additive element source contains one or more selected from nickel, cobalt, magnesium, calcium, fluorine, aluminum, manganese, titanium, zirconium, yttrium, vanadium, chromium, niobium, lanthanum, hafnium, zinc, silicon, sulfur, phosphorus, and boron.

One embodiment of the present invention is a method for forming a positive electrode active material in which a cobalt source and a first additive element source are mixed to form an acidic solution; the acidic solution and an alkaline solution are made to react to form a cobalt compound; the cobalt compound and a lithium source are mixed to form a first mixture; the first mixture is heated to form a first composite oxide; the first composite oxide and the second additive element source are mixed to form a second mixture; the second mixture is heated to form a second composite oxide; the second composite oxide and a third additive element source are mixed to form a third mixture; and the third mixture is heated. The first additive element source contains one or more selected from gallium, aluminum, boron, nickel, and indium. The second additive element source and the third additive element source contain one or more selected from nickel, cobalt, magnesium, calcium, fluorine, aluminum, manganese, titanium, zirconium, yttrium, vanadium, chromium, niobium, lanthanum, hafnium, zinc, silicon, sulfur, phosphorus, and boron. An element included in the second additive element source is different from an element included in the third additive element source.

One embodiment of the present invention is a method for forming a positive electrode active material in which a cobalt source and an alkaline solution are made to react to form a cobalt compound; the cobalt compound and a lithium source are mixed to form a first mixture; the first mixture is heated to form a first composite oxide; the first composite oxide and a first additive element source are mixed to form a second mixture; the second mixture is heated to form a second composite oxide; the second composite oxide, a second additive element source, and a third additive element source are mixed to form a third mixture; and the third mixture is heated. The first additive element source and the third additive element source contain one or more selected from nickel, cobalt, magnesium, calcium, fluorine, aluminum, manganese, titanium, zirconium, yttrium, vanadium, chromium, niobium, lanthanum, hafnium, zinc, silicon, sulfur, phosphorus, and boron. An element included in the first additive element source is different from an element included in the third additive element source. The second additive element source contains one or more selected from gallium, aluminum, boron, nickel, and indium.

In any one of the above methods for forming a positive electrode active material, the alkaline solution preferably includes an aqueous solution containing sodium hydroxide, potassium hydroxide, lithium hydroxide, or ammonia.

In any one of the above methods for forming a positive electrode active material, the resistivity of water used for the aqueous solution is preferably 1 MΩ·cm or higher.

In any one of the above methods for forming a positive electrode active material, the additive element source of gallium preferably contains gallium sulfate, gallium chloride, or gallium nitrate.

In any one of the above methods for forming a positive electrode active material, the temperature at which the second mixture is heated is preferably lower than the temperature at which the first mixture is heated.

In any one of the above methods for forming a positive electrode active material, the temperature at which the third mixture is heated is preferably lower than the temperature at which the first mixture is heated.

### Effect of the Invention

According to one embodiment of the present invention, a method for forming a positive electrode active material that is stable in a high potential state and/or a high temperature state can be provided. Alternatively, a method for forming a positive electrode active material whose crystal structure is not easily broken even when charge and discharge are repeated can be provided. Alternatively, a method for forming a positive electrode active material with excellent charge and discharge cycle performance can be provided. Alternatively, a method for forming a positive electrode active material with high charge and discharge capacity can be provided. Alternatively, a highly reliable or safe secondary battery can be provided.

According to one embodiment of the present invention, a method for forming a positive electrode that is stable in a high potential state and/or a high temperature state can be provided. Alternatively, a method for forming a positive electrode with excellent charge and discharge cycle performance can be provided. Alternatively, a method for forming a positive electrode with high charge and discharge capacity can be provided. Alternatively, a highly reliable or safe secondary battery can be provided.

According to one embodiment of the present invention, a novel material, novel active material particles, a novel electrode, a novel secondary battery, a novel power storage device, or a formation method thereof can be provided. According to one embodiment of the present invention, a method for forming a secondary battery having one or more of characteristics selected from increased purity, improved performance, and increased reliability or the secondary battery can be provided.

According to one embodiment of the present invention, a method for forming a positive electrode active material with high discharge capacity can be provided. According to one embodiment of the present invention, a method for forming a positive electrode active material that can withstand high charge and discharge voltages can be provided. According to one embodiment of the present invention, a method for forming a positive electrode active material that is less likely to deteriorate can be provided. According to one embodiment of the present invention, a novel positive electrode active material can be provided.

Note that the description of these effects does not preclude the existence of other effects. One embodiment of the present invention does not need to have all of these effects. Note that other effects will be apparent from the description of the specification, the drawings, the claims, and the like, and other effects can be derived from the description of the specification, the drawings, the claims, and the like.

### BRIEF DESCRIPTION OF THE DRAWINGS

FIG. 1 is a flow chart showing a formation process of a positive electrode active material of one embodiment of the present invention.

FIG. 2 is a flow chart showing a formation process of a positive electrode active material of one embodiment of the present invention.

FIG. 3 is a flow chart showing a formation process of a positive electrode active material of one embodiment of the present invention.

FIG. 4 is a flow chart showing a formation process of a positive electrode active material of one embodiment of the present invention.

FIG. 5 is a flow chart showing a formation process of a positive electrode active material of one embodiment of the present invention.

FIG. 6 is a flow chart showing a formation process of a positive electrode active material of one embodiment of the present invention.

FIG. 7 is a flow chart showing a formation process of a positive electrode active material of one embodiment of the present invention.

FIG. 8 is a flow chart showing a formation process of a positive electrode active material of one embodiment of the present invention.

FIG. 9 is a flow chart showing a formation process of a positive electrode active material of one embodiment of the present invention.

FIG. 10 is a flow chart showing a formation process of a positive electrode active material of one embodiment of the present invention.

FIG. 11 is a flow chart showing a formation process of a positive electrode active material of one embodiment of the present invention.

FIG. 12 is a flow chart showing a formation process of a positive electrode active material of one embodiment of the present invention.

FIG. 13 is a flow chart showing a formation process of a positive electrode active material of one embodiment of the present invention.

FIG. 14 is a flow chart showing a formation process of a positive electrode active material of one embodiment of the present invention.

FIG. 15 is a flow chart showing a formation process of a positive electrode active material of one embodiment of the present invention.

FIG. 16 is a flow chart showing a formation process of a positive electrode active material of one embodiment of the present invention.

FIG. 17A is a top view of a positive electrode active material of one embodiment of the present invention, and FIG. 17B and FIG. 17C are cross-sectional views of the positive electrode active material of one embodiment of the present invention.

FIG. 18 is a diagram showing a positive electrode active material of one embodiment of the present invention.

FIG. 19 shows XRD patterns calculated from crystal structures.

FIG. 20 is a diagram showing a positive electrode active material of a comparative example.

FIG. 21 shows XRD patterns calculated from crystal structures.

FIG. 22A and FIG. 22B are observation images of a positive electrode active material after a cycle test.

FIG. 23 is an observation image of a positive electrode active material after a cycle test.

FIG. 24A is an exploded perspective view of a coin-type secondary battery, FIG. 24B is a perspective view of the coin-type secondary battery, and FIG. 24C is a cross-sectional perspective view thereof.

FIG. 25A illustrates an example of a cylindrical secondary battery. FIG. 25B illustrates the example of the cylindrical secondary battery. FIG. 25C illustrates an example of a plurality of cylindrical secondary batteries. FIG. 25D illustrates an example of a power storage system including a plurality of cylindrical secondary batteries.

FIG. 26A and FIG. 26B illustrate examples of a secondary battery, and FIG. 26C is a diagram illustrating the internal state of a secondary battery.

FIG. 27A to FIG. 27C are diagrams illustrating an example of a secondary battery.

FIG. 28A and FIG. 28B are diagrams illustrating external appearances of a secondary battery.

FIG. 29A to FIG. 29C are diagrams illustrating a method for forming a secondary battery.

FIG. 30A to FIG. 30C are diagrams illustrating structure examples of a battery pack.

FIG. 31A and FIG. 31B are diagrams illustrating examples of a secondary battery.

FIG. 32A to FIG. 32C are diagrams illustrating an example of a secondary battery.

FIG. 33A and FIG. 33B are diagrams illustrating an example of a secondary battery.

FIG. 34A is a perspective view of a battery pack of one embodiment of the present invention, FIG. 34B is a block diagram of the battery pack, and FIG. 34C is a block diagram of a vehicle having a motor.

FIG. 35A to FIG. 35D are diagrams illustrating examples of transport vehicles.

FIG. 36A and FIG. 36B are diagrams illustrating power storage devices of one embodiment of the present invention.

FIG. 37A is a diagram illustrating an electric bicycle, FIG. 37B is a diagram illustrating a secondary battery of the electric bicycle, and FIG. 37C is a diagram illustrating an electric motorcycle.

FIG. 38A to FIG. 38D are diagrams illustrating examples of electronic devices.

FIG. 39A illustrates examples of wearable devices, FIG. 39B is a perspective view of a watch-type device, and FIG. 39C is a diagram illustrating a side surface of the watch-type device. FIG. 39D is a diagram illustrating an example of wireless earphones.

### MODE FOR CARRYING OUT THE INVENTION

Embodiments of the present invention will be described in detail below with reference to the drawings. Note that the present invention is not limited to the following description, and it is readily understood by those skilled in the art that modes and details of the present invention can be modified in various ways. In addition, the present invention should not be construed as being limited to the description of the following embodiments.

A “composite oxide” in this specification and the like refers to an oxide containing a plurality of metal atoms in its structure.

In this specification and the like, crystal planes and orientations are indicated by the Miller index. In the crystallography, a bar is placed over a number in the expression of crystal planes and orientations; however, in this specification and the like, because of application format limitations, crystal planes and orientations are sometimes expressed by placing − (a minus sign) before the number instead of placing a bar over the number. Furthermore, an individual direction which shows an orientation in a crystal is denoted with “[ ]”, a set direction which shows all of the equivalent orientations is denoted with “< >”, an individual plane which shows a crystal plane is denoted with “( )”, and a set plane having equivalent symmetry is denoted with “{ }”. As the Miller indices of trigonal system and hexagonal system such as R-3m, not only (hkl) but also (hkil) are used in some cases. Here, i is −(h+k).

In this specification and the like, a layered rock-salt crystal structure of a composite oxide containing lithium and a transition metal refers to a crystal structure in which a rock-salt ion arrangement where cations and anions are alternately arranged is included and the transition metal and lithium are regularly arranged to form a two-dimensional plane, so that lithium can diffuse two-dimensionally. Note that a defect such as a cation or anion vacancy may exist. Moreover, in the layered rock-salt crystal structure, strictly, a lattice of a rock-salt crystal is distorted in some cases.

In this specification and the like, a rock-salt crystal structure refers to a structure in which cations and anions are alternately arranged. Note that a cation or anion vacancy may exist in part of the crystal structure.

In this specification and the like, the theoretical capacity of a positive electrode active material refers to the amount of electricity for the case where all the lithium that can be inserted into and extracted from the positive electrode active material is extracted. For example, the theoretical capacity of LiFePO₄ is 170 mAh/g, the theoretical capacity of LiCoO₂ is 274 mAh/g, the theoretical capacity of LiNiO₂ is 275 mAh/g, and the theoretical capacity of LiMn₂O₄ is 148 mAh/g.

The remaining amount of lithium that can be inserted into and extracted from a positive electrode active material is represented by x in a compositional formula, e.g., LiₓCoO₂ or LiₓMO₂. In this specification, LiₓCoO₂ can be replaced with LiₓMlO₂ as appropriate. It can be said that x is an occupancy rate, and in the case of a positive electrode active material in a secondary battery, x may be represented by (theoretical capacity−charge capacity)/theoretical capacity. For example, in the case where a secondary battery using LiCoO₂ as a positive electrode active material is charged to 219.2 mAh/g, it can be said that the positive electrode active material is represented by Li_{0.2}CoO₂ or x=0.2. Small x in LiₓCoO₂ means, for example, 0.1<x≤0.24.

In the case where lithium cobalt oxide almost satisfies the stoichiometric composition proportion, lithium cobalt oxide is LiCoO₂ and the occupancy rate of Li in the lithium sites is x=1. For a secondary battery after its discharge ends, it can be said that lithium cobalt oxide is LiCoO₂ and x=1. Here, “discharging ends” means that a voltage becomes lower than or equal to 2.5 V (lithium counter electrode) at a current of 100 mA/g, for example. In a lithium-ion secondary battery, the voltage of the lithium-ion secondary battery rapidly decreases when the occupancy rate of lithium in the lithium sites becomes x=1 and more lithium cannot enter the lithium-ion secondary battery. At this time, it can be said that the discharge is terminated. In general, in a lithium-ion secondary battery using LiCoO₂, the discharge voltage rapidly decreases until discharge voltage reaches 2.5 V; thus, discharge is terminated under the above-described conditions.

In this specification and the like, the charge depth obtained when all the lithium that can be inserted into and extracted from a positive electrode material is inserted is 0, and the charge depth obtained when all the lithium that can be inserted into and extracted from the positive electrode active material is extracted is 1, in some cases.

Although in this specification and the like, an active material is referred to as an active material particle in some cases, the shape is varied and not limited to a particulate shape. For example, in one cross section, the shape of an active material (active material particle) is an ellipse, a rectangle, a trapezoid, a triangle, a quadrilateral with rounded corners, an asymmetrical shape, or the like besides a circle in some cases.

In this specification and the like, it can be said that when surface unevenness information in one cross section of an active material is converted into numbers with measurement data, a smooth surface of the active material has a surface roughness of at least less than or equal to 10 nm.

In this specification and the like, the one cross section is, for example, a cross section obtained in observation using a scanning transmission electron microscope (STEM).

### Embodiment 1

In this embodiment, a method for forming a positive electrode active material of one embodiment of the present invention is described.

### <Formation Method 1>

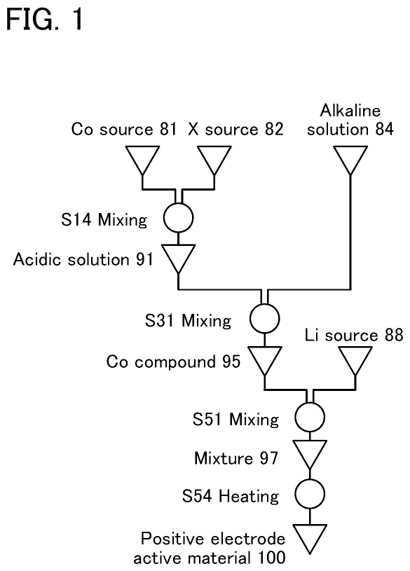

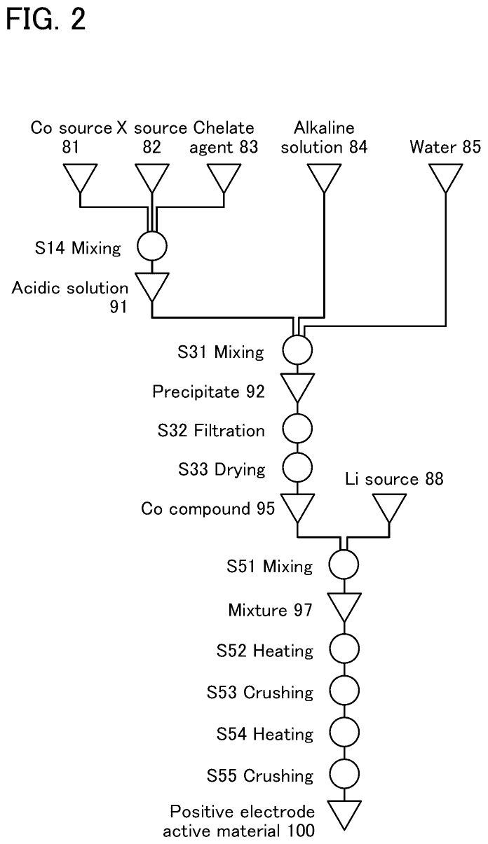

The process related to Formation Method 1 is described with reference to flow charts shown in FIG. 1 and FIG. 2 and the like. Note that although the flow chart in FIG. 2 describes part of the process in FIG. 1 in detail, the process described in detail is not always necessary.

A cobalt source 81 (denoted as Co source in the drawings) and a first additive element source 82 (denoted as X source in the drawings) shown in FIG. 1 and FIG. 2 are described. Note that cobalt is one of transition metals M1 that can form, together with lithium, a layered rock-salt composite oxide belonging to the space group R-3m. For the transition metal M1, manganese, nickel, or the like can be given besides cobalt.

### <Cobalt Source>

The cobalt source 81 is one of starting materials of the positive electrode active material. As the cobalt source 81, a compound containing cobalt (referred to as a cobalt compound) is used. As the cobalt compound, cobalt sulfate, cobalt chloride, cobalt nitrate, or a hydrate thereof can be used, for example. Furthermore, as the cobalt compound, cobalt alkoxide or an organic cobalt complex may be used. Moreover, as the cobalt compound, an organic acid of cobalt, such as cobalt acetate, or hydrate thereof may be used. Note that in this specification and the like, the organic acid includes citric acid, oxalic acid, formic acid, butyric acid, and the like, in addition to acetic acid.

In the case where a solution is used as the cobalt source 81, an aqueous solution containing the above cobalt compound (referred to as a cobalt aqueous solution) is prepared.

In the transition metal M1 contained in a positive electrode active material LiM1O₂, the proportion of cobalt is preferably greater than or equal to 75 atomic %, further preferably greater than or equal to 90 atomic %, still further preferably greater than or equal to 95 atomic %. The use of the cobalt source 81 weighed to achieve the above proportion brings many advantages such as relatively easy synthesis, easy handling, and excellent cycle performance. Cobalt with the above proportion can be referred to as a main component of the positive electrode active material.

The positive electrode active material of the present invention may contain manganese as its main component, but it is further preferable that manganese be not substantially contained. The positive electrode active material not substantially containing manganese as its main component has many advantages such as relatively easy synthesis, easy handling, and excellent cycle performance. “Not substantially containing manganese as its main component” may be considered that the content is low in the positive electrode active material. Specifically, the manganese weight in the positive electrode active material is less than or equal to 600 ppm, further preferably less than or equal to 100 ppm.

### <First Additive Element Source (X Source)>

The first additive element source 82 is one of the starting materials of the positive electrode active material, and a compound containing a first additive element X is used. The specific first additive element X is described in Embodiment 2 in detail, and one or more selected from gallium, aluminum, boron, nickel, and indium are preferably contained, for example. When the positive electrode active material contains nickel in addition to the above-described cobalt, a shift in a layered structure formed of octahedrons of cobalt and oxygen is inhibited, and the crystal structure of the positive electrode active material becomes more stable in a charged state at a high temperature, in some cases, which is preferable.

When the first additive element X is gallium, the first additive element source 82 can be referred to a gallium source. As the gallium source, a compound containing gallium is used. As the compound containing gallium, for example, gallium sulfate, gallium chloride, gallium nitrate, or a hydrate thereof can be used. Alternatively, gallium alkoxide or an organogallium complex may be used as the compound containing gallium. Further alternatively, organic acid of gallium such as gallium acetate, or a hydrate thereof may be used as the compound containing gallium.

When the first additive element X is aluminum, the first additive element source 82 can be referred to as an aluminum source. As the aluminum source, a compound containing aluminum is used. Aluminum sulfate, aluminum chloride, aluminum nitrate, or a hydrate thereof can be used as the compound containing aluminum, for example. Alternatively, aluminum alkoxide or an organoaluminum complex may be used as the compound containing aluminum. Further alternatively, organic acid of aluminum such as aluminum acetate, or a hydrate thereof may be used as the compound containing aluminum.

When the first additive element X is boron, the first additive element source 82 can be referred to as a boron source. As the boron source, a compound containing boron is used. As the compound containing boron, for example, boric acid or a borate can be used.

When the first additive element X is nickel, the first additive element source 82 can be referred to as a nickel source. As the nickel source, a compound containing nickel is used. As the compound containing nickel, for example, nickel sulfate, nickel chloride, nickel nitrate, or a hydrate thereof can be used. Alternatively, nickel alkoxide or an organonickel complex may be used as the compound containing nickel. Further alternatively, organic acid of nickel such as nickel acetate, or a hydrate thereof may be used as the compound containing nickel.

When the first additive element X is indium, the first additive element source 82 can be referred to as an indium source. As the indium source, a compound containing indium is used. As the compound containing indium, for example, indium sulfate, indium chloride, indium nitrate, or a hydrate thereof can be used. Alternatively, indium alkoxide or an organoindium complex may be used as the compound containing indium. Further alternatively, organic acid of indium such as indium acetate, or a hydrate thereof may be used as the compound containing indium.

When a solution is used as the first additive element source 82, an aqueous solution containing the above compound is prepared.

Here, a chelate agent 83 shown in FIG. 2 is described. The use of the chelate agent 83 exhibits the following effects. However, as in FIG. 1, the cobalt compound can be obtained without the chelate agent 83.

### <Chelate Agent>

Examples of compounds forming the chelate agent include glycine, oxine, 1-nitroso-2-naphthol, 2-mercaptobenzothiazole, and EDTA (ethylenediaminetetraacetic acid). Note that two or more kinds selected from glycine, oxine, 1-nitroso-2-naphthol, and 2-mercaptobenzothiazole may be used. At least one of the above is dissolved in water (e.g., pure water) and the solution is used as a chelate aqueous solution. The chelate agent is preferred to a general complexing agent in terms of being a complexing agent to form a chelate compound. Needless to say, a general complexing agent may be used, and ammonia water can be used instead of the chelate agent, for example.

The chelate aqueous solution described above is preferably used, in which case generation of unnecessary crystal nuclei is suppressed to promote crystal growth. Since generation of unnecessary crystal nuclei is suppressed to inhibit generation of fine particles, a cobalt compound with good particle size distribution can be obtained. Furthermore, the use of the chelate aqueous solution can slow an acid-base reaction, so that the reaction gradually proceeds to form a nearly spherical cobalt compound.

Glycine described as an example of the compound contained in the chelate aqueous solution has a function of keeping the pH value greater than or equal to 9 and less than or equal to or the vicinity of the range. Therefore, the use of a glycine aqueous solution as the chelate aqueous solution is preferable because it is easy to control the pH in a reaction vessel for obtaining the above cobalt compound. Furthermore, the concentration of glycine in the glycine aqueous solution is preferably greater than or equal to 0.05 mol/L and less than or equal to 0.5 mol/L, further preferably greater than or equal to 0.1 mol/L and less than or equal to 0.2 mol/L.

### <Pure Water>

Water used as the above aqueous solution is preferably pure water. The pure water is water with a resistivity of 1 MΩ·cm or higher, preferably water with a resistivity of 10 MΩ·cm or higher, further preferably water with a resistivity of 15 MΩ·cm or higher. Water with the above-described resistivity has high purity and an extremely small amount of impurities.

### <Step S14>

Next, Step S14 shown in FIG. 1 and FIG. 2 is described. In Step S14, the cobalt source 81 and the first additive element source 82 are mixed. Here, an example is described where an aqueous solution containing a gallium compound as the first additive element source 82 is used. A solution showing acidity (acidic solution) 91 in which the cobalt compound and the gallium compound are dissolved in water can be obtained by mixing. The above pure water is preferably used as the water. Note that it is only required that an aqueous solution is prepared in Step S14, and thus preparing the cobalt source 81 and the first additive element source 82 in the form of aqueous solutions is not essential.

Next, an alkaline solution 84 shown in FIG. 1 and FIG. 2 is described.

### <Alkali Solution>

For example, an aqueous solution containing sodium hydroxide, potassium hydroxide, lithium hydroxide, or ammonia is used as the alkaline solution 84, and the alkaline solution 84 is not limited to the aqueous solution as long as it functions as a pH adjuster. An aqueous solution in which two or more kinds selected from sodium hydroxide, potassium hydroxide, and lithium hydroxide are dissolved in water may be used, for example. The above pure water is preferably used as the water.

Here, water 85 shown in FIG. 2 is described. The water 85 is described as a filling liquid or an adjustment liquid in some cases, and refers to an aqueous solution in the initial state of the reaction. The above pure water or an aqueous solution in which the above chelate agent is dissolved in the above pure water is preferably used as water. When the chelate agent is used, as described above, generation of unnecessary crystal nuclei is suppressed to promote crystal growth; since generation of unnecessary crystal nuclei is suppressed to inhibit generation of fine particles, the effect is exhibited that a cobalt compound with good particle size distribution can be obtained, or an acid-base reaction can be slowed and thus the reaction gradually proceeds to form a nearly spherical cobalt compound. However, as in FIG. 1, the cobalt compound can be obtained without the water 85.

### <Step S31>

Next, Step S31 shown in FIG. 1 and FIG. 2 is described. In Step S31, the acidic solution 91 and the alkaline solution 84 are mixed. By the mixing, the acidic solution 91 reacts with the alkaline solution 84 to form a cobalt compound 95. The cobalt compound 95 contains the first additive element X The first additive element X can exist in the entire cobalt compound 95.

The above reaction in Step S31 is referred to as a neutralization reaction, an acid-base reaction, or a coprecipitation reaction in some cases. The obtained cobalt compound 95 is referred to as a precursor of lithium cobalt oxide that is a positive electrode active material 100 in some cases

### <Reaction Conditions>

In the case where the acidic solution 91 and the alkaline solution 84 are made to react by the coprecipitation reaction, the pH of a reaction vessel is set to greater than or equal to 9 and less than or equal to 11, preferably greater than or equal to 9.8 and less than or equal to 10.5. The above range is preferable because a particle diameter of a secondary particle of the obtained cobalt compound can be large. When the pH is outside the above range, the productivity becomes low, and the obtained cobalt compound is likely to contain an impurity.

In the case where the acidic solution 91 is put into the reaction vessel and the alkaline solution 84 is dropped into the reaction vessel, the pH of the aqueous solution in the reaction vessel is preferably kept in the above range. Also in the case where the alkaline solution 84 is put into the reaction vessel and the acidic solution 91 is dropped thereinto, the pH is preferably kept in the above range.

In order that the coprecipitation reaction proceeds more efficiently, it is preferable that the water 85 shown in FIG. 2 be put into the reaction vessel, and the acidic solution 91 be dropped thereinto. When the pH in the reaction vessel is changed from a predetermined value by dropping the acidic solution 91, the pH in the reaction vessel is preferably controlled by dropping the alkaline solution 84.

The dropping rate of the acidic solution 91 or the alkaline solution 84 is preferably greater than or equal to 0.01 mL/min and less than or equal to 1 mL/min, further preferably greater than or equal to 0.1 mL/min and less than or equal to 0.8 mL/min in the case where greater than or equal to 200 mL and less than or equal to 350 mL of the solution is in the reaction vessel.

A solution in the reaction vessel is preferably stirred with a stirring means. The stirring means includes a stirrer, an agitator blade, or the like. Two to six agitator blades can be provided; for example, in the case where four agitator blades are provided, they may be placed in a cross shape seen from above. The number of rotations of the agitator blades of the stirring means is preferably greater than or equal to 800 rpm and less than or equal to 1200 rpm.

The solution temperature in the reaction vessel is adjusted to be higher than or equal to 50° C. and lower than or equal to 90° C. It is preferable to start dropping after that. The above range is preferable because a particle diameter of a secondary particle of the obtained cobalt compound can be large.

The reaction vessel preferably has an inert atmosphere. For example, in the case of a nitrogen atmosphere, a nitrogen gas is preferably introduced at a flow rate of 0.5 L/min or more and 1.2 L/min.

In the reaction vessel, a reflux condenser is preferably placed. The nitrogen gas can be released from the reaction vessel and water can be returned to the reaction vessel with use of the reflux condenser.

Through the above reaction, the cobalt compound 95 (denoted as Co compound in the drawings) is precipitated in the reaction vessel as a reaction product.

### <Step S32 and Step S33>

Here, a precipitate 92, filtration in Step S32, and drying in Step S33 shown in FIG. 2 are described. The precipitate 92 contains the above cobalt compound 95. The precipitate 92 contains an impurity in addition to the cobalt compound 95. Therefore, in order to collect the cobalt compound 95, the filtration in Step S32 is preferably performed. Suction filtration or low-pressure filtration can be employed for the filtration. Other than filtration, centrifugation may be employed. In the case of using suction filtration, after a reaction product precipitated in the reaction vessel is washed with pure water, an organic solvent (e.g., acetone) having a low boiling point is preferably added before the suction filtration is performed.

It is preferable that the drying in Step S33 be further performed on the cobalt compound after the filtration. For example, the drying is performed under vacuum at higher than or equal to 60° C. and lower than or equal to 90° C. for longer than or equal to 0.5 hours and shorter than or equal to 3 hours. In this manner, the cobalt compound 95 can be obtained.

The cobalt compound 95 contains cobalt hydroxide. The cobalt hydroxide is obtained in the state of secondary particles which are aggregations of primary particles. Note that in this specification and the like, a primary particle refers to a particle (lump) of the smallest unit having no grain boundary when being observed, for example, at a magnification of 5000 times with a SEM (scanning electron microscope). In other words, the primary particle means a particle of the smallest unit surrounded by a grain boundary. The secondary particle refers to a particle in which the primary particles are aggregated, partially sharing the grain boundary (the circumference of the primary particle or the like) and are not easily separated from each other (an independent particle). That is, the secondary particle has a grain boundary in some cases.

Next, a lithium compound is prepared as a lithium source 88 (denoted as Li source in the drawings) shown in FIG. 1 and FIG. 2.

### <Lithium Compound>

Lithium hydroxide, lithium carbonate, lithium oxide, or lithium nitrate are prepared as the lithium compound. For example, when cobalt hydroxide is obtained as the cobalt compound 95, lithium hydroxide can be used as the lithium compound. In the positive electrode active material, the atomic ratio (Li/Co) of cobalt (Co) to lithium (Li) is greater than or equal to 1.0 and less than or equal to 1.06, preferably greater than or equal to 1.02 and less than or equal to 1.05. The lithium compound is weighed so that the above range is satisfied.

The lithium compound is preferably ground. For example, grinding is performed using a mortar for longer than or equal to 5 minutes and shorter than or equal to 15 minutes. The mortar is preferably made of a material that hardly releases an impurity; specifically, a mortar made of alumina with the purity of higher than or equal to 90 wt %, preferably higher than or equal to 99 wt % is used. Alternatively, a wet grinding method using a ball mill or the like may be employed. In the wet grinding method, acetone can be used for a solvent, and grinding is preferably performed at the rotational frequency greater than or equal to 200 rpm and less than or equal to 400 rpm for longer than or equal to 10 hours and shorter than or equal to 15 hours.

### <Step S51>

Next, Step S51 shown in FIG. 1 and FIG. 2 is described. In Step S51, the cobalt compound 95 and the lithium source 88 are mixed. After that, a mixed mixture 97 is obtained. A planetary centrifugal mixer is preferably used as a unit that mixes the cobalt compound 95 and the lithium source 88. When media are not used, grinding is not performed in many cases, and a change in particle diameters of the cobalt compound 95 and the lithium source 88 is small.

When the cobalt compound 95 and the lithium source 88 are ground at the same time as the mixing, a ball mill or a bead mill is preferably used. Alumina balls or zirconia balls can be used as media of the ball mill or the bead mill. The centrifugal force is applied to the media in the ball mill or the bead mill, and thus microparticulation becomes possible. Note that in the case where contamination from the media and the like might occur, it is preferable that the zirconia balls be used and a peripheral speed be preferably set to greater than or equal to 100 mm/sec and less than or equal to 2000 mm/sec.

A dry grinding method and a wet grinding method can be used when mixing and grinding are performed at the same time. In a dry grinding method, grinding is performed in an inert gas or in air, and a particle can be ground to a particle diameter less than or equal to 3.5 lam, preferably less than or equal to 3 μm. In a wet grinding method, grinding is performed in a liquid, and a particle can be ground to a particle diameter less than or equal to 1 μm. That is, the wet grinding method is preferably used to obtain a small particle diameter.

In the above manner, the mixture 97 is obtained.

Here, a supplementary explanation of a heating step is provided with reference to Step S52 and Step S53 shown in FIG. 2.

### <Step S52>

Next, Step S52 shown in FIG. 2 is described. The heating step may be performed a plurality of times, and in Step S52, heating is performed at a temperature higher than or equal to 400° C. and lower than or equal to 700° C. before Step S54 described later. The heating in Step S52 is performed at a lower temperature than that in Step S54 and thus referred to as temporary baking in some cases. By Step S52, gas components contained in the cobalt compound 95 or the lithium source 88 are released in some cases. With the use of the material in which the gas components are released, a composite oxide with few impurities can be obtained. However, as in FIG. 1, the positive electrode active material can be obtained without the temporary baking in Step S52.

### <Step S53>

Next, Step S53 shown in FIG. 2 is described. In Step S53, a crushing step is performed. For example, it is preferable to perform classification using a sieve with an aperture diameter of greater than or equal to 40 lam and less than or equal to 60 lam. However, as in FIG. 1, the positive electrode active material can be obtained without the crushing step in Step S53.

### <Step S54>

Next, Step S54 shown in FIG. 1 and FIG. 2 is described. In Step S54, the mixture obtained through the crushing step in Step S53 is heated. By heating, lithium cobalt oxide that is a composite oxide can be obtained. This is the positive electrode active material 100. Step S54 is referred to as main baking in some cases. In consideration of Step S52 and the like, there are a lot of heating steps, and they are sometimes referred to as first baking, second baking, and the like appropriately using ordinal numbers in order to be distinguished from each other.

### <Heating Conditions>

In Step S54, the heating temperature is preferably higher than or equal to 700° C. and lower than 1100° C., further preferably higher than or equal to 800° C. and lower than or equal to 1000° C., still further preferably higher than or equal to 800° C. and lower than or equal to 950° C. When a cobalt oxide is formed through this heat treatment, heating is performed at a temperature at which at least the cobalt compound 95 and the lithium source 88 are diffused mutually. Because of the temperature, Step S54 is referred to as main baking.

The heating time in Step S54 can be longer than or equal to 1 hour and shorter than or equal to 100 hours, for example, and is preferably longer than or equal to 2 hours and shorter than or equal to 20 hours.

The heating atmosphere in Step S54 is preferably an atmosphere containing oxygen or an oxygen-containing atmosphere that is what is called dry air with little water (e.g., a dew point is lower than or equal to −50° C., and a dew point is preferably lower than or equal to −80° C.).

For example, in the case where the heating is performed at 750° C. for 10 hours, the temperature rising rate is preferably greater than or equal to 150° C./h and less than or equal to 250° C./h. The flow rate of dry air that can form a dry atmosphere is preferably greater than or equal to 3 L/min and less than or equal to 10 L/min. The temperature decreasing time from a specified temperature to room temperature is preferably longer than or equal to 10 hours and shorter than or equal to 50 hours. The temperature decreasing rate can be calculated from the temperature decreasing time or the like.

A crucible, a sagger, a setter, or a container used in the heating is preferably made of a material that hardly releases impurities. For example, a crucible made of alumina with a purity of 99.9% is preferably used. In the case of mass production, a sagger made of mullite cordierite (Al₂O₃, SiO₂, and MgO) is preferably used, for example.

It is preferable to collect the heated materials after the materials are transferred from the crucible to a mortar in order to prevent impurities from entering the materials. The mortar is preferably made of a material that hardly releases impurities; specifically, a mortar made of alumina or zirconia with the purity of higher than or equal to 90 wt %, preferably higher than or equal to 99 wt % is preferably used.

According to Formation Method 1 above, the positive electrode active material 100 such as lithium cobalt oxide can be formed. The positive electrode active material 100 can reflect the shape of the cobalt compound 95 that is the precursor. Furthermore, according to Formation Method 1, the first additive element X can exist inside the positive electrode active material 100 or in the entire positive electrode active material 100 (including the inside and a surface portion).

The lithium cobalt oxide is preferred in containing few impurities. However, sulfur might be detected from the lithium cobalt oxide, when a sulfide is used as a starting material. With use of GD-MS (a glow discharge mass spectrometry), ICP-MS (an inductively coupled plasma-mass spectrometry), or the like, elements in the whole particle of the positive electrode active material can be analyzed to measure the concentration of sulfur.

### <Formation Method 2>

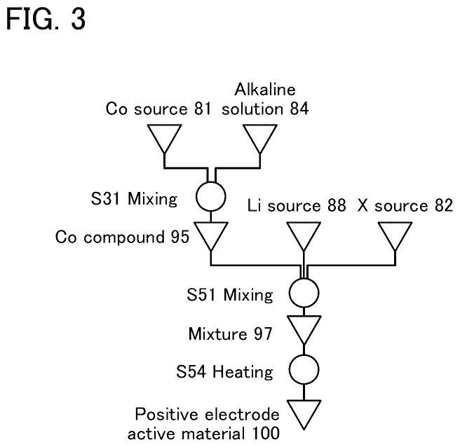

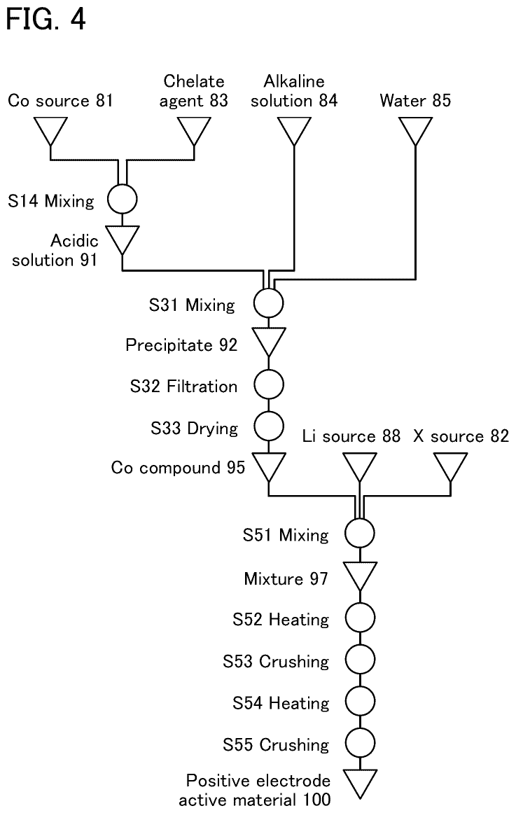

The process related to Formation Method 2 is described with reference to flow charts shown in FIG. 3 and FIG. 4 and the like. Note that although the flow chart in FIG. 4 describes part of the process in FIG. 3 in detail, the process described in detail is not always necessary.

Formation Method 2 is different from Formation Method 1 in the timing when the first additive element source 82 is introduced, and the first additive element source 82 and the lithium source 88 are introduced at the same time in Step S51.

### <First Additive Element Source (X Source)>

A supplementary explanation of the first additive element source 82 shown in FIGS. 3 and FIG. 4 is provided. In Formation Method 2, an element preferable as the first additive element X is similar to that described in Formation Method 1. Note that in Formation Method 2, the first additive element source 82 is not necessarily an aqueous solution.

For example, as a gallium source, it is possible to use gallium oxyhydroxide, gallium hydroxide, gallium oxide, or a gallium salt such as gallium sulfate, gallium acetate, or gallium nitrate. Gallium alkoxide may also be used.

As an aluminum source, it is possible to use aluminum hydroxide, aluminum oxide, or an aluminum salt such as aluminum sulfate, aluminum acetate, or aluminum nitrate. Aluminum alkoxide may also be used.

As a boron source, for example, boric acid or a borate can be used.

As an indium source, indium sulfate, indium acetate, indium oxide, or indium nitrate can be used, for example. Indium alkoxide may also be used.

The description of Formation Method 1, other than the above different structure and method, can be referred to for FIG. 3 and FIG. 4 showing Formation Method 2.

According to Formation Method 2, the positive electrode active material 100 such as lithium cobalt oxide can be formed. The positive electrode active material 100 can reflect the shape of the cobalt compound 95 that is the precursor. Furthermore, according to Formation Method 2, the first additive element X can exist inside the positive electrode active material 100 or in the entire positive electrode active material 100 (including the inside and the surface portion).

The lithium cobalt oxide is preferred in containing few impurities. However, sulfur might be detected from the lithium cobalt oxide, when a sulfide is used as a starting material. With use of GD-MS, ICP-MS, or the like, elements in the whole particle of the positive electrode active material can be analyzed to measure the concentration of sulfur.

A coprecipitation method is not necessarily used to form the positive electrode active material 100. For example, as the cobalt compound 95 in FIG. 3 and FIG. 4, cobalt oxide, cobalt hydroxide, cobalt oxyhydroxide, cobalt carbonate, cobalt oxalate, cobalt sulfate, and the like are used, whereby it is possible to obtain the positive electrode active material 100 containing the first additive element X inside the particle or in the entire particle (including the inside and the surface portion). The above description of Step S54 can be referred to for the heating conditions.

### <Formation Method 3>

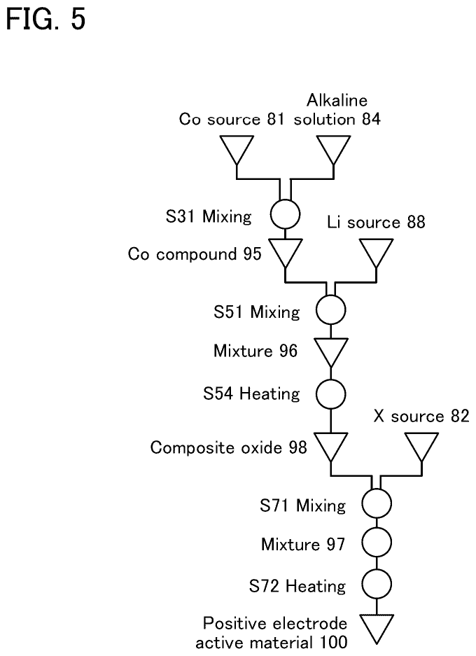

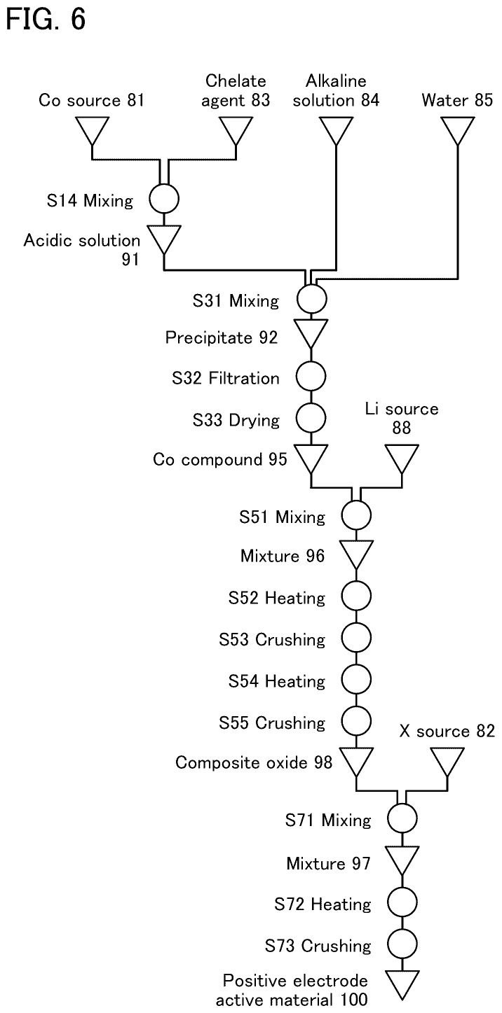

The process related to Formation Method 3 is described with reference to flow charts shown in FIG. 5 and FIG. 6 and the like. Note that although the flow chart in FIG. 6 describes part of the process in FIG. 5 in detail, the process described in detail is not always necessary.

Formation Method 3 is different from Formation Method 1 in the timing when the first additive element source 82 is introduced, and the first additive element source 82 is introduced into a composite oxide 98.

### <First Additive Element Source (X Source)>

A supplementary explanation of the first additive element source 82 shown in FIG. 5 and FIG. 6 is provided. Different from Formation Method 1, it is preferable that water be not contained as the first additive element source 82 in Formation Method 2. As the first additive element source 82 not containing water, Formation Method 2 can be referred to for the specific compound.

### <Composite Oxide>

The composite oxide 98 shown in FIG. 5 and FIG. 6 is described. The composite oxide 98 is formed through the heating in Step S54 and referred to as the positive electrode active material 100 in Formation Method 1 and Formation Method 2.

### <Step S71>

Step S71 shown in FIG. 5 and FIG. 6 is described. In Step S71, the first additive element source 82 and the composite oxide 98 are mixed. After that, the mixture 97 is formed. As the mixing, dry mixing or wet mixing can be used. In mixing, the rotational frequency is preferably greater than or equal to 100 rpm and less than or equal to 200 rpm to prevent the composite oxide 98 from being broken.

### <Step S72>

Step S72 shown in FIG. 5 and FIG. 6 is described. In Step S72, the mixture 97 is heated. The description of Step S54 can be referred to for the heating conditions.

Here, a supplementary explanation of the heating temperature in Step S72 is provided. The heating temperature in Step S72 is preferably lower than the heating temperature in Step S54. Since the composite oxide 98 is formed through Step S54, the temperature at which the crystal structure of the composite oxide 98 is not broken is preferably employed in Step S72.

Furthermore, the heating in Step S72 needs to be performed at higher than or equal to the temperature at which a reaction between the composite oxide 98 and the first additive element source 82 proceeds. The temperature at which the reaction proceeds is the temperature at which interdiffusion occurs in the composite oxide 98 and the first additive element source 82, and may be lower than the melting temperatures of these materials. It is known that in the case of an oxide as an example, interdiffusion occurs at a temperature that is 0.757 times the melting temperature Tₘ (Tamman temperature T_{d}). Therefore, the heating temperature in Step S72 needs to be at least higher than or equal to 500° C.

Needless to say, a temperature higher than or equal to the temperature at which part of the composite oxide 98 and the first additive element source 82 is melted is preferable because the reaction proceeds easily.

A higher heating temperature is preferable because it facilitates the reaction, shortens the heating time, and enables high productivity.

The heating temperature is lower than the decomposition temperature of the composite oxide 98 (the decomposition temperature of LiCoO₂ is 1130° C.). At around the decomposition temperature, a slight amount of the composite oxide 98 might be decomposed. Thus, the heating temperature is preferably lower than or equal to 1000° C., further preferably lower than or equal to 950° C., still further preferably lower than or equal to 900° C.

The description of Formation Method 1 to Formation Method 2, other than the above different structure and method, can be referred to for FIG. 5 and FIG. 6 showing Formation Method 3.

According to Formation Method 3, the positive electrode active material 100 such as lithium cobalt oxide can be formed. The positive electrode active material 100 can reflect the shape of the cobalt compound 95 that is the precursor. Furthermore, according to Formation Method 3, the first additive element X can exist in the surface portion of the positive electrode active material 100.

The lithium cobalt oxide is preferred in containing few impurities. However, sulfur might be detected from the lithium cobalt oxide, when a sulfide is used as a starting material. With use of GD-MS, ICP-MS, or the like, elements in the whole particle of the positive electrode active material can be analyzed to measure the concentration of sulfur.

### <Formation Method 4>

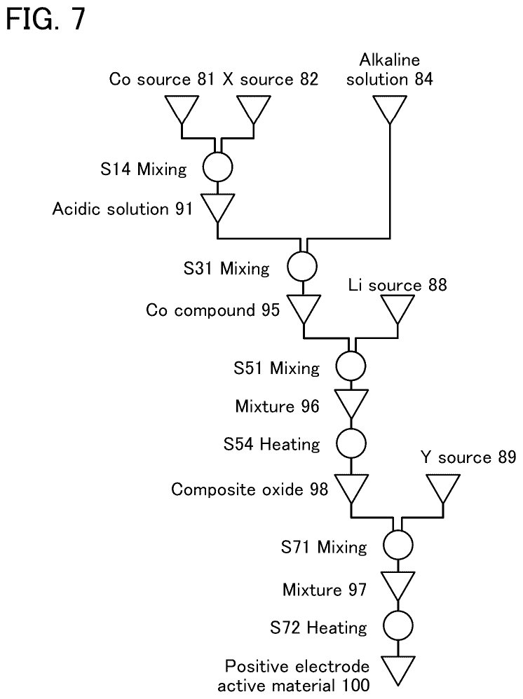

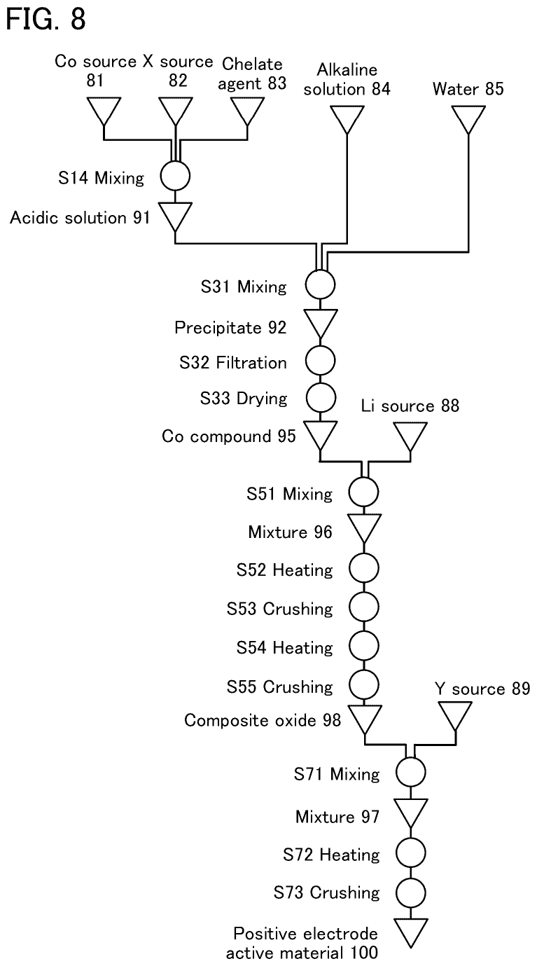

The process related to Formation Method 4 is described with reference to flow charts shown in FIG. 7 and FIG. 8 and the like. Note that although the flow chart in FIG. 8 describes part of the process in FIG. 7 in detail, the process described in detail is not always necessary.

In Formation Method 4, a second additive element source 89 (denoted as Y source in the drawings) is introduced into the composite oxide 98, in addition to the steps in Formation Method 1.

### <Second Additive Element Source (Y Source)>

The second additive element source 89 shown in FIG. 7 and FIG. 8 is described. The second additive element source 89 is one of the starting materials of the positive electrode active material, and a compound containing a second additive element Y is used. The second additive element source 89 contains an element different from that in the first additive element source 82. The specific second additive element Y is described in Embodiment 2 in detail, and it is preferable that one or more selected from nickel, cobalt, magnesium, calcium, fluorine, aluminum, manganese, titanium, zirconium, yttrium, vanadium, chromium, niobium, lanthanum, hafnium, zinc, silicon, sulfur, phosphorus, and boron be contained, for example, and the second additive element Y be different from the first additive element X When the positive electrode active material contains nickel in addition to cobalt, a shift in a layered structure formed of octahedrons of cobalt and oxygen is inhibited, and the crystal structure of the positive electrode active material becomes more stable in a charged state at a high temperature, in some cases, which is preferable.

When the second additive element Y is magnesium, the second additive element source 89 can be referred to as a magnesium source. As the magnesium source, a compound containing magnesium is used. As the compound containing magnesium, for example, magnesium fluoride, magnesium oxide, magnesium hydroxide, magnesium carbonate, or the like can be used. Two or more of these magnesium sources may be used.

When the second additive element Y is fluorine, the second additive element source 89 can be referred to as a fluorine source. As the fluorine source, a compound containing fluorine is used. As the compound containing fluorine, it is possible to use lithium fluoride, magnesium fluoride, aluminum fluoride, titanium fluoride, cobalt fluoride, nickel fluoride, zirconium fluoride, vanadium fluoride, manganese fluoride, iron fluoride, chromium fluoride, niobium fluoride, zinc fluoride, calcium fluoride, sodium fluoride, potassium fluoride, barium fluoride, cerium fluoride, lanthanum fluoride, or sodium aluminum hexafluoride, for example. Among them, lithium fluoride, which has a relatively low melting point of 848° C., is preferable because it is easily melted in a heating step described later.

Magnesium fluoride can be used as both the fluorine source and the magnesium source. Lithium fluoride can be used as both the fluorine source and the lithium source.

The fluorine source may be a gas, and fluorine, carbon fluoride, sulfur fluoride, oxygen fluoride, or the like may be used and mixed in the atmosphere in a heating step described later. Two or more of these fluorine sources may be used.

When the second additive element source 89 is prepared, two or more kinds of the second additive elements Y can be used. For example, in the case where both lithium fluoride and magnesium fluoride are used to form the second additive element source 89, the molar ratio of the lithium fluoride to the magnesium fluoride is preferably LiF:MgF₂=x:1 (0≤x≤1.9), further preferably LiF:MgF₂=x:1 (0.1≤x≤0.5), still further preferably LiF:MgF₂=x:1 (x=0.33 and an approximate value thereof). Note that an approximate value means a value greater than 0.9 times and less than 1.1 times a certain value.

When two or more kinds of the second additive element sources 89 are used, those second additive element sources 89 are preferably mixed in advance. Mixing is performed by a method in which raw materials are mixed while being ground or a method in which raw materials are mixed without being ground. In the case of mixing the two or more kinds of the second additive element source 89 in advance, mixing while grounding is preferable. In that case, particle diameters in the second additive element source 89 can be uniform, and the particle diameters can be small.

Furthermore, when the second additive element source 89 is collected after the mixing and the like, classification may be performed using a sieve with an aperture diameter of greater than or equal to 250 lam and less than or equal to 350 lam. The particle diameters can be uniform.

As the method in which mixing is performed while grinding, a dry grinding method or a wet grinding method is given. A wet grinding method is preferable because a particle diameter can be smaller than that in a dry grinding method. When wet grinding is performed, a solvent is prepared. As the solvent, ketone such as acetone, alcohol such as ethanol or isopropanol, ether, dioxane, acetonitrile, N-methyl-2-pyrrolidone (NMP), or the like can be used. Dehydrated acetone with purity higher than or equal to 99.5% is preferably used as the solvent. With the use of dehydrated acetone with the above-described purity, impurities that might be mixed can be reduced.

In the method in which mixing is performed while grinding, a ball mill, a bead mill, or the like can be used. Alumina balls or zirconia balls can be used as media of the ball mill or the bead mill. The centrifugal force is applied to the media in the ball mill and the bead mill, and thus microparticulation becomes possible. Note that in the case where contamination from the media and the like might occur, it is preferable that the zirconia balls be used and a peripheral speed be preferably set to greater than or equal to 100 mm/sec and less than or equal to 2000 mm/sec.

Although two kinds of the second additive element sources 89 are prepared in the example described above, one kind or three or more kinds of the second additive element sources 89 may be mixed.

As the introduction method of the second additive element Y into the composite oxide 98, a solid phase method, a liquid phase method such as a sol-gel method, a sputtering method, an evaporation method, a CVD (chemical vapor deposition) method, a PLD (pulsed laser deposition) method, or the like can be employed.

### <Step S71>

Step S71 shown in FIG. 7 and FIG. 8 is described. In Step S71, the second additive element source 89 and the composite oxide 98 are mixed. After that, the mixture 97 is formed. As the mixing, dry mixing or wet mixing can be used. In mixing, the rotational frequency is preferably greater than or equal to 100 rpm and less than or equal to 200 rpm to prevent the composite oxide 98 from being broken.

### <Step S72>

Step S72 shown in FIG. 7 and FIG. 8 is described. In Step S72, the mixture 97 is heated. Note that the heating conditions in Step S72 in Formation Method 3 can be referred to for the heating in Step S72 in Formation Method 4.

Here, a supplementary explanation of the heating temperature is provided. The heating in Step S72 needs to be performed higher than or equal to the temperature at which a reaction between the composite oxide 98 and the second additive element source 89 proceeds. The temperature at which the reaction proceeds is the temperature at which interdiffusion occurs in the composite oxide 98 and the second additive element source 89, and may be lower than the melting temperatures of these materials. It is known that in the case of an oxide as an example, interdiffusion occurs at a temperature that is 0.757 times the melting temperature Tₘ (Tamman temperature T_{d}). Accordingly, it is only required that the heating temperature of the second heating be higher than or equal to 500° C.

Needless to say, a temperature higher than or equal to the temperature at which part of the composite oxide 98 and the second additive element source 89 is melted is preferable because the reaction proceeds easily. For example, when LiF and MgF₂ are contained as the second additive element source 89, the heating is preferably performed at higher than or equal to 700° C. in Step S72. In particular, the eutectic point of LiF and MgF₂ is around 742° C., and thus the heating is preferably performed at higher than or equal to 742° C. in Step S72.

In the case where the mixture 97 is obtained by mixing such that LiCoO₂:LiF:MgF₂=100:0.33:1 (molar ratio), an endothermic peak is observed at around 830° C. in differential scanning calorimetry measurement (DSC measurement). Therefore, the temperature of the heating in Step S72 is further preferably higher than or equal to 830° C.

A higher heating temperature is preferable because it facilitates the reaction, shortens the heating time, and enables high productivity.

The heating temperature is lower than the decomposition temperature of the composite oxide 98 (the decomposition temperature of LiCoO₂ is 1130° C.). At around the decomposition temperature, a slight amount of the composite oxide 98 might be decomposed. Thus, the heating temperature is preferably lower than or equal to 1000° C., further preferably lower than or equal to 950° C., still further preferably lower than or equal to 900° C.

In view of the above, the heating temperature of the heating in Step S72 is preferably higher than or equal to 500° C. and lower than or equal to 1130° C., further preferably higher than or equal to 700° C. and lower than or equal to 1000° C., still further preferably higher than or equal to 700° C. and lower than or equal to 950° C., yet still further preferably higher than or equal to 700° C. and lower than or equal to 900° C. Furthermore, the heating temperature is preferably higher than or equal to 742° C. and lower than or equal to 1130° C., further preferably higher than or equal to 742° C. and lower than or equal to 1000° C., still further preferably higher than or equal to 742° C. and lower than or equal to 950° C., yet still further preferably higher than or equal to 742° C. and lower than or equal to 900° C. Furthermore, the heating temperature is higher than or equal to 800° C. and lower than or equal to 1100° C., preferably higher than or equal to 830° C. and lower than or equal to 1130° C., further preferably higher than or equal to 830° C. and lower than or equal to 1000° C., still further preferably higher than or equal to 830° C. and lower than or equal to 950° C., yet still further preferably higher than or equal to 830° C. and lower than or equal to 900° C.

In addition, at the time of heating the mixture 97, the partial pressure of fluorine or a fluoride originating from the fluorine source or the like is preferably controlled to be within an appropriate range in the heating environment.

In the formation method described in this embodiment, LiF, which is the fluorine source, functions as flux in some cases. Owing to this function, the temperature of the heating in Step S72 can be lower than the decomposition temperature of the composite oxide 98, e.g., a temperature higher than or equal to 742° C. and lower than or equal to 950° C., which allows distribution of the second additive element Y such as magnesium in the surface portion and formation of the positive electrode active material having favorable performance.

However, since LiF in a gas phase has a specific gravity less than that of oxygen, LiF might be sublimated by heating and the sublimation causes a reduction in the amount of LiF in the mixture 97. As a result, the function of flux deteriorates. Thus, heating needs to be performed while the sublimation of LiF is inhibited. Note that even when LiF is not used as the fluorine source or the like, Li at the surface of the composite oxide 98 and F of the fluorine source other than LiF might react to produce LiF, which might be sublimated. Therefore, the sublimation needs to be inhibited also when a fluoride having a higher melting point than LiF is used as the fluorine source other than LiF.

In order to inhibit the sublimation, there is a method in which the mixture 97 is heated in an atmosphere containing LiF. In the method, the atmosphere in the heating furnace where the mixture 97 is heated is made in a state where the partial pressure of LiF is high. In another method, a container containing the mixture 97 is covered with a lid. By such a method and the like, the sublimation of LiF, i.e., the reduction of LiF, in the mixture 97 can be inhibited.

The heating in Step S72 can be performed by a roller hearth kiln. In the roller hearth kiln, the mixture 97 can be heated while moving in the kiln in a state where the container containing the mixture 97 is covered with a lid. Covering the container with a lid makes it possible to heat the mixture 97 in an atmosphere containing LiF, and inhibit the sublimation, i.e., the reduction, of LiF in the mixture 97.

The heating in Step S72 can be performed by a rotary kiln. In the rotary kiln, it is preferable that the atmosphere in the kiln contain oxygen, and heating be performed while controlling the flow rate of oxygen. In order to inhibit the sublimation, i.e., the reduction, of LiF in the mixture 97, the flow rate of oxygen is preferably set low. As a method to make the flow rate of oxygen low, there is a method in which oxygen is introduced in the kiln first and held for a certain period, and oxygen is not introduced after that, for example.

As described above, when LiF exists in the surface portion, or at least when fluorine exists in the surface portion, it is considered that a positive electrode active material with a smooth surface and little unevenness can be obtained.

The heating in Step S72 is preferably performed such that particles of the mixture 97 are not adhered to one another. Adhesion of the particles of the mixture 97 during the heating might decrease the area of contact with oxygen in the atmosphere and obstruct a path of diffusion of one of the second additive elements Y (e.g., fluorine), and thus distribution of the second additive element Y (e.g., magnesium) might be hindered.

After the heating of the mixture 97 described above, classification is preferably performed using a sieve with an aperture diameter of greater than or equal to 40 lam and less than or equal to 60 lam. Adhesion of the particles can be inhibited.

The description of Formation Method 1 to Formation Method 3, other than the above different structure and method, can be referred to for FIG. 7 and FIG. 8 showing Formation Method 4.

According to Formation Method 4, the positive electrode active material 100 such as lithium cobalt oxide can be formed. The positive electrode active material 100 can reflect the shape of the cobalt compound 95 that is the precursor. Furthermore, according to Formation Method 4, the first additive element X can exist in the entire positive electrode active material 100 and the second additive element Y can exist in the surface portion of the positive electrode active material 100. Note that when the ion radius of the first additive element X is larger than the ion radius of the transition metal M1, the first additive element X is less likely to be dissolved and moved to the surface portion in some cases.

The lithium cobalt oxide is preferred in containing few impurities. However, sulfur might be detected from the lithium cobalt oxide, when a sulfide is used as a starting material. With use of GD-MS, ICP-MS, or the like, elements in the whole particle of the positive electrode active material can be analyzed to measure the concentration of sulfur.

### <Formation Method 5>

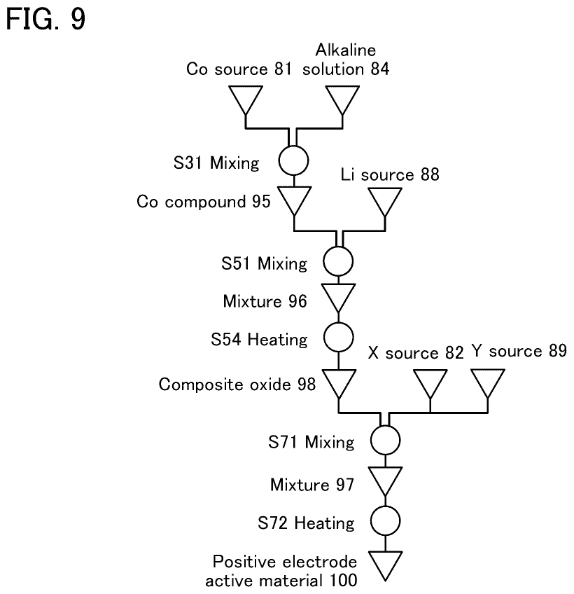

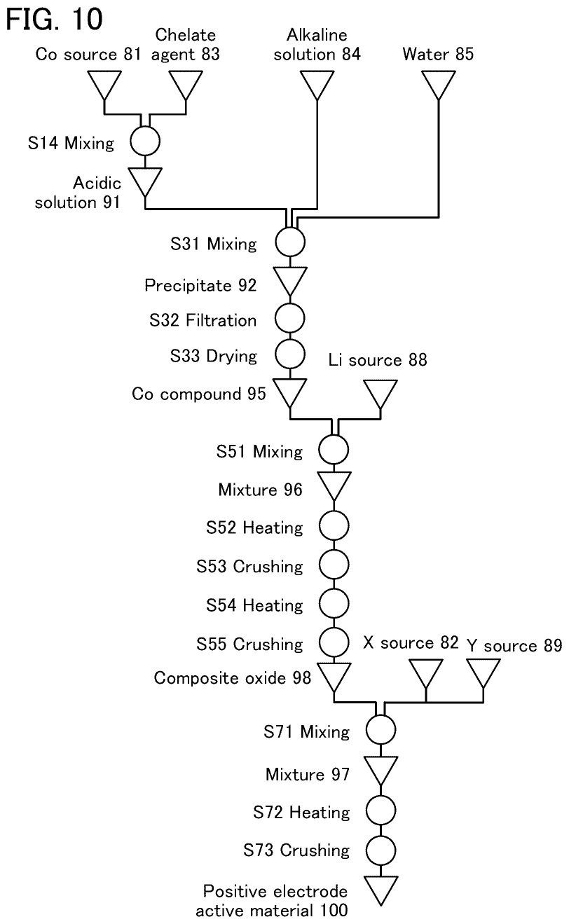

The process related to Formation Method 5 is described with reference to flow charts shown in FIG. 9 and FIG. 10 and the like. Note that although the flow chart in FIG. 10 describes part of the process in FIG. 9 in detail, the process described in detail is not always necessary.

Formation Method 5 is different from Formation Method 3 in that second additive element source 89 (denoted as Y source in the drawings) and the first additive element source 82 (denoted as X source in the drawings) are introduced into composite oxide 98.

The description of Formation Method 1 to Formation Method 4, other than the above different structure and method, can be referred to for FIG. 9 and FIG. 10 showing Formation Method 5.

According to Formation Method 5, the positive electrode active material 100 such as lithium cobalt oxide can be formed. The positive electrode active material 100 can reflect the shape of the cobalt compound 95 that is the precursor. Furthermore, according to Formation Method 5, the first additive element X and the second additive element Y can exist in the surface portion of the positive electrode active material 100.

The lithium cobalt oxide is preferred in containing few impurities. However, sulfur might be detected from the lithium cobalt oxide, when a sulfide is used as a starting material. With use of GD-MS, ICP-MS, or the like, elements in the whole particle of the positive electrode active material can be analyzed to measure the concentration of sulfur.

### <Formation Method 6>

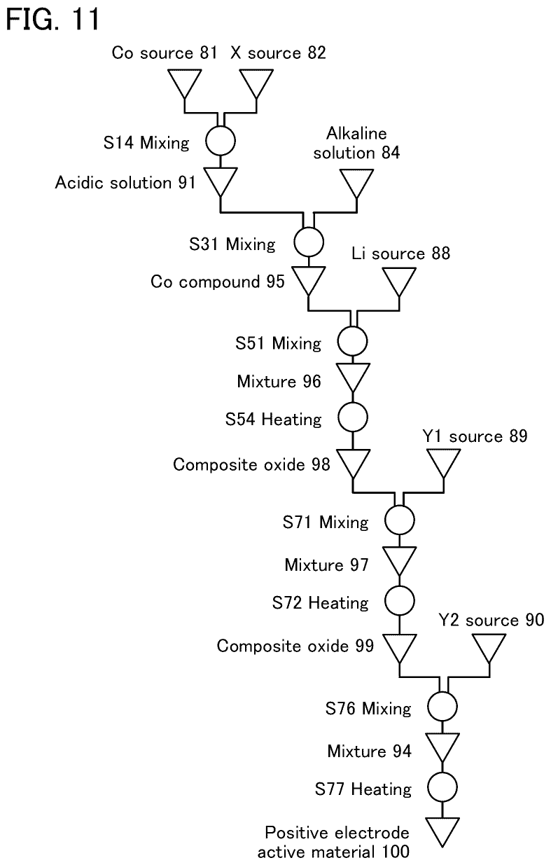

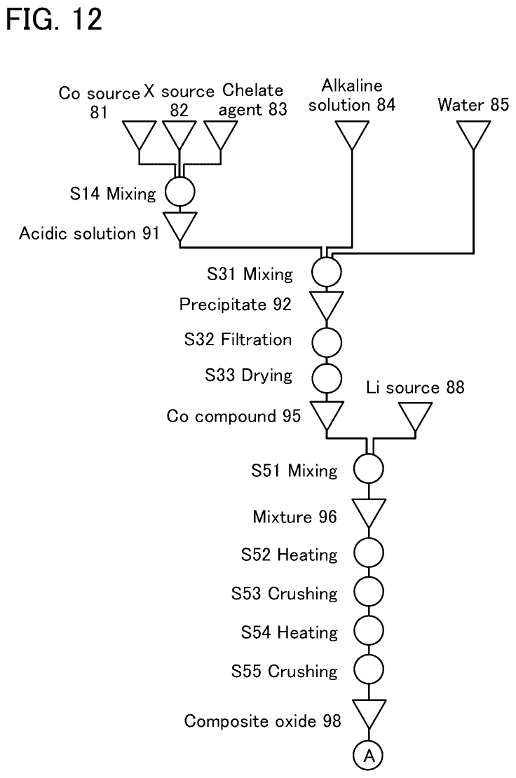

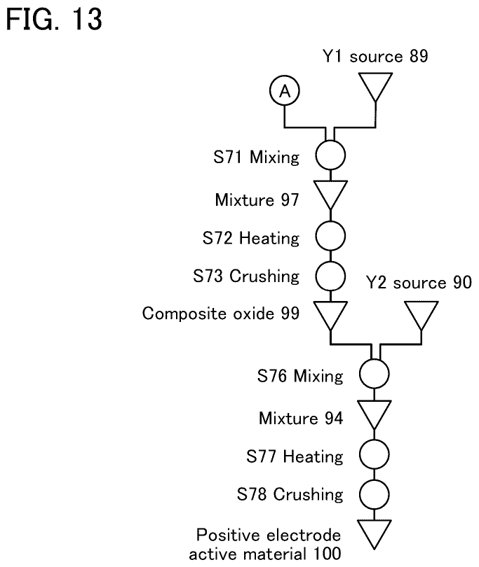

The process related to Formation Method 6 is described with reference to flow charts shown in FIG. 11 to FIG. 13 and the like. Note that although the flow charts in FIG. 12 and FIG. 13 describe part of the process in FIG. 11 in detail, the process described in detail is not always necessary. The process proceeds from A in FIG. 12 to A in FIG. 13.

In Formation Method 6, the second additive element source 89 (denoted as Y source in the drawings) added in the steps in Formation Method 4 is introduced into the composite oxide 98 and a composite oxide 99 in two steps. Here, the second additive element source 89 introduced in two steps is denoted with a different ordinal number: the second additive element source 89 and a third additive element source 90. Note that the second additive element source 89 and the third additive element source 90 are each a material containing the second additive element Y.

### <Second Additive Element Source (Y1 Source) and Third Additive Element Source (Y2 Source)>

The second additive element source 89 and the third additive element source 90 (denoted as Y1 source and Y2 source in the drawings) shown in FIG. 11 to FIG. 13 are described. The second additive element source can be added in two or more steps. In this step, the case where the second additive element source is added in two steps is described. Elements contained in the second additive element source 89 and the third additive element source 90 can be selected from the elements that can be used as the second additive element Y, and different elements are preferably selected as the second and third additive element sources. For example, a magnesium source and a fluorine source are used for the Y1 source, and an aluminum source and a nickel source are used for the Y2 source.

Although not shown, the second additive element source may be added in three or more steps, and in this case, a magnesium source and a fluorine source may be used for the Y1 source, and a nickel source may be used for the Y2 source, and an aluminum source and a zirconium source may be used for a Y3 source. The Y3 source is preferably added by a sol-gel method using alkoxide.

### <Step S76 and Step S77>

Step S76 and Step S77 shown in FIG. 11 and FIG. 13 are described. In Step S76, the third additive element source 90 that is to be added last and the composite oxide 99 are mixed to form a mixture 94, and in Step S77, the mixture 94 is heated. The description of Step S72 can be referred to for the heating conditions.

The description of Formation Method 1 to Formation Method 5, other than the above different structure and method, can be referred to for FIG. 11 to FIG. 13 showing Formation Method 6.

According to Formation Method 6, the positive electrode active material 100 such as lithium cobalt oxide can be formed. The positive electrode active material 100 can reflect the shape of the cobalt compound 95 that is the precursor. Furthermore, according to Formation Method 6, the first additive element X can exist inside the positive electrode active material 100 or in the entire positive electrode active material 100 (including the inside and the surface portion), and the second additive element Y1 and the second additive element Y2 can exist in the surface portion of the positive electrode active material 100.

The lithium cobalt oxide is preferred in containing few impurities. However, sulfur might be detected from the lithium cobalt oxide, when a sulfide is used as a starting material. With use of GD-MS, ICP-MS, or the like, elements in the whole particle of the positive electrode active material can be analyzed to measure the concentration of sulfur.

### <Formation Method 7>

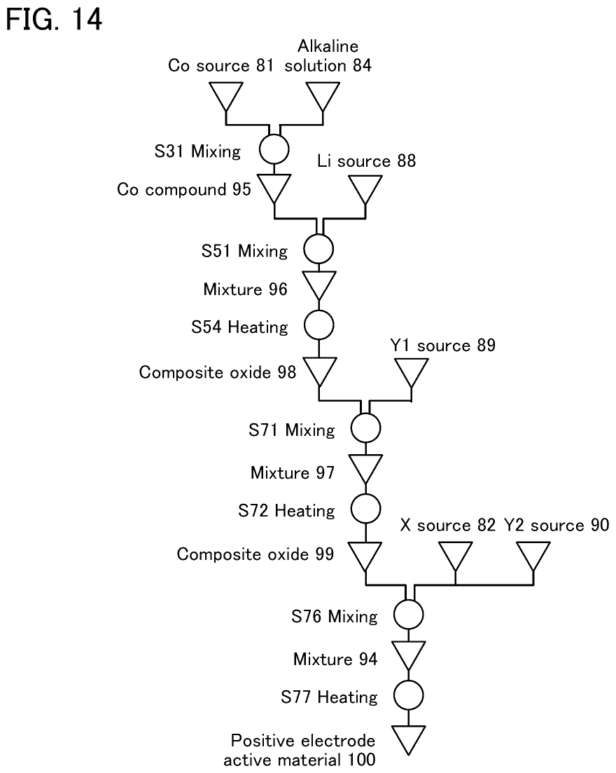

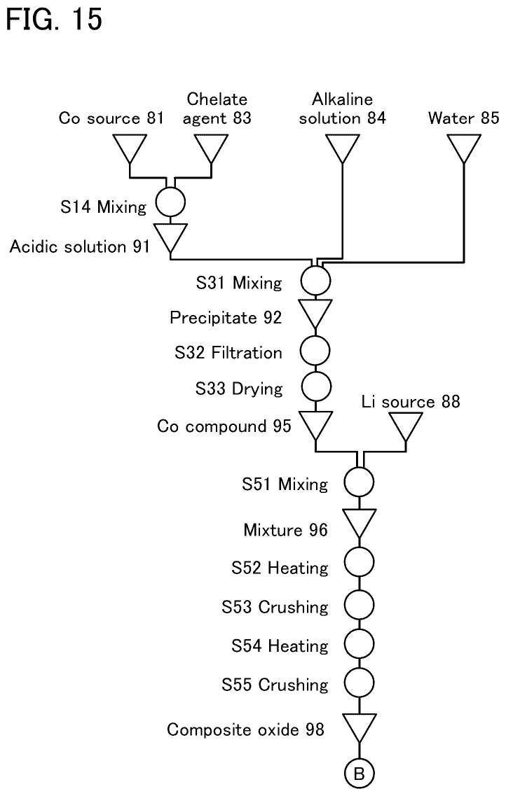

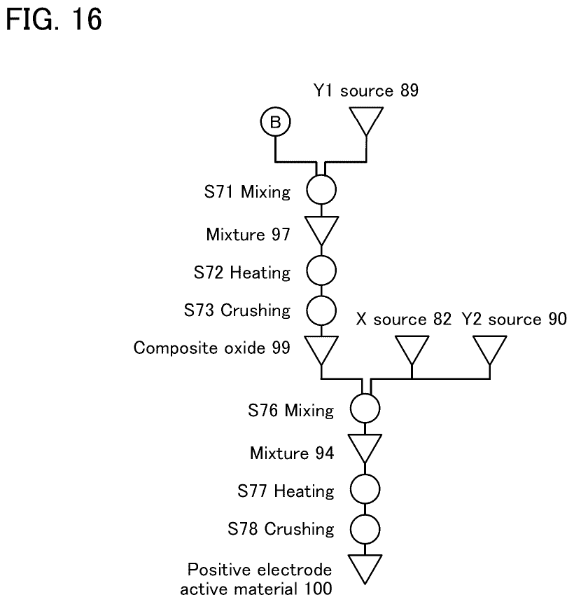

The process related to Formation Method 7 is described with reference to flow charts shown in FIG. 14 to FIG. 16 and the like. Note that although the flow charts in FIG. 15 and FIG. 16 describe part of the process in FIG. 14 in detail, the process described in detail is not always necessary. The process proceeds from B in FIG. 15 to B in FIG. 16.

Formation Method 7 is a method in which, in Formation Method 6, the first additive element source 82 is not introduced at the same time as the cobalt source 81, and the first additive element source 82 is introduced at the same time as the third additive element source 90 (denoted as Y2 source in the drawings) when the third additive element source 90 is introduced into the composite oxide 99.

An element selected as the first additive element X (e.g., gallium) and an element selected as the third additive element Y2 (e.g., aluminum) have the same valence. Such elements with the same valence are preferably added at the same time. Furthermore, instead of aluminum of the third additive element Y2, gallium of the first additive element X may be added.

The description of Formation Method 1 to Formation Method 5, other than the above different structure and method, can be referred to for FIG. 14 to FIG. 16 showing Formation Method 7.

According to Formation Method 7, the positive electrode active material 100 such as lithium cobalt oxide can be formed. The positive electrode active material 100 can reflect the shape of the cobalt compound 95 that is the precursor. Furthermore, according to Formation Method 7, the first additive element X, the second additive element Y1, and the third additive element Y2 can exist in the surface portion of the positive electrode active material 100.

The lithium cobalt oxide is preferred in containing few impurities. However, sulfur might be detected from the lithium cobalt oxide, when a sulfide is used as a starting material. With use of GD-MS, ICP-MS, or the like, elements in the whole particle of the positive electrode active material can be analyzed to measure the concentration of sulfur.

### <Formation Method 8>

The process related to Formation Method 8 is described. Formation Method 8 can be applied to any of Formation Method 1 to Formation Method 7 described above and is implemented after obtaining the positive electrode active material 100. Note that Formation Method 8 is not necessarily implemented.

The positive electrode active material 100 of one embodiment of the present invention may be a positive electrode active material composite including a coating layer that covers at least part of the positive electrode active material 100. As the coating layer, one or more of glass, an oxide, and LiM2PO₄ (M2 is one or more selected from Fe, Ni, Co, and Mn) can be used, for example.

As glass contained in the coating layer of the positive electrode active material composite, a material including an amorphous part can be used. Examples of the material including an amorphous part include a material containing one or more selected from SiO₂, SiO, Al₂O₃, TiO₂, Li₄SiO₄, Li₃PO₄, Li₂S, SiS₂, B₂S₃, GeS₄, AgI, Ag₂O, Li₂O, P₂O₅, B₂O₃, V₂O₅, and the like; Li₇P₃S₁₁; and Li_{1+x+y}AlₓTi₂₋ₓSi_{y}P_{3-y}O₁₂ (0<x<2 and 0<y<3). The material including an amorphous part can be used in the state where the entire part is amorphous or in the state of crystallized glass part of which is crystallized (also referred to as glass ceramic). The glass desirably has lithium-ion conductivity. Having the lithium-ion conductivity can also be regarded as having a diffusion property of lithium ions and a penetration property of lithium ions. The melting point of the glass is preferably 800° C. or lower, further preferably 500° C. or lower. The glass preferably has electron conductivity. Furthermore, the glass preferably has a softening point of 800° C. or lower, and Li₂O—B₂O₃—SiO₂ based glass can be used, for example.

Examples of the oxide contained in the coating layer of the positive electrode active material composite include aluminum oxide, zirconium oxide, hafnium oxide, and niobium oxide. Examples of LiM2PO₄ (M2 is one or more selected from Fe, Ni, Co, and Mn) contained in the coating layer of the positive electrode active material composite include LiFePO₄, LiNiPO₄, LiCoPO₄, LiMnPO₄, LiFeₐNi_{b}PO₄, LiFeₐCo_{b}PO₄, LiFeₐMn_{b}PO₄, LiNiₐCo_{b}PO₄, LiNiₐMn_{b}PO₄ (a+b is 1 or less, 0<a<1, and 0<b<1), LiFe_{c}Ni_{d}CoₑPO₄, LiFe_{c}Ni_{d}MnₑPO₄, LiNi_{c}Co_{d}MnₑPO₄ (c+d+e is 1 or less, 0<c<1, 0<d<1, and 0<e<1), and LiFe_{f}Ni_{g}CoₕMnᵢPO₄ (f+g+h+i is 1 or less, 0<f<1, 0<g<1, 0<h<1, and 0<i<1).

Composing process can be performed to form the coating layer of the positive electrode active material composite. As the composing process, one or more of the following composing processes can be used: a composing process using mechanical energy, e.g., a mechanochemical method, a mechanofusion method, or a ball mill method; a composing process using a liquid phase reaction, e.g., a coprecipitation method, a hydrothermal method, or a sol-gel method; and a composing process using a gas phase reaction, e.g., a barrel sputtering method, an ALD (Atomic Layer Deposition) method, an evaporation method, or a CVD (Chemical Vapor Deposition) method. For example, for the composing process using mechanical energy, Picobond by Hosokawa Micron Ltd. can be used. Heat treatment is preferably performed once or more times in the composing process.

Since the contact between the positive electrode active material 100 and an electrolyte solution and the like is reduced by the positive electrode active material composite, the deterioration of the secondary battery can be inhibited.

This embodiment can be implemented in appropriate combination with the other embodiments.

### Embodiment 2

In this embodiment, a positive electrode active material of one embodiment of the present invention is described.

### [Positive Electrode Active Material]

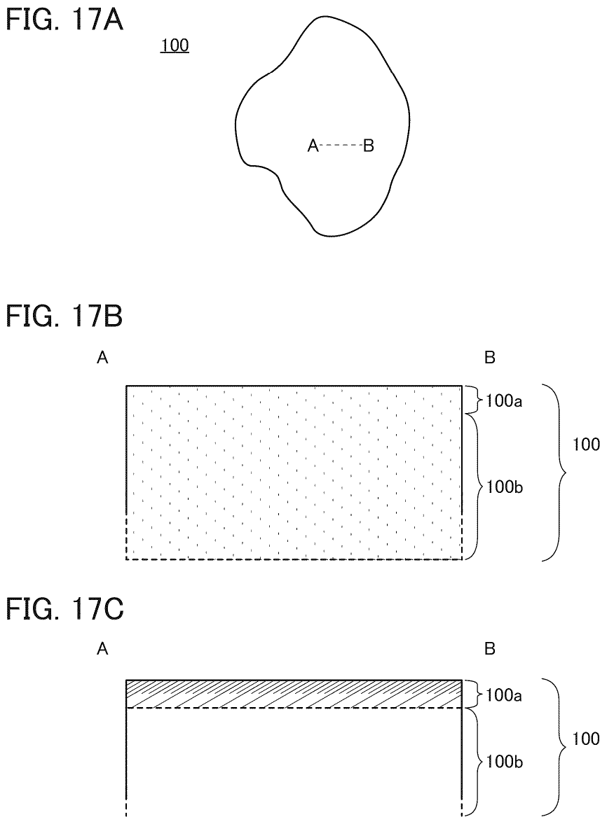

A positive electrode active material of one embodiment of the present invention is described with reference to FIG. 17 to FIG. 21.

FIG. 17A is a schematic top view of the positive electrode active material 100 which is one embodiment of the present invention. FIG. 17B and FIG. 17C are schematic cross-sectional views taken along A-B in FIG. 17A.

### [Contained Elements and Distribution]

The positive electrode active material 100 contains lithium, the transition metal M1, oxygen, and the first additive element X and/or the second additive element Y. The positive electrode active material 100 can be regarded as a composite oxide represented by LiM1O₂ containing the first additive element X and/or the second additive element Y.

As the transition metal M1 contained in the positive electrode active material 100, a metal that can form, together with lithium, a layered rock-salt composite oxide belonging to the space group R-3m is preferably used. As the transition metal M1, at least one of manganese, cobalt, and nickel can be used, for example. That is, as the transition metal M1 contained in the positive electrode active material 100, only cobalt may be used, only nickel may be used, two metals of cobalt and manganese may be used or two metals of cobalt and nickel may be used, or three metals of cobalt, manganese, and nickel may be used. In other words, the positive electrode active material 100 can contain a composite oxide containing lithium and the transition metal M1, such as lithium cobalt oxide, lithium nickel oxide, lithium cobalt oxide in which manganese is substituted for part of cobalt, lithium cobalt oxide in which nickel is substituted for part of cobalt, or lithium nickel-manganese-cobalt oxide.

As the first additive element X contained in the positive electrode active material 100, it is preferable to use one or more selected from gallium, aluminum, boron, nickel, and indium. Furthermore, the positive electrode active material 100 preferably contains the second additive element Y in addition to the first additive element X As the second additive element Y, it is preferable to use one or more selected from nickel, cobalt, magnesium, calcium, fluorine, aluminum, manganese, titanium, zirconium, yttrium, vanadium, chromium, niobium, lanthanum, hafnium, zinc, silicon, sulfur, phosphorus, and boron. The first additive element X and/or the second additive element Y further stabilize the crystal structure of the positive electrode active material 100 in some cases as described later. That is, the positive electrode active material 100 can contain lithium cobalt oxide to which gallium is added, lithium cobalt oxide to which gallium and magnesium are added, lithium cobalt oxide to which gallium, magnesium, and fluorine are added, lithium cobalt oxide to which magnesium and fluorine are added, lithium cobalt oxide to which magnesium, fluorine, and titanium are added, lithium nickel-cobalt oxide to which magnesium and fluorine are added, lithium cobalt-aluminum oxide to which magnesium and fluorine are added, lithium nickel-cobalt-aluminum oxide, lithium nickel-cobalt-aluminum oxide to which magnesium and fluorine are added, lithium nickel-manganese-cobalt oxide to which magnesium and fluorine are added, or the like. In this specification and the like, the first additive element X and the second additive element Y may be rephrased as a constituent of an additive, a mixture, or a raw material or the like.

As illustrated in FIG. 17B, the positive electrode active material 100 includes a surface portion 100a and an inner portion 100b. A region which is deeper than the surface portion 100a of the positive electrode active material 100 is referred to as the inner portion 100b. It is preferable that the inner portion 100b contain the first additive element X, and the first additive element X be contained in the entire region of the inner portion 100b. Note that the first additive element X may be contained not only in the inner portion 100b but also in the surface portion 100a.

In addition to the region containing the first additive element X illustrated in FIG. 17B, the second additive element Y may be contained in the surface portion 100a. The surface portion 100a preferably has a higher concentration of the second additive element Y than the inner portion 100b. In the case of containing the second additive element Y in the surface portion 100a, the second additive element Y preferably has a concentration gradient becoming higher from the inner portion to the surface as illustrated with gradation in FIG. 17C. A plane generated by a crack may also be referred to as a surface.

As for a closed split generated in the inner portion 100b in the positive electrode active material 100 of one embodiment of the present invention in charge and discharge, when the first additive element X is contained in the inner portion 100b, the closed split is expected not to be generated easily.

In order to prevent the breakage of a layered structure formed of octahedrons of cobalt and oxygen even when lithium is extracted, by charge, from the positive electrode active material 100 of one embodiment of the present invention that contains the first additive element X and/or the second additive element Y in the surface portion 100a, reinforcement is performed by the surface portion 100a having a high concentration of the second additive element Y, i.e., the outer portion of a particle. The surface portion 100a having the high concentration of the second additive element Y is desirably provided in at least part of the surface portion of the particle, preferably in a region of half or more of the surface portion of the particle, further preferably in the entire region of the surface portion of the particle.

In the positive electrode active material 100 of one embodiment of the present invention, a region of the concentration gradient of the second additive element Y is desirably provided in at least part of the surface portion of the particle, preferably in a region of half or more of the surface portion of the particle, further preferably in the entire region of the surface portion of the particle. A situation where only part of the surface portion 100a has reinforcement is not preferable because stress might be concentrated on parts that do not have reinforcement. The concentration of stress on part of the inside of the particle might cause defects such as closed splits or cracks from that part, leading to breakage of the positive electrode active material and a decrease in charge and discharge capacity.

Gallium, aluminum, boron, and indium are each trivalent and can exist at a transition metal site in the layered rock-salt crystal structure. Gallium, aluminum, boron, and indium can inhibit dissolution of surrounding cobalt. Furthermore, gallium, aluminum, boron, and indium can inhibit cation mixing of surrounding cobalt (movement of cobalt to a lithium site). Moreover, the bonding strength of oxygen with gallium, aluminum, boron, and indium is high, thereby inhibiting extraction of oxygen around gallium, aluminum, boron, and indium. Hence, any one or more of gallium, aluminum, boron, and indium contained as the first additive element X enables the positive electrode active material 100 to have the crystal structure that is unlikely to be broken by repetitive charge and discharge.

Magnesium is divalent and is more stable in lithium sites than in transition metal sites in the layered rock-salt crystal structure; thus, magnesium is likely to enter the lithium sites. An appropriate concentration of magnesium in the lithium sites of the surface portion 100a facilitates maintenance of the layered rock-salt crystal structure. The bonding strength of magnesium with oxygen is high, thereby inhibiting extraction of oxygen around magnesium. An appropriate concentration of magnesium does not have an adverse effect on insertion and extraction of lithium in charge and discharge, and is thus preferable. However, excess magnesium might adversely affect insertion and extraction of lithium.

When fluorine, which is a monovalent anion, is substituted for part of oxygen in the surface portion 100a, the lithium extraction energy is lowered. This is because the change in the valence of cobalt ions associated with lithium extraction differs depending on the presence or absence of fluorine. For example, the change in the valence of cobalt ions is trivalent to tetravalent in the case of not containing fluorine and divalent to trivalent in the case of containing fluorine, and the oxidation-reduction potential of cobalt ions differs therebetween. It can thus be said that when fluorine is substituted for part of oxygen in the surface portion 100a of the positive electrode active material 100, lithium ions near fluorine are likely to be extracted and inserted smoothly. Thus, using such a positive electrode active material 100 in a secondary battery is preferable because the charge and discharge characteristics, rate performance, and the like are improved.

A titanium oxide is known to have superhydrophilicity. Accordingly, the positive electrode active material 100 including an oxide of titanium in the surface portion 100a presumably has good wettability with respect to a high-polarity solvent. Such the positive electrode active material 100 and a high-polarity electrolyte solution can have favorable contact at the interface therebetween and presumably inhibit a resistance increase when a secondary battery is formed using the positive electrode active material 100. In this specification and the like, an electrolyte solution may be read as an electrolyte.

The voltage of a positive electrode generally increases with increasing charge voltage of a secondary battery. The positive electrode active material of one embodiment of the present invention has a stable crystal structure even at high voltage. The stable crystal structure of the positive electrode active material in a charged state can inhibit a capacity decrease due to repetitive charge and discharge.

A short circuit of a secondary battery might cause not only malfunction in charge operation and/or discharge operation of the secondary battery but also heat generation and firing. In order to obtain a safe secondary battery, a short-circuit current is preferably inhibited even at high charge voltage. In the positive electrode active material 100 of one embodiment of the present invention, a short-circuit current is inhibited even at high charge voltage. Thus, a secondary battery with high capacity and safety can be obtained.

It is preferable that a secondary battery using the positive electrode active material 100 of one embodiment of the present invention have high capacity, excellent charge and discharge cycle performance, and safety simultaneously.

The gradient of the concentration of the additive can be evaluated using energy dispersive X-ray spectroscopy (EDX). EDX can be used in combination with SEM or STEM. In the EDX measurement, to measure along a line segment connecting between two portions is referred to as EDX line analysis in some cases. In the EDX measurement, to measure a region in the shape of a rectangle or the like while scanning the region and evaluate the region two-dimensionally is referred to as EDX area analysis in some cases. In addition, the case of extracting data of a linear region from EDX area analysis and evaluating the atomic concentration distribution in the positive electrode active material is also referred to as EDX line analysis in some cases.

By EDX area analysis (e.g., element mapping), the concentrations of the additive in the surface portion 100a, the inner portion 100b, the vicinity of a crystal grain boundary, and the like of the positive electrode active material 100 can be quantitatively analyzed. By EDX linear analysis, the concentration distribution of the first additive element X and the second additive element Y can be analyzed.

When the positive electrode active material 100 is analyzed with the EDX linear analysis, a peak of the magnesium concentration (the position where the concentration has the maximum value) in the surface portion 100a preferably exists in a region from the surface of the positive electrode active material 100 to a depth of 3 nm toward the center, further preferably to a depth of 1 nm, and still further preferably to a depth of 0.5 nm.

In addition, the distribution of fluorine contained in the positive electrode active material 100 preferably overlaps with the distribution of magnesium. Thus, when the EDX linear analysis is performed, a peak of the fluorine concentration (the position where the concentration has the maximum value) in the surface portion 100a preferably exists in a region from the surface of the positive electrode active material 100 to a depth of 3 nm toward the center, further preferably to a depth of 1 nm, and still further preferably to a depth of 0.5 nm.

As described above, excess additives in the positive electrode active material 100 might adversely affect insertion and extraction of lithium. The use of such a positive electrode active material 100 for a secondary battery might cause a resistance increase, a capacity decrease, and the like. Meanwhile, when the amount of additive is insufficient, the additive element is not distributed throughout the surface portion 100a, which might reduce the effect of maintaining the crystal structure. The additive at an appropriate concentration is required in the positive electrode active material 100; however, the adjustment of the concentration is not easy.

For this reason, the positive electrode active material 100 may include a region where excess additives are unevenly distributed, for example. With such a region, the excess additive is removed from the other region, and the additive concentration in most of the inner portion and the surface portion of the positive electrode active material 100 can be appropriate. An appropriate additive concentration in most of the inner portion and the surface portion of the positive electrode active material 100 can inhibit a resistance increase, a capacity decrease, and the like when the positive electrode active material 100 is used for a secondary battery. A feature of inhibiting a resistance increase of a secondary battery is extremely preferable especially in charge and discharge at a high rate.

In the positive electrode active material 100 including the region where the excess additive is unevenly distributed, mixing of an excess additive to some extent in the formation process is acceptable. This is preferable because the margin of production can be increased.

Note that in this specification and the like, uneven distribution means that the concentration of an element in a certain region differs from another region. The uneven distribution may be rephrased as segregation, precipitation, unevenness, deviation, high concentration, low concentration, or the like.

### [Crystal Structure]

A material with the layered rock-salt crystal structure, such as lithium cobalt oxide (LiCoO₂), is known to have a high discharge capacity and excel as a positive electrode active material of a secondary battery. As an example of the material with the layered rock-salt crystal structure, a composite oxide represented by LiM1O₂ is given.

It is known that the Jahn-Teller effect in a transition metal compound varies in degree according to the number of electrons in the d orbital of the transition metal.

In a compound containing nickel, distortion is likely to be caused because of the Jahn-Teller effect in some cases. Accordingly, when high-voltage charge and discharge are performed on LiNiO₂, the crystal structure might be broken because of the distortion. The influence of the Jahn-Teller effect is suggested to be small in LiCoO₂; hence, LiCoO₂ is preferable because the resistance to high-voltage charge and discharge is higher in some cases.

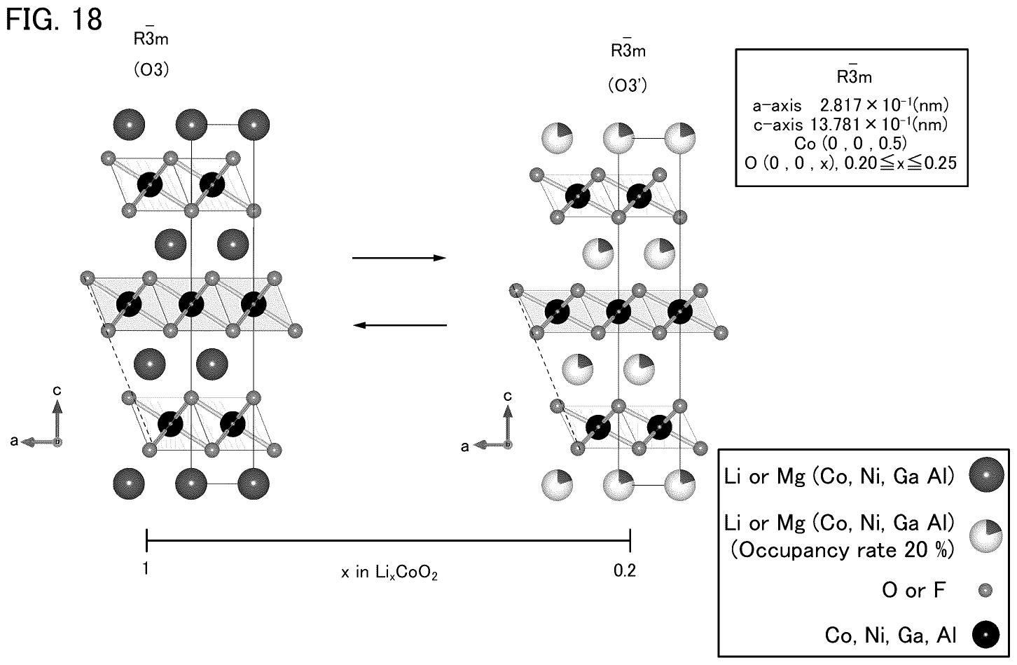

Positive electrode active materials are described with reference to FIG. 18 to FIG. 21. In FIG. 18 to FIG. 21, the case where cobalt is used as the transition metal contained in the positive electrode active material is described.

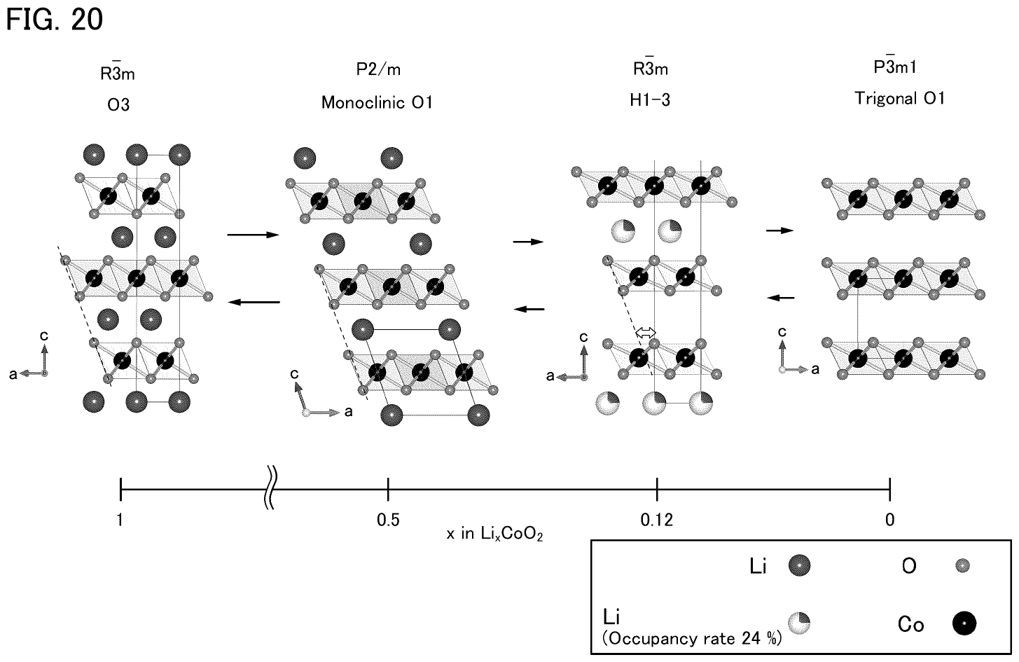

The positive electrode active material shown in FIG. 20 is lithium cobalt oxide (LiCoO₂) that does not contain the first additive element X and the second additive element Y substantially. The crystal structure of the lithium cobalt oxide shown in FIG. 20 is changed depending on a charge depth. In other words, the crystal structure changes depending on the occupancy rate x of lithium in the lithium sites when the lithium cobalt oxide is referred to as LiₓCoO₂.

As shown in FIG. 20, lithium cobalt oxide in a state with x of 1 (discharged state) includes a region having the crystal structure belonging to the space group R-3m, and includes three CoO₂ layers in a unit cell. Thus, this crystal structure is referred to as an O3 type crystal structure in some cases. Note that the CoO₂ layer has a structure in which an octahedral structure with cobalt coordinated to six oxygen atoms continues in a plane direction in an edge-shared state.

Lithium cobalt oxide with x of 0 has a crystal structure belonging to the space group P-3m1 and includes one CoO₂ layer in a unit cell. Thus, this crystal structure is referred to as an O1 type crystal structure (trigonal O1) in some cases.

Lithium cobalt oxide with x of approximately 0.12 has the crystal structure belonging to the space group R-3m. This structure can also be regarded as a structure in which CoO₂ structures such as P-3m1 (O1) and LiCoO₂ structures such as R-3m (O3) are alternately stacked. Thus, this crystal structure is referred to as an H1-3 type crystal structure in some cases. Note that since insertion and extraction of lithium do not necessarily uniformly occur in reality, the H1-3 type crystal structure is started to be observed when x is approximately 0.25 in practice. The number of cobalt atoms per unit cell in the actual H1-3 type crystal structure is twice that in other structures. However, in this specification including FIG. 20, the c-axis of the H1-3 type crystal structure is half that of the unit cell for easy comparison with the other structures.

For the H1-3 type crystal structure, the coordinates of cobalt and oxygen in the unit cell can be expressed as follows, for example: Co (0, 0, 0.42150±0.00016), O₁ (0, 0, 0.27671±0.00045), and O₂ (0, 0, 0.11535±0.00045). Note that O₁ and O₂ are each an oxygen atom. In this manner, the H1-3 type crystal structure is represented by a unit cell including one cobalt and two oxygen. Meanwhile, the O3′ type crystal structure of one embodiment of the present invention is preferably represented by a unit cell including one cobalt and one oxygen, as described later. This means that the symmetry of cobalt and oxygen differs between the O3′ type crystal structure and the H1-3 type structure, and the amount of change from the O3 structure is smaller in the O3′ type crystal structure than in the H1-3 type structure. A preferred unit cell for representing a crystal structure in a positive electrode active material is selected such that the value of GOF (goodness of fit) is smaller in Rietveld analysis of X-ray diffraction (XRD), for example.

When charge at a high charge voltage of 4.6 V or more with reference to the redox potential of a lithium metal or charge with a large depth with x of 0.24 or less and discharge are repeated, the crystal structure of lithium cobalt oxide changes (i.e., an unbalanced phase change occurs) repeatedly between the H1-3 type crystal structure and the structure belonging to R-3m (O3) in a discharged state.

However, there is a large shift in the CoO₂ layers between these two crystal structures. As denoted by the dotted line and the arrow in FIG. 20, the CoO₂ layer in the H1-3 type crystal structure largely shifts from R-3m (O3). Such a dynamic structural change can adversely affect the stability of the crystal structure.

A difference in volume is also large. The O3 type crystal structure in a discharged state and the H1-3 type crystal structure which contain the same number of cobalt atoms have a difference in volume of more than or equal to 3.0%.

In addition, a structure in which CoO₂ layers are arranged continuously, such as P-3m1 (O1), included in the H1-3 type crystal structure is highly likely to be unstable.

Thus, the repeated high-voltage charge and discharge causes loss of the crystal structure of lithium cobalt oxide. The broken crystal structure triggers deterioration of the cycle performance. This is probably because the loss of the crystal structure reduces sites where lithium can stably exist and makes it difficult to insert and extract lithium.

In the positive electrode active material 100 of one embodiment of the present invention, the shift in CoO₂ layers can be small in repeated high-voltage charge and discharge. Furthermore, the change in the volume can be small. Accordingly, the positive electrode active material of one embodiment of the present invention can enable excellent cycle performance. In addition, the positive electrode active material of one embodiment of the present invention can have a stable crystal structure in a high-voltage charged state. Thus, the positive electrode active material of one embodiment of the present invention inhibits a short circuit in some cases while the high-voltage charged state is maintained. This is preferable because the safety is further improved.

The positive electrode active material of one embodiment of the present invention has a small crystal-structure change and a small volume difference per the same number of atoms of the transition metal between a sufficiently discharged state and a high-voltage charged state.

FIG. 18 shows the crystal structures of the positive electrode active material 100 before and after being charged and discharged. The positive electrode active material 100 is a composite oxide containing lithium, cobalt as the transition metal, and oxygen. In addition to the above, magnesium is preferably contained as the second additive element Y. Furthermore, it is preferable that halogen such as fluorine or chlorine be further contained as the second additive element Y.

The crystal structure with x of 1 (discharged state) in FIG. 18 is R-3m (O3), which is the same as that in FIG. 20. Meanwhile, the positive electrode active material 100 with a charge depth in a sufficiently charged state includes a crystal whose structure is different from the H1-3 type crystal structure. This structure belongs to the space group R-3m, and is not a spinel crystal structure but a structure in which an ion of cobalt, magnesium, or the like occupies a site coordinated to six oxygen atoms and the cation arrangement has symmetry similar to that of the spinel structure. Furthermore, the periodicity of CoO₂ layers of this structure is the same as that in the O3 type structure. This structure is thus referred to as the O3′ type crystal structure or the pseudo-spinel crystal structure in this specification and the like. Accordingly, the O3′ type crystal structure may be rephrased as the pseudo-spinel crystal structure. Note that although the indication of lithium is omitted in the diagram of the O3′ type crystal structure shown in FIG. 18 to explain the symmetry of cobalt atoms and the symmetry of oxygen atoms, a lithium of 20 atomic % or less, for example, with respect to cobalt practically exists between the CoO₂ layers. In both the O3 type crystal structure and the O3′ type crystal structure, a slight amount of magnesium preferably exists between the CoO₂ layers, i.e., in lithium sites. In addition, a slight amount of halogen such as fluorine preferably exists at random in oxygen sites.

The O3′ type crystal structure can also be regarded as a crystal structure that contains Li between layers at random but is similar to a CdCl₂ crystal structure. The crystal structure similar to the CdCl₂ crystal structure is close to a crystal structure of lithium nickel oxide when charged until x becomes 0.06 (Li_{0.06}NiO₂); however, pure lithium cobalt oxide or a layered rock-salt positive electrode active material containing a large amount of cobalt is known not to have this crystal structure in general.

In the positive electrode active material 100 of one embodiment of the present invention, a change in the crystal structure caused when a large amount of lithium is extracted by charging with high voltage is smaller than that in a conventional positive electrode active material. As shown by the dotted lines in FIG. 18, for example, CoO₂ layers hardly shift between the crystal structures.

Specifically, the crystal structure of the positive electrode active material 100 of one embodiment of the present invention is highly stable even when charge voltage is high. For example, at a charge voltage that makes a conventional positive electrode active material have the H1-3 type crystal structure, for example, at a voltage of approximately 4.6 V with reference to the potential of a lithium metal, the crystal structure belonging to R-3m (O3) can be maintained. Moreover, in a higher charge voltage range, for example, at voltages of approximately 4.65 V to 4.7 V with reference to the potential of a lithium metal, the O3′ type crystal structure can be obtained. At a much higher charge voltage, a H1-3 type crystal is eventually observed in some cases. In the case where graphite, for instance, is used as a negative electrode active material in a secondary battery, a charge voltage region where the R-3m (O3) crystal structure can be maintained exists when the voltage of the secondary battery is, for example, higher than or equal to 4.3 V and lower than or equal to 4.5 V. In a higher charge voltage region, for example, at a voltage higher than or equal to 4.35 V and lower than or equal to 4.55 V with reference to the potential of a lithium metal, there is a region within which the O3′ type crystal structure can be obtained.

Thus, in the positive electrode active material 100 of one embodiment of the present invention, the crystal structure is unlikely to be broken even when high-voltage charge and discharge are repeated.

In addition, in the positive electrode active material 100, a difference in the volume per unit cell between the O3 type crystal structure with x of 1 and the O3′ type crystal structure with x of 0.2 is less than or equal to 2.5%, specifically, less than or equal to 2.2%.

Note that in the unit cell of the O3′ type crystal structure, the coordinates of cobalt and oxygen can be represented by Co (0, 0, 0.5) and O (0, 0, x) within the range of 0.20≤x≤0.25.

A slight amount of the second additive element Y such as magnesium randomly existing between the CoO₂ layers, i.e., in lithium sites, can inhibit a shift in the CoO₂ layers. Thus, magnesium between the CoO₂ layers makes it easier to obtain the O3′ type crystal structure. Therefore, magnesium desirably exists in at least part of the surface portion of the particle of the positive electrode active material 100 of one embodiment of the present invention, preferably in a region of half or more of the surface portion of the particle, further preferably in the entire region of the surface portion of the particle. To distribute magnesium into the entire region of the surface portion of the particle, heat treatment is preferably performed in the manufacturing process of the positive electrode active material 100 of one embodiment of the present invention.

However, heat treatment at an excessively high temperature may cause cation mixing, which increases the possibility of entry of the second additive element Y such as magnesium into the cobalt sites. Magnesium existing in the cobalt sites does not have the effect of maintaining the R-3m structure in a high-voltage charged state. Furthermore, when the heat treatment temperature is excessively high, adverse effects such as reduction of cobalt to have a valence of two and evaporation of lithium are concerned.

In view of the above, a halogen compound such as a fluorine compound is preferably added to lithium cobalt oxide before the heat treatment for distributing magnesium throughout the surface portion of the particle. The addition of the halogen compound decreases the melting point of lithium cobalt oxide. The decreased melting point makes it easier to distribute magnesium throughout the particle at a temperature at which the cation mixing is unlikely to occur. Furthermore, the fluorine compound probably increases corrosion resistance to hydrofluoric acid generated by decomposition of an electrolyte solution.

When the magnesium concentration is higher than or equal to a desired value, the effect of stabilizing a crystal structure becomes small in some cases. This is probably because magnesium enters the cobalt sites in addition to the lithium sites. The number of magnesium atoms in the positive electrode active material of one embodiment of the present invention is preferably 0.001 to 0.1 times, preferably larger than 0.01 times and less than 0.04 times, still further preferably approximately 0.02 times the number of atoms of a transition metal. The magnesium concentration described here may be a value obtained by element analysis on the whole particles of the positive electrode active material using ICP-MS or the like, or may be a value based on the ratio of the raw materials mixed in the formation process of the positive electrode active material, for example.

Gallium, aluminum, boron, and indium and the transition metal typified by nickel and manganese preferably exist in cobalt sites; and although part of them may exist in lithium sites, the amount is preferably as small as possible. Magnesium preferably exists in lithium sites. Fluorine may be substituted for part of oxygen.

As the contents of the first additive element X and the second additive element Y contained in the positive electrode active material of one embodiment of the present invention increases, the capacity of the positive electrode active material decreases in some cases. As an example, one possible reason is that lithium ions in the vicinity of transition metal sites cannot contribute to charge and discharge when gallium, aluminum, boron, or indium enters the transition metal sites. As an example, one possible reason is that the amount of lithium that contributes to charge and discharge decreases when magnesium enters the lithium sites. Another possible reason is that excess magnesium generates a magnesium compound that does not contribute to charge and discharge.

In FIG. 18, the symmetry of the oxygen atoms slightly differs between the O3 type crystal structure and the O3′ type crystal structure. Specifically, the oxygen atoms in the O3 type crystal structure are aligned with the dotted line, whereas strict alignment of the oxygen atoms is not observed in the O3′ type crystal structure. This is caused by an increase in the amount of tetravalent cobalt along with a decrease in the amount of lithium in the O3′ type crystal structure, resulting in an increase in the Jahn-Teller distortion. Consequently, the octahedral structure of CoO₆ is distorted. In addition, repelling of oxygen atoms in the CoO₂ layer becomes stronger along with a decrease in the amount of lithium, which also affects the difference in symmetry of oxygen atoms.

As described above, the surface portion 100a of the positive electrode active material 100 of one embodiment of the present invention preferably has a composition different from that in the inner portion 100b, i.e., the concentrations of the second additive element Y such as magnesium and fluorine are preferably higher than those in the inner portion. The surface portion 100a having such a composition preferably has a crystal structure stable at room temperature. Accordingly, the surface portion 100a may have a crystal structure different from that of the inner portion 100b. For example, at least part of the surface portion 100a of the positive electrode active material 100 of one embodiment of the present invention may have the rock-salt crystal structure. When the surface portion 100a and the inner portion 100b have different crystal structures, the orientations of crystals in the surface portion 100a and the inner portion 100b are preferably substantially aligned with each other.

Anions of a layered rock-salt crystal and anions of a rock-salt crystal form a cubic close-packed structure (face-centered cubic lattice structure). Anions of an O3′ type crystal are presumed to form a cubic close-packed structure. When these crystals are in contact with each other, there is a crystal plane at which orientations of cubic close-packed structures composed of anions are aligned. Note that a space group of the layered rock-salt crystal and the O3′ type crystal is R-3m, which is different from a space group Fm-3m of a rock-salt crystal (a space group of a general rock-salt crystal) and a space group Fd-3m of a rock-salt crystal (a space group of a rock-salt crystal having the simplest symmetry); thus, the Miller index of the crystal plane satisfying the above conditions in the layered rock-salt crystal and the O3′ type crystal is different from that in the rock-salt crystal. In this specification, a state where the orientations of the cubic close-packed structures composed of anions in the layered rock-salt crystal, the O3′ type crystal, and the rock-salt crystal are aligned is sometimes referred to as a state where crystal orientations are substantially aligned.

Substantial alignment of the crystal orientations in two regions can be judged from a TEM (transmission electron microscope) image, a STEM (scanning transmission electron microscope) image, a HAADF-STEM (high-angle annular dark-field scanning transmission electron microscope) image, an ABF-STEM (annular bright-field scanning transmission electron microscope) image, or the like. X-ray diffraction (XRD), electron diffraction, neutron diffraction, and the like can also be used for judging. When the crystal orientations are substantially aligned with each other, a state where an angle between the orientations of lines in each of which cations and anions are alternately arranged is less than or equal to 5°, preferably less than or equal to 2.5° is observed from a TEM image and the like. Note that in the TEM image and the like, a light element such as oxygen or fluorine cannot be clearly observed in some cases; however, in such a case, alignment of orientations can be judged by arrangement of metal elements.

However, in the surface portion 100a where only MgO is contained or MgO and CoO(II) form a solid solution, it is difficult to insert and extract lithium. Thus, the surface portion 100a should contain at least cobalt, and also contain lithium in a discharged state to have the path through which lithium is inserted and extracted. The cobalt concentration is preferably higher than the magnesium concentration.

The second additive element Y is preferably positioned in the surface portion 100a of the particle of the positive electrode active material 100 of one embodiment of the present invention. For example, the positive electrode active material 100 of one embodiment of the present invention may be covered with the coating film containing the second additive element Y.

Like the particle surface, the crystal grain boundary is also a plane defect. Thus, the crystal grain boundary tends to be unstable and its crystal structure easily starts to change. Therefore, when the concentration of the first added element X and/or the second additive element Y in the crystal grain boundary and its vicinity is higher, the change in the crystal structure can be inhibited more effectively.

In the case where the concentration of the first added element X and/or the second additive element Y is high in the crystal grain boundary and its vicinity, even when a crack is generated along the crystal grain boundary of the particle of the positive electrode active material 100 of one embodiment of the present invention, the concentration of the first added element X and/or the second additive element Y is increased in the vicinity of the surface generated by the crack. Thus, the positive electrode active material can have an increased corrosion resistance to hydrofluoric acid even after a crack is generated.

### [High-Voltage Charged State of Positive Electrode Active Material]

Whether or not a given positive electrode active material is the positive electrode active material 100 of one embodiment of the present invention, which has the O3′ type crystal structure at the time of high voltage charge, can be judged by analyzing a positive electrode charged with high voltage by XRD, electron diffraction, neutron diffraction, electron spin resonance (ESR), nuclear magnetic resonance (NMR), or the like. XRD is particularly preferable because the symmetry of a transition metal such as cobalt contained in the positive electrode active material can be analyzed with high resolution, the degrees of crystallinity and the crystal orientations can be compared, the distortion of lattice periodicity and the crystallite size can be analyzed, and a positive electrode itself obtained by disassembling a secondary battery can be measured with sufficient accuracy, for example.

As described above, the positive electrode active material 100 of one embodiment of the present invention features in a small change in the crystal structure between a high-voltage charged state and a discharged state. A material 50 wt % or more of which has the crystal structure that largely changes between a high-voltage charged state and a discharged state is not preferable because the material cannot withstand high-voltage charge and discharge. It should be noted that the intended crystal structure is not obtained in some cases only by addition of the additive. For example, although the positive electrode active material that is lithium cobalt oxide containing magnesium and fluorine is a commonality, the positive electrode active material has the O3′ type crystal structure at 60 wt % or more in some cases, and has the H1-3 type crystal structure at 50 wt % or more in other cases, when charged at high voltage. In some cases, lithium cobalt oxide containing magnesium and fluorine may have the O3′ type crystal structure at almost 100 wt % at a predetermined voltage, and increasing the voltage to be higher than the predetermined voltage may cause the H1-3 type crystal structure. Thus, to determine whether or not a positive electrode active material is the positive electrode active material 100 of one embodiment of the present invention, the crystal structure should be analyzed by XRD or other methods.

However, the crystal structure of a positive electrode active material in a high-voltage charged state or a discharged state may be changed with exposure to the air. For example, the O3′ type crystal structure changes into the H1-3 type crystal structure in some cases. For that reason, all samples are preferably handled in an inert atmosphere such as an argon atmosphere.

### <Charge Method 1>

High-voltage charge for determining whether or not a composite oxide is the positive electrode active material 100 of one embodiment of the present invention can be performed on a coin cell (CR2032 type with a diameter of 20 mm and a height of 3.2 mm) with a lithium counter electrode, for example.

More specifically, a positive electrode can be formed by application of a slurry in which the positive electrode active material, a conductive material, and a binder are mixed to a positive electrode current collector made of aluminum foil.

A lithium metal can be used for a counter electrode. Note that when the counter electrode is formed using a material other than the lithium metal, the potential of a secondary battery differs from the potential of the positive electrode. Unless otherwise specified, the voltage and the potential in this specification and the like refer to the potential of a positive electrode.

As an electrolyte contained in an electrolyte solution, 1 mol/L lithium hexafluorophosphate (LiPF₆) can be used. As the electrolyte solution, an electrolyte solution in which ethylene carbonate (EC) and diethyl carbonate (DEC) at EC:DEC=3:7 (volume ratio) and vinylene carbonate (VC) at 2 wt % are mixed can be used.

As a separator, 25-μm-thick polypropylene can be used.

Stainless steel (SUS) can be used for a positive electrode can and a negative electrode can.

The coin cell fabricated with the above conditions is charged with constant current at 4.6 V and 0.5 C and then charged with constant voltage until the current value reaches 0.01 C. Note that here, 1 C is set to 137 mA/g. The temperature is set to 25° C. After the charge is performed in this manner, the coin cell is disassembled in a glove box with an argon atmosphere to take out the positive electrode, whereby the positive electrode active material charged with high voltage can be obtained. In order to inhibit a reaction with components in the external environment, the taken positive electrode is preferably enclosed in an argon atmosphere in performing various analyses later. For example, XRD can be performed on the positive electrode active material enclosed in an airtight container with an argon atmosphere.

### <XRD>

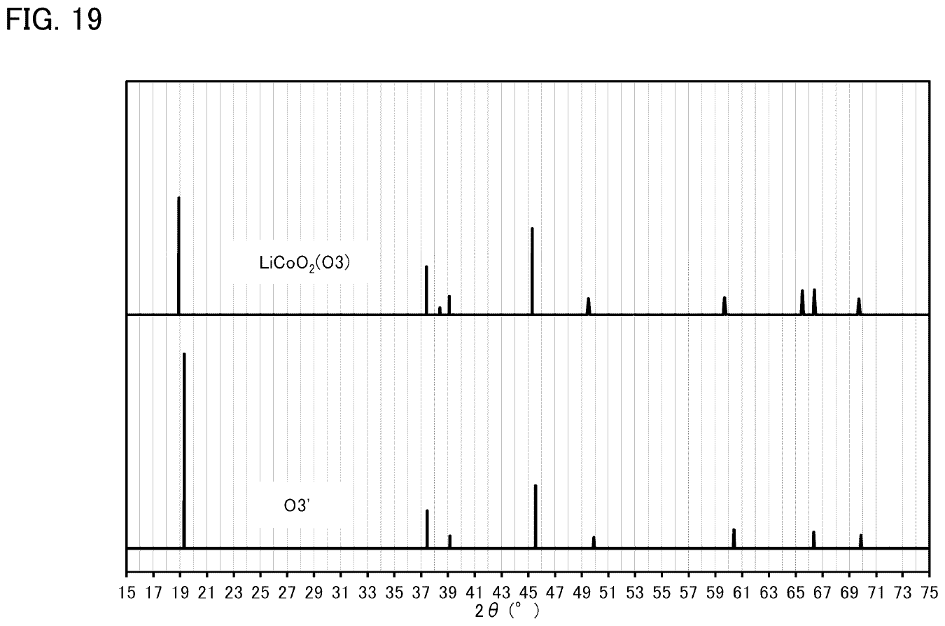

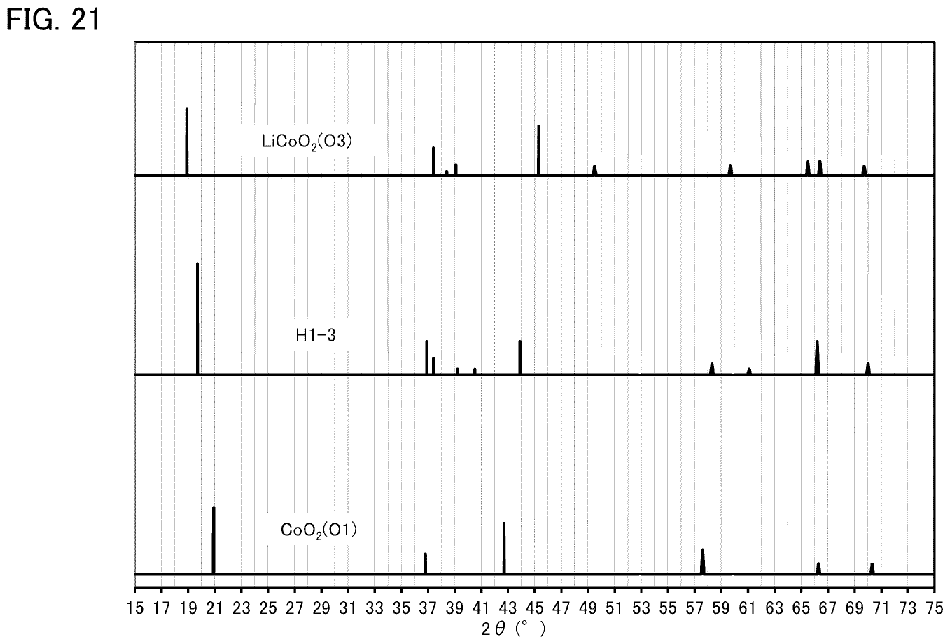

FIG. 19 and FIG. 21 show ideal powder XRD patterns with CuKα1 rays that are calculated from models of an O3′ type crystal structure and an H1-3 type crystal structure. For comparison, ideal XRD patterns calculated from the crystal structure of LiCoO₂ (O₃) with x of 1 and the crystal structure of CoO₂ (O1) with x of 0 are also shown. Note that the patterns of LiCoO₂ (O3) and CoO₂ (O1) were made from crystal structure data obtained from ICSD (Inorganic Crystal Structure Database) using Reflex Powder Diffraction, which is a module of Materials Studio (BIOVIA). The range of 20 was from 15° to 75°, the step size was 0.01, the wavelength λ1 was 1.540562=10⁻¹⁰ m, the wavelength λ2 was not set, and a single monochromator was used. Similarly, the H1-3 type crystal structure pattern was made from the crystal structure data (W. E. Counts et al., Journal of the American Ceramic Society, 1953, 36 [1], pp. 12-17. FIG. 01471). The pattern of the O3′ type crystal structure was estimated from the XRD pattern of the positive electrode active material of one embodiment of the present invention, the crystal structure was fitted with TOPAS ver. 3 (crystal structure analysis software manufactured by Bruker Corporation), and XRD patterns were made in a manner similar to those of other structures.

As shown in FIG. 19, the O3′ type crystal structure exhibits diffraction peaks at 2θ of 19.30±0.20° (greater than or equal to 19.10° and less than or equal to 19.50°) and 2θ of 45.55±0.10° (greater than or equal to 45.45° and less than or equal to 45.65°). More specifically, sharp diffraction peaks appear at 2θ of 19.30±0.10° (greater than or equal to 19.20° and less than or equal to 19.40°) and 2θ of 45.55±0.05° (greater than or equal to 45.50° and less than or equal to 45.60°). By contrast, as shown in FIG. 21, the H1-3 type crystal structure and CoO₂ (P-3m1, O1) do not exhibit peaks at these positions. Thus, the peaks at 2θ of 19.30±0.20° and 2θ of 45.55±0.10° in a high-voltage charged state can be the features of the positive electrode active material 100 of one embodiment of the present invention.

It can be said that the positions of the XRD diffraction peaks exhibited by the crystal structure with x of 1 are close to those of the XRD diffraction peaks exhibited by the crystal structure in a high-voltage charged state. More specifically, it can be said that a difference in the positions of two or more, preferably three or more of the main diffraction peaks between the crystal structures is 2θ=0.7° or less, preferably 2θ=0.5° or less.

Although the positive electrode active material 100 of one embodiment of the present invention has the O3′ type crystal structure at the time of high voltage charge, not all the particles necessarily have the O3′ type crystal structure. The positive electrode active material 100 may have another crystal structure or may be partly amorphous. Note that when the XRD patterns are subjected to the Rietveld analysis, the O3′ type crystal structure preferably accounts for greater than or equal to 50 wt %, further preferably greater than or equal to 60 wt %, still further preferably greater than or equal to 66 wt %. The positive electrode active material in which the O3′ type crystal structure accounts for greater than or equal to 50 wt %, preferably greater than or equal to 60 wt %, further preferably greater than or equal to 66 wt % can have sufficiently good cycle performance.

Furthermore, even after 100 or more cycles of charge and discharge after the measurement starts, the O3′ type crystal structure preferably accounts for greater than or equal to 35 wt %, further preferably greater than or equal to 40 wt %, still further preferably greater than or equal to 43 wt %, in the Rietveld analysis.

The crystallite size of the O3′ type crystal structure of the positive electrode active material particle is only decreased to approximately one-tenth that of LiCoO₂ (O3) in a discharged state. Thus, a clear peak of the O3′ type crystal structure can be observed in a high-voltage charged state, even under the same XRD measurement conditions as those of a positive electrode before the charge and discharge. By contrast, simple LiCoO₂ has a small crystallite size and exhibits a broad and small peak although it can partly have a structure similar to the O3′ type crystal structure. The crystallite size can be calculated from the half width of the XRD peak.

As described above, the influence of the Jahn-Teller effect is preferably small in the positive electrode active material of one embodiment of the present invention. It is preferable that the positive electrode active material of one embodiment of the present invention have a layered rock-salt crystal structure and mainly contain cobalt as a transition metal. The positive electrode active material of one embodiment of the present invention may contain the first additive element X and/or the second additive element Y described above in addition to cobalt as long as the influence of the Jahn-Teller effect is small.

In the positive electrode active material of one embodiment of the present invention, when the layered rock-salt crystal structure of the particle of the positive electrode active material in the discharged state or the state where charge and discharge are not performed is subjected to XRD analysis, a first peak is observed at 2θ of greater than or equal to 18.50° and less than or equal to 19.30°, and a second peak is observed at 2θ of greater than or equal to 38.00° and less than or equal to 38.80°, in some cases.

Note that the peaks appearing in the powder XRD patterns reflect the crystal structure of the inner portion 100b of the positive electrode active material 100, which accounts for the majority of the volume of the positive electrode active material 100. The crystal structure of the surface portion 100a or the like can be analyzed by electron diffraction of a cross section of the positive electrode active material 100, for example.

### [Defects in Positive Electrode Active Material]

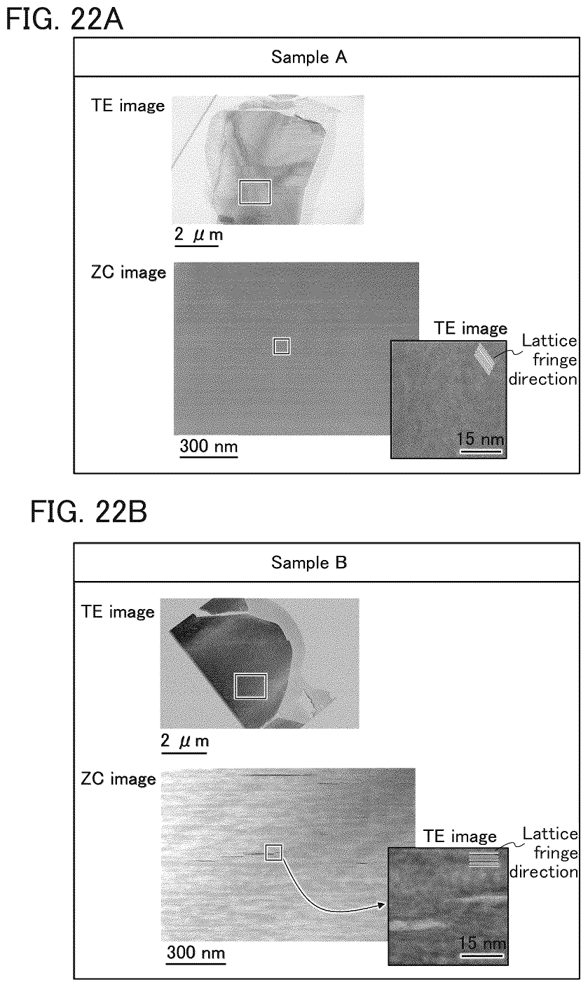

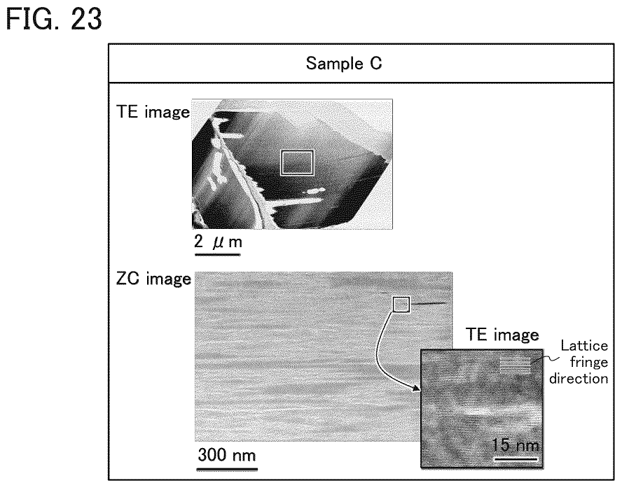

Examples of defects that can be generated in the positive electrode active material are shown in FIG. 22 to FIG. 23. An effect of inhibiting the generation of the defects described below can be expected in the positive electrode active material of one embodiment of the present invention.

When charge and discharge are performed under high-voltage charge conditions at 4.5 V or higher or at a high temperature (45° C. or higher), a progressive defect (also referred to as a closed split) might be generated inside a positive electrode active material particle.

In order to show examples of defects, a positive electrode active material not containing the first additive element X was prepared, and slurry in which a positive electrode active material, a conductive material, and a binder were mixed was applied to a positive electrode current collector made of aluminum foil, whereby positive electrode samples were formed. Coin cells (CR2032 type with a diameter of 20 mm and a height of 3.2 mm) were fabricated using the positive electrode samples and lithium foil as positive electrodes and negative electrodes, respectively, and charge and discharge were repeated 50 times. As charge, constant current charge was performed at 0.5 C until the voltage reached 4.7 V, and then constant voltage charge was performed until the current value reached 0.05 C. As discharge, constant current discharge was performed at 0.5 C until the voltage reached 2.5 V. Note that here 1 C was set to 137 mA/g. Three temperature conditions, that is, 25° C., 45° C., and 60° C., were set. After the charge and discharge were repeated 50 times in this manner, the coin cells were disassembled in a glove box with an argon atmosphere to take out the positive electrodes. The taken out degraded positive electrode samples are Sample A, Sample B, and Sample C. Here, the positive electrode after the test under the 25° C. condition is referred to as Sample A, the positive electrode after the test under the 45° C. condition is referred to as Sample B, and the positive electrode after the test under the 60° C. condition is referred to as Sample C.

### <STEM Observation>

Then, a cross section of the positive electrode of the secondary battery after 50 cycles was observed with a scanning transmission electron microscope (STEM). An FIB (Focused Ion Beam) was used for processing the sample for cross-sectional observation. The cross-sectional STEM observation results of Sample A, Sample B, and Sample C are respectively shown in FIG. 22A, FIG. 22B, and FIG. 23. In order to obtain the cross-sectional STEM images, HD-2700 manufactured by Hitachi High-Tech Corporation was used and the accelerating voltage was 200 kV.

In Sample A with the cycle test condition of 25° C. shown in FIG. 22A, a closed split is not observed in the positive electrode active material; while in Sample B with the cycle test condition of 45° C. and Sample C with the cycle test condition of 60° C. shown in FIG. 22B and FIG. 23, closed splits are observed in the positive electrode active materials. Note that the observed closed splits extend in a direction parallel to lattice fringes. The lattice fringes shown in FIG. 22A, FIG. 22B, and FIG. 23 are the image contrast originating from the atomic arrangement (crystal plane) of the positive electrode active material, and in this case, the lattice fringes are considered to originate from a crystal plane perpendicular to the c-axis.

### [Surface Roughness and Specific Surface Area]

The positive electrode active material 100 of one embodiment of the present invention preferably has a smooth surface with little unevenness. A smooth surface with little unevenness indicates favorable distribution of the second additive element Y in the surface portion 100a.

A smooth surface with little unevenness can be recognized from, for example, a cross-sectional SEM image or a cross-sectional TEM image of the positive electrode active material 100 or the specific surface area of the positive electrode active material 100.

The level of the surface smoothness of the positive electrode active material 100 can be quantified from its cross-sectional SEM image, as described below, for example.

First, the positive electrode active material 100 is processed with an FIB or the like such that its cross section is exposed. At this time, the positive electrode active material 100 is preferably covered with a protective film, a protective agent, or the like. Next, a SEM image of the interface between the positive electrode active material 100 and the protective film or the like is taken. The SEM image is subjected to noise processing using image processing software. For example, the Gaussian Blur (σ=2) is performed, followed by binarization. In addition, interface extraction is performed using image processing software. Moreover, an interface line between the positive electrode active material 100 and the protective film or the like is selected with a magic hand tool or the like, and data is extracted to spreadsheet software or the like. With the use of the function of the spreadsheet software or the like, correction is performed using regression curves (quadratic regression), parameters for calculating roughness are obtained from data subjected to slope correction, and root-mean-square (RMS) surface roughness is obtained by calculating standard deviation. This surface roughness refers to the surface roughness in at least 400 nm of the particle periphery of the positive electrode active material.

On the surface of the particle of the positive electrode active material 100 of this embodiment, root-mean-square (RMS) surface roughness, which is an index of roughness, is preferably less than 3 nm, further preferably less than 1 nm, still further preferably less than 0.5 nm.

Note that the image processing software used for the noise processing, the interface extraction, or the like is not particularly limited, and for example, “ImageJ” can be used. In addition, the spreadsheet software or the like is not particularly limited, and Microsoft Office Excel can be used, for example.

For example, the level of surface smoothness of the positive electrode active material 100 can also be quantified from the ratio of an actual specific surface area A_{R} measured by a constant-volume gas adsorption method to an ideal specific surface area Aᵢ.

The median diameter D50 can be measured with a particle size distribution analyzer or the like using a laser diffraction and scattering method. The specific surface area can be measured with a specific surface area analyzer or the like by a constant-volume gas adsorption method, for example.

The ideal specific surface area Aᵢ is calculated on the assumption that all the particles have the same diameter as D50, have the same weight, and have ideal spherical shapes.

In the positive electrode active material 100 of one embodiment of the present invention, the ratio of the actual specific surface area A_{R} to the ideal specific surface area Aᵢ (in the case of a true spherical shape) obtained from the median diameter D50 (A_{R}/Aᵢ) is preferably greater than or equal to 1 and less than or equal to 2.

When the particle diameter of the positive electrode active material 100 of one embodiment of the present invention is too large, there are problems such as difficulty in lithium diffusion and large surface roughness of an active material layer at the time when the material is applied to a current collector. By contrast, when the particle diameter is too small, there are problems such as difficulty in loading of the active material layer at the time when the material is applied to the current collector and overreaction with an electrolyte solution. Therefore, an average particle diameter (D50, also referred to as median diameter) is preferably greater than or equal to 1 μm and less than or equal to 100 μm, further preferably greater than or equal to 2 μm and less than or equal to 40 μm, still further preferably greater than or equal to 5 μm and less than or equal to 30 μm.

This embodiment can be implemented in appropriate combination with the other embodiments.

### Embodiment 3

This embodiment describes examples of shapes of several types of secondary batteries including the positive electrode active material 100 formed by the formation method described in the foregoing embodiment.

### [Coin-Type Secondary Battery]

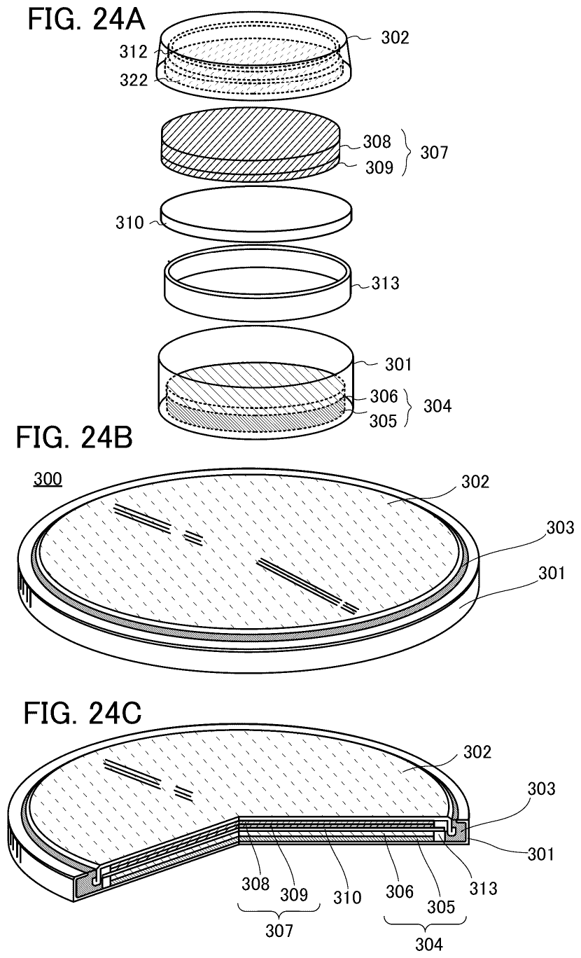

An example of a coin-type secondary battery is described. FIG. 24A is an exploded perspective view of a coin-type (single-layer flat type) secondary battery, FIG. 24B is an external view, and FIG. 24C is a cross-sectional view thereof. Coin-type secondary batteries are mainly used in small electronic devices. In this specification and the like, coin-type batteries include button-type batteries.

For easy understanding, FIG. 24A is a schematic view illustrating overlap (a vertical relation and a positional relation) between components. Thus, FIG. 24A and FIG. 24B do not completely correspond with each other.

In FIG. 24A, a positive electrode 304, a separator 310, a negative electrode 307, a spacer 322, and a washer 312 are overlaid. They are sealed with a negative electrode can 302 and a positive electrode can 301. Note that a gasket for sealing is not illustrated in FIG. 24A. The spacer 322 and the washer 312 are used to protect the inside or fix the position inside the cans at the time when the positive electrode can 301 and the negative electrode can 302 are bonded with pressure. For the spacer 322 and the washer 312, stainless steel or an insulating material is used.

The positive electrode 304 has a stacked-layer structure in which a positive electrode active material layer 306 is formed over a positive electrode current collector 305.

To prevent a short circuit between the positive electrode and the negative electrode, the separator 310 and a ring-shaped insulator 313 are placed to cover the side surface and top surface of the positive electrode 304. The separator 310 has a larger flat surface area than the positive electrode 304.

FIG. 24B is a perspective view of a completed coin-type secondary battery.

In a coin-type secondary battery 300, the positive electrode can 301 doubling as a positive electrode terminal and the negative electrode can 302 doubling as a negative electrode terminal are insulated from each other and sealed by a gasket 303 made of polypropylene or the like. The positive electrode 304 includes the positive electrode current collector 305 and the positive electrode active material layer 306 provided in contact with the positive electrode current collector 305. The negative electrode 307 includes a negative electrode current collector 308 and a negative electrode active material layer 309 provided in contact with the negative electrode current collector 308. The negative electrode 307 is not limited to having a stacked-layer structure, and lithium metal foil or lithium-aluminum alloy foil may be used.

Note that only one surface of the current collector of each of the positive electrode 304 and the negative electrode 307 used for the coin-type secondary battery 300 is provided with an active material layer.

For the positive electrode can 301 and the negative electrode can 302, a metal having corrosion resistance to an electrolyte, such as nickel, aluminum, or titanium, an alloy of such a metal, or an alloy of such a metal and another metal (e.g., stainless steel) can be used. The positive electrode can 301 and the negative electrode can 302 are preferably covered with nickel, aluminum, or the like in order to prevent corrosion due to the electrolyte, for example. The positive electrode can 301 and the negative electrode can 302 are electrically connected to the positive electrode 304 and the negative electrode 307, respectively.

The negative electrode 307, the positive electrode 304, and the separator 310 are immersed in the electrolyte solution. Then, as illustrated in FIG. 24C, the positive electrode 304, the separator 310, the negative electrode 307, and the negative electrode can 302 are stacked in this order with the positive electrode can 301 positioned at the bottom, and the positive electrode can 301 and the negative electrode can 302 are bonded with pressure with the gasket 303 therebetween. In this manner, the coin-type secondary battery 300 is fabricated.

With the above-described structure, the coin-type secondary battery 300 can have high capacity, high charge and discharge capacity, and excellent cycle performance. Note that in the case of a secondary battery including a solid electrolyte layer between the negative electrode 307 and the positive electrode 304, the separator 310 is not necessarily provided.

### [Cylindrical Secondary Battery]

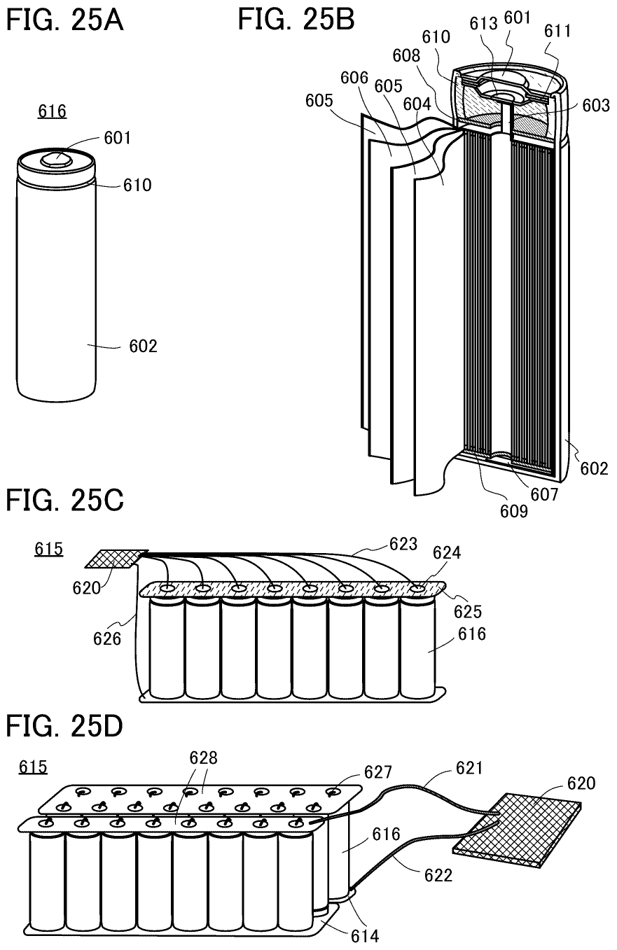

An example of a cylindrical secondary battery is described with reference to FIG. 25A. As illustrated in FIG. 25A, a cylindrical secondary battery 616 includes a positive electrode cap (battery cap) 601 on the top surface and a battery can (outer can) 602 on the side surface and bottom surface. The positive electrode cap 601 and the battery can (outer can) 602 are insulated from each other by a gasket (insulating gasket) 610.

FIG. 25B schematically illustrates a cross section of a cylindrical secondary battery. The cylindrical secondary battery illustrated in FIG. 25B includes the positive electrode cap (battery cap) 601 on the top surface and the battery can (outer can) 602 on the side surface and the bottom surface. The positive electrode cap and the battery can (outer can) 602 are insulated from each other by the gasket (insulating gasket) 610.

Inside the battery can 602 having a hollow cylindrical shape, a battery element in which a belt-like positive electrode 604 and a belt-like negative electrode 606 are wound with a belt-like separator 605 located therebetween is provided. Although not illustrated, the battery element is wound around a central axis. One end of the battery can 602 is close and the other end thereof is open. For the battery can 602, a metal having corrosion resistance to an electrolyte solution, such as nickel, aluminum, or titanium, an alloy of such a metal, or an alloy of such a metal and another metal (e.g., stainless steel) can be used. The battery can 602 is preferably covered with nickel, aluminum, or the like in order to prevent corrosion due to the electrolyte solution. Inside the battery can 602, the battery element in which the positive electrode, the negative electrode, and the separator are wound is provided between a pair of insulating plates 608 and 609 that face each other. A nonaqueous electrolyte solution (not illustrated) is injected inside the battery can 602 provided with the battery element. A nonaqueous electrolyte solution similar to that for the coin-type secondary battery can be used.

Since a positive electrode and a negative electrode that are used for a cylindrical storage battery are wound, active materials are preferably formed on both surfaces of a current collector. Note that although FIG. 25A to FIG. 25D each illustrate the secondary battery 616 in which the height of the cylinder is larger than the diameter of the cylinder, one embodiment of the present invention is not limited thereto. In a secondary battery, the diameter of the cylinder may be larger than the height of the cylinder. Such a structure can reduce the size of a secondary battery, for example.

The positive electrode active material 100 obtained in the above embodiment is used for the positive electrode 604, whereby the cylindrical secondary battery 616 can have high capacity, high charge and discharge capacity, and excellent cycle performance.

A positive electrode terminal (positive electrode current collecting lead) 603 is connected to the positive electrode 604, and a negative electrode terminal (negative electrode current collecting lead) 607 is connected to the negative electrode 606. Both the positive electrode terminal 603 and the negative electrode terminal 607 can be formed using a metal material such as aluminum. The positive electrode terminal 603 and the negative electrode terminal 607 are resistance-welded to a safety valve mechanism 613 and the bottom of the battery can 602, respectively. The safety valve mechanism 613 is electrically connected to the positive electrode cap 601 through a PTC element (Positive Temperature Coefficient) 611. The safety valve mechanism 613 cuts off electrical connection between the positive electrode cap 601 and the positive electrode 604 when the internal pressure of the battery exceeds a predetermined threshold. The PTC element 611, which is a thermally sensitive resistor whose resistance increases as temperature rises, limits the amount of current by increasing the resistance, in order to prevent abnormal heat generation. Barium titanate (BaTiO₃)-based semiconductor ceramics or the like can be used for the PTC element.

FIG. 25C shows an example of a power storage system 615. The power storage system 615 includes a plurality of secondary batteries 616. The positive electrodes of the secondary batteries are in contact with and electrically connected to conductors 624 isolated by an insulator 625. The conductor 624 is electrically connected to a control circuit 620 through a wiring 623. The negative electrodes of the secondary batteries are electrically connected to the control circuit 620 through a wiring 626. As the control circuit 620, a protection circuit for preventing overcharge or overdischarge or the like can be used, for example.

FIG. 25D illustrates an example of the power storage system 615. The power storage system 615 includes the plurality of secondary batteries 616, and the plurality of secondary batteries 616 are sandwiched between a conductive plate 628 and a conductive plate 614. The plurality of secondary batteries 616 are electrically connected to the conductive plate 628 and the conductive plate 614 through a wiring 627. The plurality of secondary batteries 616 may be connected in parallel, connected in series, or connected in series after being connected in parallel. With the power storage system 615 including the plurality of secondary batteries 616, large electric power can be extracted.

The plurality of secondary batteries 616 may be connected in series after being connected in parallel.

A temperature control device may be provided between the plurality of secondary batteries 616. The secondary batteries 616 can be cooled with the temperature control device when overheated, whereas the secondary batteries 616 can be heated with the temperature control device when cooled too much. Thus, the performance of the power storage system 615 is less likely to be influenced by the outside temperature.

In FIG. 25D, the power storage system 615 is electrically connected to the control circuit 620 through a wiring 621 and a wiring 622. The wiring 621 is electrically connected to the positive electrodes of the plurality of secondary batteries 616 through the conductive plate 628, and the wiring 622 is electrically connected to the negative electrodes of the plurality of secondary batteries 616 through the conductive plate 614.

### [Other Structure Examples of Secondary Battery]

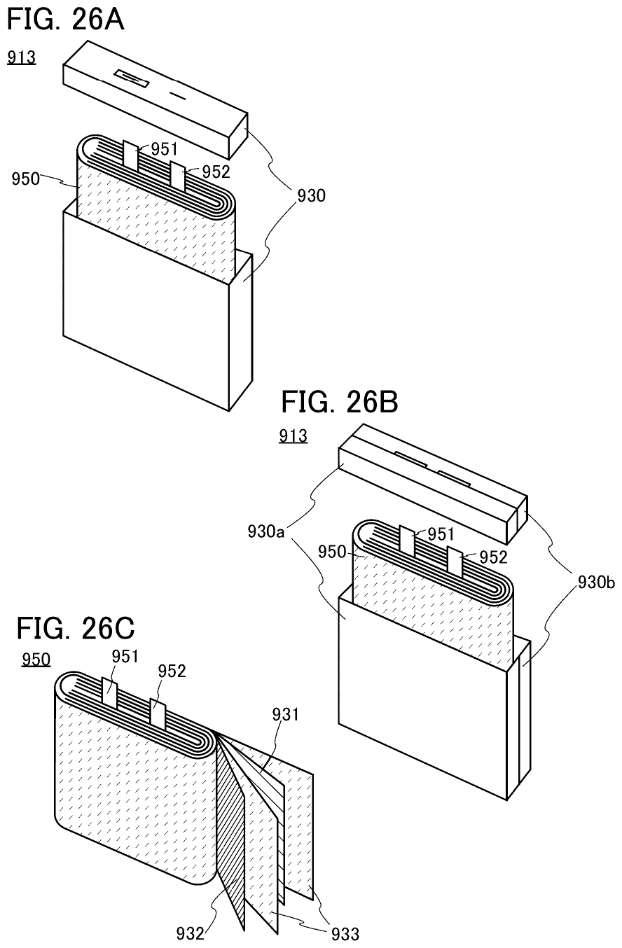

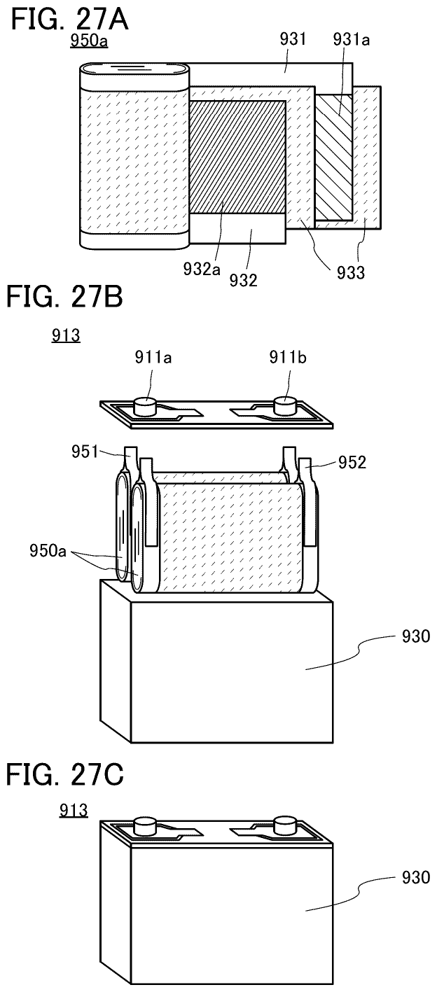

Structure examples of secondary batteries are described with reference to FIG. 26 and FIG. 27.

The secondary battery 913 illustrated in FIG. 26A includes a wound body 950 provided with the terminal 951 and the terminal 952 inside a housing 930. The wound body 950 is immersed in an electrolyte solution inside the housing 930. The terminal 952 is in contact with the housing 930. The use of an insulator or the like prevents contact between the terminal 951 and the housing 930. Note that in FIG. 26A, the housing 930 divided into pieces is illustrated for convenience; however, in the actual structure, the wound body 950 is covered with the housing 930 and the terminal 951 and the terminal 952 extend to the outside of the housing 930. For the housing 930, a metal material (e.g., aluminum) or a resin material can be used.

Note that as illustrated in FIG. 26B, the housing 930 illustrated in FIG. 26A may be formed using a plurality of materials. For example, in the secondary battery 913 illustrated in FIG. 26B, a housing 930a and a housing 930b are bonded to each other, and the wound body 950 is provided in a region surrounded by the housing 930a and the housing 930b.

For the housing 930a, an insulating material such as an organic resin can be used. In particular, when a material such as an organic resin is used for the side on which an antenna is formed, blocking of an electric field by the secondary battery 913 can be inhibited. When an electric field is not significantly blocked by the housing 930a, an antenna may be provided inside the housing 930a. For the housing 930b, a metal material can be used, for example.

FIG. 26C illustrates the structure of the wound body 950. The wound body 950 includes a negative electrode 931, a positive electrode 932, and separators 933. The wound body 950 is obtained by winding a sheet of a stack in which the negative electrode 931 and the positive electrode 932 overlap with each other with the separator 933 therebetween. Note that a plurality of stacks each including the negative electrode 931, the positive electrode 932, and the separators 933 may be further stacked.

As illustrated in FIG. 27A to FIG. 27C, the secondary battery 913 may include a wound body 950a. The wound body 950a illustrated in FIG. 27A includes the negative electrode 931, the positive electrode 932, and the separators 933. The negative electrode 931 includes a negative electrode active material layer 931a. The positive electrode 932 includes a positive electrode active material layer 932a.

The positive electrode active material 100 obtained in the above embodiment is used for the positive electrode 932, whereby the secondary battery 913 can have high capacity, high charge and discharge capacity, and excellent cycle performance.

The separator 933 has a larger width than the negative electrode active material layer 931a and the positive electrode active material layer 932a, and is wound to overlap with the negative electrode active material layer 931a and the positive electrode active material layer 932a. In terms of safety, the width of the negative electrode active material layer 931a is preferably larger than that of the positive electrode active material layer 932a. The wound body 950a having such a shape is preferable because of its high level of safety and high productivity.

As illustrated in FIG. 27B, the negative electrode 931 is electrically connected to the terminal 951. The terminal 951 is electrically connected to a terminal 911a. The positive electrode 932 is electrically connected to the terminal 952. The terminal 952 is electrically connected to a terminal 911b.

As illustrated in FIG. 27C, the wound body 950a and an electrolyte solution are covered with the housing 930, whereby the secondary battery 913 is completed. The housing 930 is preferably provided with a safety valve, an overcurrent protection element, and the like. In order to prevent the battery from exploding, a safety valve is a valve to be released when the internal pressure of the housing 930 reaches a predetermined pressure.

As illustrated in FIG. 27B, the secondary battery 913 may include a plurality of wound bodies 950a. The use of the plurality of wound bodies 950a enables the secondary battery 913 to have higher charge and discharge capacity. The description of the secondary battery 913 illustrated in FIG. 26A to FIG. 26C can be referred to for the other components of the secondary battery 913 illustrated in FIG. 27A and FIG. 27B.

### <Laminated Secondary Battery>

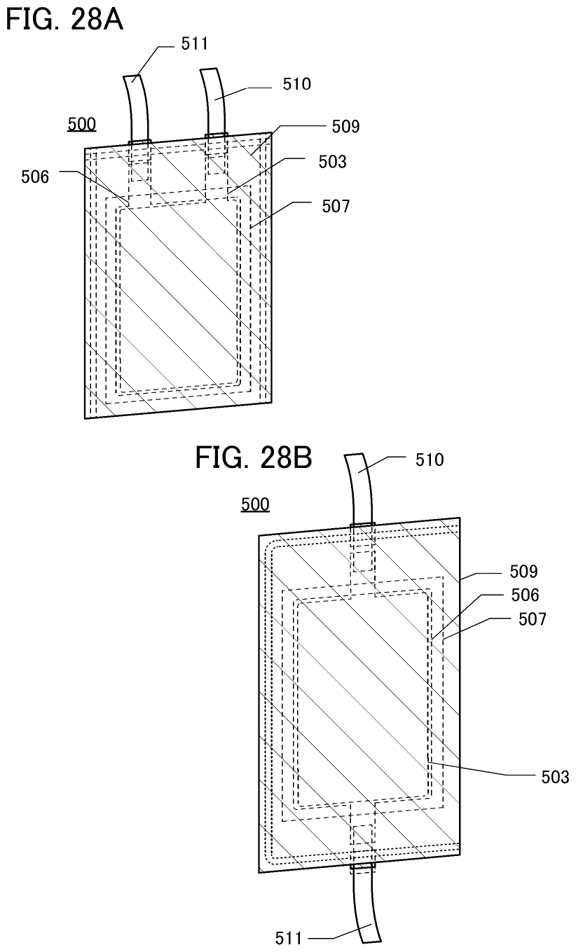

Next, examples of the appearance of a laminated secondary battery are illustrated in FIG. 28A and FIG. 28B. In FIG. 28A and FIG. 28B, a positive electrode 503, a negative electrode 506, a separator 507, an exterior body 509, a positive electrode lead electrode 510, and a negative electrode lead electrode 511 are included.

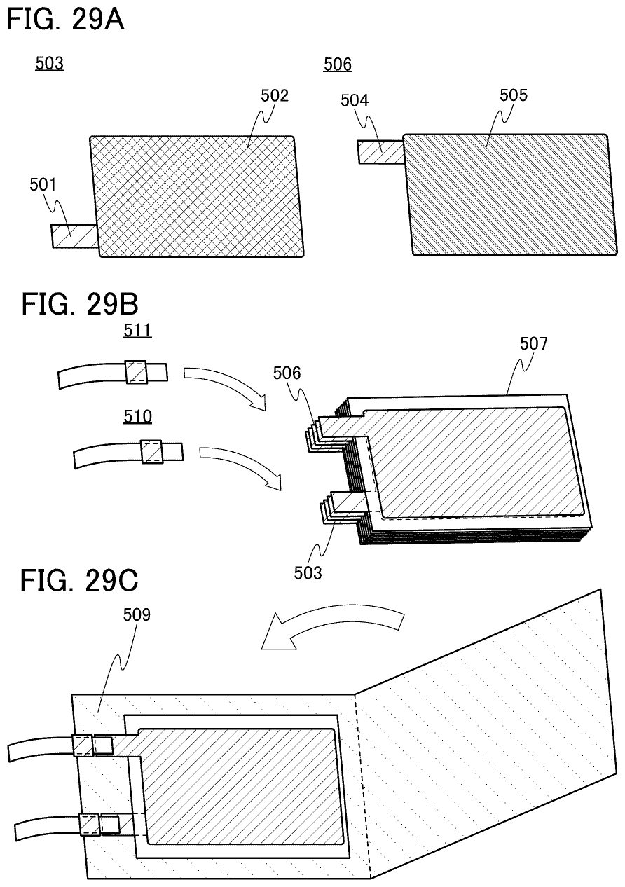

FIG. 29A illustrates external views of the positive electrode 503 and the negative electrode 506. The positive electrode 503 includes a positive electrode current collector 501, and a positive electrode active material layer 502 is formed on a surface of the positive electrode current collector 501. The positive electrode 503 also includes a region where the positive electrode current collector 501 is partly exposed (hereinafter, referred to as a tab region). The negative electrode 506 includes a negative electrode current collector 504, and a negative electrode active material layer 505 is formed on a surface of the negative electrode current collector 504. The negative electrode 506 also includes a region where the negative electrode current collector 504 is partly exposed, that is, a tab region. The areas and the shapes of the tab regions included in the positive electrode and the negative electrode are not limited to the examples illustrated in FIG. 29A.

### <Method of Fabricating Laminated Secondary Battery>

Here, an example of a method for fabricating the laminated secondary battery whose external view is illustrated in FIG. 28A is described with reference to FIG. 29B and FIG. 29C.

First, the negative electrode 506, the separator 507, and the positive electrode 503 are stacked. FIG. 29B illustrates the negative electrode 506, the separator 507, and the positive electrode 503 that are stacked. Here, an example in which five negative electrodes and four positive electrodes are used is shown. The stacked negative electrodes, separators, and positive electrodes can be referred to as a stack. Next, the tab regions of the positive electrodes 503 are bonded to each other, and the positive electrode lead electrode 510 is bonded to the tab region of the positive electrode on the outermost surface. The bonding can be performed by ultrasonic welding, for example. In a similar manner, the tab regions of the negative electrodes 506 are bonded to each other, and the negative electrode lead electrode 511 is bonded to the tab region of the negative electrode on the outermost surface.

After that, the negative electrodes 506, the separators 507, and the positive electrodes 503 are placed over the exterior body 509.

Next, the exterior body 509 is bent along a portion shown by a dashed line, as illustrated in FIG. 29C. Then, the outer edges of the exterior body 509 are bonded to each other. The bonding can be performed by thermocompression, for example. At this time, an unbonded region (hereinafter referred to as an inlet) is provided for part (or one side) of the exterior body 509 so that an electrolyte solution can be introduced later.

Next, the electrolyte solution is introduced into the exterior body 509 from the inlet of the exterior body 509. The electrolyte solution is preferably introduced in a reduced pressure atmosphere or in an inert atmosphere. Lastly, the inlet is sealed by bonding. In this manner, the laminated secondary battery 500 can be fabricated.

The positive electrode active material 100 obtained in the above embodiment is used for the positive electrode 503, whereby the secondary battery 500 can have high capacity, high charge and discharge capacity, and excellent cycle performance.

### [Examples of Battery Pack]

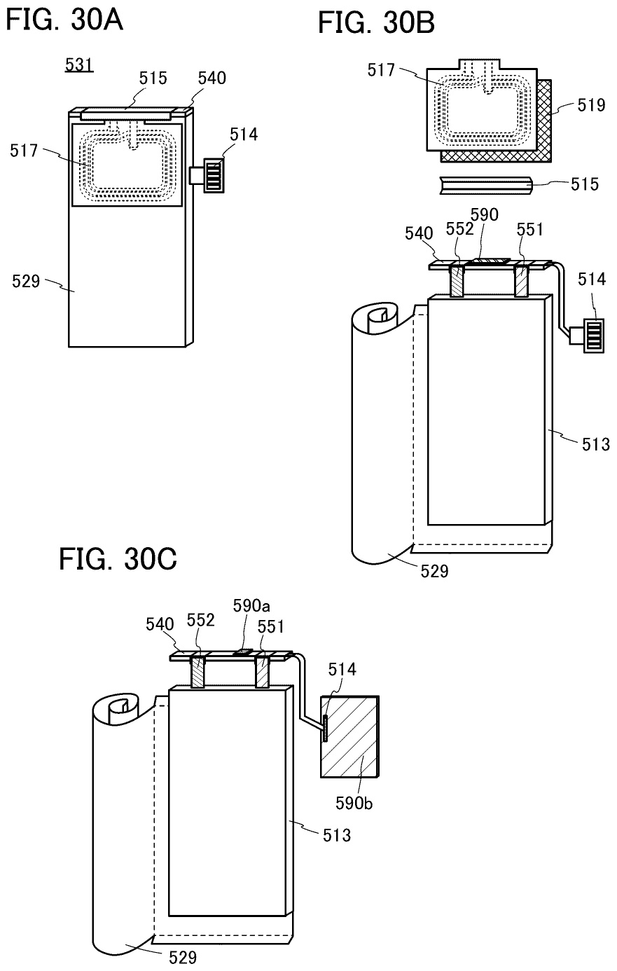

Examples of a secondary battery pack of one embodiment of the present invention that is capable of wireless charging using an antenna will be described with reference to FIG. 30A to FIG. 30C.

FIG. 30A is a diagram illustrating the appearance of a secondary battery pack 531 that has a rectangular solid shape with a small thickness (also referred to as a flat plate shape with a certain thickness). FIG. 30B is a diagram illustrating a structure of the secondary battery pack 531. The secondary battery pack 531 includes a circuit board 540 and a secondary battery 513. A label 529 is attached to the secondary battery 513. The circuit board 540 is fixed by a sealant 515. The secondary battery pack 531 also includes an antenna 517.

A wound body or a stack may be included inside the secondary battery 513.

In the secondary battery pack 531, a control circuit 590 is provided over the circuit board 540 as illustrated in FIG. 30B, for example. The circuit board 540 is electrically connected to a terminal 514. The circuit board 540 is electrically connected to the antenna 517, one 551 of a positive electrode lead and a negative electrode lead of the secondary battery 513, and the other 552 of the positive electrode lead and the negative electrode lead.

Alternatively, as illustrated in FIG. 30C, a circuit system 590a provided over the circuit board 540 and a circuit system 590b electrically connected to the circuit board 540 through the terminal 514 may be included.

Note that the shape of the antenna 517 is not limited to a coil shape and may be a linear shape or a plate shape, for example. Furthermore, a planar antenna, an aperture antenna, a traveling-wave antenna, an EH antenna, a magnetic-field antenna, a dielectric antenna, or the like may be used. Alternatively, the antenna 517 may be a flat-plate conductor. The flat-plate conductor can serve as one of conductors for electric field coupling. That is, the antenna 517 can function as one of two conductors of a capacitor. Thus, electric power can be transmitted and received not only by an electromagnetic field or a magnetic field but also by an electric field.

The secondary battery pack 531 includes a layer 519 between the antenna 517 and the secondary battery 513. The layer 519 has a function of blocking an electromagnetic field from the secondary battery 513, for example. As the layer 519, a magnetic material can be used, for example.

### [Positive Electrode]

The positive electrode includes a positive electrode active material layer and a positive electrode current collector. The positive electrode active material layer includes a positive electrode active material, and may include a conductive material and a binder. As the positive electrode active material, the positive electrode active material formed by the formation method described in the above embodiments is used.

The positive electrode active material described in the above embodiments and another positive electrode active material may be mixed to be used.

Other examples of the positive electrode active material include a composite oxide with an olivine crystal structure, a composite oxide with a layered rock-salt crystal structure, and a composite oxide with a spinel crystal structure. For example, a compound such as LiFePO₄, LiFeO₂, LiNiO₂, LiMn₂O₄, V₂O₅, Cr₂O₅, or MnO₂ can be used.

As another positive electrode active material, it is preferable to use a mixture of lithium nickel oxide (LiNiO₂ or LiNi₁₋ₓMₓO₂ (0<x<1) (M=Co, Al, or the like)) and a lithium-containing material that has a spinel crystal structure and contains manganese, such as LiMn₂O₄. This composition can improve the characteristics of the secondary battery.

Another example of the positive electrode active material is a lithium-manganese composite oxide that can be represented by a composition formula LiₐMn_{b}M_{c}O_{d}. Here, the element M is preferably silicon, phosphorus, or a metal element other than lithium and manganese, further preferably nickel. In the case where the whole particles of a lithium-manganese composite oxide are measured, it is preferable to satisfy the following at the time of discharge: 0<a/(b+c)<2; c>0; and 0.26≤(b+c)/d<0.5. Note that the proportions of metals, silicon, phosphorus, and other elements in the whole particles of a lithium-manganese composite oxide can be measured with, for example, an ICP-MS. The proportion of oxygen in the whole particles of a lithium-manganese composite oxide can be measured by, for example, EDX (energy dispersive X-ray spectroscopy). Alternatively, the proportion of oxygen can be measured by ICP-MS analysis combined with fusion gas analysis and valence evaluation of XAFS (X-ray absorption fine structure) analysis. Note that the lithium-manganese composite oxide is an oxide containing at least lithium and manganese, and may contain at least one selected from chromium, cobalt, aluminum, nickel, iron, magnesium, molybdenum, zinc, indium, gallium, copper, titanium, niobium, silicon, phosphorus, and the like.

### <Conductive Material>

A conductive material is also referred to as a conductive additive or a conductivity-imparting agent, and a carbon material is used. A conductive material is attached between a plurality of active materials, whereby the plurality of active materials are electrically connected to each other, and the conductivity increases. Note that the term “attach” refers not only to a state where an active material and a conductive material are physically in close contact with each other, and includes, for example, the following concepts: the case where covalent bonding occurs, the case where bonding with the Van der Waals force occurs, the case where a conductive material covers part of the surface of an active material, the case where a conductive material is embedded in surface roughness of an active material, and the case where an active material and a conductive material are electrically connected to each other without being in contact with each other.

Typical examples of the carbon material used as the conductive material include carbon black (e.g., furnace black, acetylene black, and graphite).

Graphene or a graphene compound is further preferably used as the conductive material.

A graphene compound in this specification and the like refers to multilayer graphene, multi graphene, graphene oxide, multilayer graphene oxide, multi graphene oxide, reduced graphene oxide, reduced multilayer graphene oxide, reduced multi graphene oxide, graphene quantum dots, and the like. A graphene compound contains carbon, has a plate-like shape, a sheet-like shape, or the like, and has a two-dimensional structure formed of a six-membered ring composed of carbon atoms. The two-dimensional structure formed of the six-membered ring composed of carbon atoms may be referred to as a carbon sheet. A graphene compound may include a functional group. The graphene compound is preferably bent. The graphene compound may be rounded like a carbon nanofiber.

In this specification and the like, graphene oxide contains carbon and oxygen, has a sheet-like shape, and includes a functional group, in particular, an epoxy group, a carboxy group, or a hydroxy group.

In this specification and the like, reduced graphene oxide contains carbon and oxygen, has a sheet-like shape, and has a two-dimensional structure formed of a six-membered ring composed of carbon atoms. The reduced graphene oxide may be referred to as a carbon sheet. The reduced graphene oxide functions by itself and may have a stacked-layer structure. Reduced graphene oxide preferably includes a portion where the carbon concentration is higher than 80 atomic % and the oxygen concentration is higher than or equal to 2 atomic % and lower than or equal to 15 atomic %. With such a carbon concentration and such an oxygen concentration, reduced graphene oxide can function as a conductive material with high conductivity even with a small amount. In addition, the intensity ratio G/D of a G band to a D band of the Raman spectrum of reduced graphene oxide is preferably 1 or more. Reduced graphene oxide with such an intensity ratio can function as a conductive material with high conductivity even with a small amount.

The graphene and graphene compound may have excellent electrical characteristics of high conductivity and excellent physical properties of high flexibility and high mechanical strength. The graphene and graphene compound have a sheet-like shape. The graphene and graphene compound have a curved surface in some cases, thereby enabling low-resistant surface contact. Furthermore, a graphene compound sometimes has extremely high conductivity even with a small thickness, and thus a small amount of a graphene compound efficiently allows a conductive path to be formed in an active material layer. Hence, the use of graphene or a graphene compound as a conductive material can increase the area where an active material and the conductive material are in contact with each other. Graphene or a graphene compound preferably covers 80% or more of the area of an active material. Note that the graphene or the graphene compound preferably clings to at least part of an active material particle. Alternatively, the graphene or the graphene compound preferably overlays at least part of the active material particle. Alternatively, the shape of the graphene or the graphene compound preferably conforms to at least part of the shape of the active material particle. The shape of an active material particle means, for example, unevenness of a single active material particle or unevenness formed by a plurality of active material particles. The graphene or the graphene compound preferably surrounds at least part of the active material particle. The graphene or the graphene compound may have a hole.

In the case where active material particles with a small diameter (e.g., 1 μm or less) are used, the specific surface area of the active material particles is large and thus more conductive paths for the active material particles are needed. In such a case, it is preferable to use graphene or a graphene compound that can efficiently form a conductive path even with a small amount be used.

It is particularly effective to use a graphene compound, which has the above-described properties, as a conductive material of a secondary battery that needs to be rapidly charged and discharged. For example, a secondary battery for a two- or four-wheeled vehicle, a secondary battery for a drone, or the like is required to have fast charge and fast discharge characteristics in some cases. In addition, a mobile electronic device or the like is required to have fast charge characteristics in some cases. Fast charge and discharge may also be referred to as charge and discharge at a high rate, for example, at 1 C, 2 C, or 5 C or more.

A material used in formation of graphene or the graphene compound may be mixed with graphene or the graphene compound to be used for the active material layer. For example, particles used as a catalyst in formation of the graphene compound may be mixed with the graphene compound. As an example of the catalyst in formation of the graphene compound, particles containing any of silicon oxide (SiO₂ or SiOₓ (x<2)), aluminum oxide, iron, nickel, ruthenium, iridium, platinum, copper, germanium, and the like can be given. The median diameter (D50) of the particles is preferably less than or equal to 1 μm, further preferably less than or equal to 100 nm.

### <Binder>

As the binder, a rubber material such as styrene-butadiene rubber (SBR), styrene-isoprene-styrene rubber, acrylonitrile-butadiene rubber, butadiene rubber, or ethylene-propylene-diene copolymer is preferably used, for example. Alternatively, fluororubber can be used as the binder.

As the binder, for example, water-soluble polymers are preferably used. As the water-soluble polymers, a polysaccharide can be used, for example. As the polysaccharide, starch, a cellulose derivative such as carboxymethyl cellulose (CMC), methyl cellulose, ethyl cellulose, hydroxypropyl cellulose, diacetyl cellulose, or regenerated cellulose, or the like can be used. It is further preferable that such water-soluble polymers be used in combination with any of the above rubber materials.

Alternatively, as the binder, a material such as polystyrene, poly(methyl acrylate), poly(methyl methacrylate) (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, polyvinylidene fluoride (PVDF), polyacrylonitrile (PAN), ethylene-propylene-diene polymer, polyvinyl acetate, or nitrocellulose is preferably used.

Two or more of the above materials may be used in combination for the binder.

For example, a material having a significant viscosity modifying effect and another material may be used in combination. For example, a rubber material or the like has high adhesion and high elasticity but may have difficulty in viscosity modification when mixed in a solvent. In such a case, a rubber material or the like is preferably mixed with a material having a significant viscosity modifying effect, for example. As a material having a significant viscosity modifying effect, for instance, a water-soluble polymer is preferably used. As a water-soluble polymer having a significant viscosity modifying effect, the above-mentioned polysaccharide, for instance, a cellulose derivative such as carboxymethyl cellulose (CMC), methyl cellulose, ethyl cellulose, hydroxypropyl cellulose, diacetyl cellulose, or regenerated cellulose or starch can be used.

Note that a cellulose derivative such as carboxymethyl cellulose obtains a higher solubility when converted into a salt such as a sodium salt or an ammonium salt of carboxymethyl cellulose, and thus easily exerts an effect as a viscosity modifier. A high solubility can also increase the dispersibility of an active material and other components in the formation of a slurry for an electrode. In this specification and the like, cellulose and a cellulose derivative used as a binder of an electrode include salts thereof.

A water-soluble polymer stabilizes the viscosity by being dissolved in water and allows stable dispersion of the active material and another material combined as a binder, such as styrene-butadiene rubber, in an aqueous solution. Furthermore, a water-soluble polymer is expected to be easily and stably adsorbed onto an active material surface because it has a functional group. Many cellulose derivatives, such as carboxymethyl cellulose, have a functional group such as a hydroxyl group or a carboxyl group. Because of functional groups, polymers are expected to interact with each other and cover an active material surface in a large area.

In the case where the binder that covers or is in contact with the active material surface forms a film, the film is expected to serve also as a passivation film to suppress the decomposition of the electrolyte solution. Here, a passivation film refers to a film without electric conductivity or a film with extremely low electric conductivity, and can inhibit the decomposition of an electrolyte solution at a potential at which a battery reaction occurs when the passivation film is formed on the active material surface, for example. It is further desirable that the passivation film can conduct lithium ions while inhibiting electrical conduction.

### [Positive Electrode Current Collector]

The positive electrode current collector can be formed using a material that has high conductivity, such as a metal like stainless steel, gold, platinum, aluminum, or titanium, or an alloy thereof. It is preferred that a material used for the positive electrode current collector not be dissolved at the potential of the positive electrode. It is also possible to use an aluminum alloy to which an element that improves heat resistance, such as silicon, titanium, neodymium, scandium, or molybdenum, is added. A metal element that forms silicide by reacting with silicon may be used. Examples of the metal element that forms silicide by reacting with silicon include zirconium, titanium, hafnium, vanadium, niobium, tantalum, chromium, molybdenum, tungsten, cobalt, and nickel. The current collector can have a foil-like shape, a plate-like shape, a sheet-like shape, a net-like shape, a punching-metal shape, an expanded-metal shape, or the like as appropriate. The current collector preferably has a thickness greater than or equal to 5 μm and less than or equal to 30 lam.

### [Negative Electrode]

The negative electrode includes a negative electrode active material layer and a negative electrode current collector. The negative electrode active material layer may contain a conductive material and a binder.

For the negative electrode active material, an element that enables charge and discharge reactions by an alloying reaction and a dealloying reaction with lithium can be used. For example, a material containing at least one of silicon, tin, gallium, aluminum, germanium, lead, antimony, bismuth, silver, zinc, cadmium, indium, and the like can be used. Such elements have higher capacity than carbon. In particular, silicon has a high theoretical capacity of 4200 mAh/g. For this reason, silicon is preferably used as the negative electrode active material. Alternatively, a compound containing any of the above elements may be used. Examples of the compound include SiO, Mg₂Si, Mg₂Ge, SnO, SnO₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn. Here, an element that enables charge and discharge reactions by an alloying reaction and a dealloying reaction with lithium, a compound containing the element, and the like may be referred to as an alloy-based material.

In this specification and the like, SiO refers, for example, to silicon monoxide. Note that SiO can alternatively be expressed as SiOₓ. Here, it is preferred that x be 1 or have an approximate value of 1. For example, x is preferably greater than or equal to 0.2 and less than or equal to 1.5, or preferably greater than or equal to 0.3 and less than or equal to 1.2.

As the carbon-based material, graphite, graphitizing carbon (soft carbon), non-graphitizing carbon (hard carbon), carbon nanotube, graphene, carbon black, or the like is used.

Examples of graphite include artificial graphite and natural graphite. Examples of artificial graphite include mesocarbon microbeads (MCMB), coke-based artificial graphite, and pitch-based artificial graphite. As artificial graphite, spherical graphite having a spherical shape can be used. For example, MCMB is preferably used because it may have a spherical shape. Moreover, MCMB may preferably be used because it can relatively easily have a small surface area. Examples of natural graphite include flake graphite and spherical natural graphite.

Graphite has a low potential substantially equal to that of a lithium metal (greater than or equal to 0.05 V and less than or equal to 0.3 V vs. Li/Li⁺) when lithium ions are inserted into graphite (while a lithium-graphite intercalation compound is formed). For this reason, a lithium-ion secondary battery using graphite can have a high operating voltage. In addition, graphite is preferred because of its advantages such as a relatively high capacity per unit volume, relatively small volume expansion, low cost, and a higher level of safety than that of a lithium metal.

As the negative electrode active material, an oxide such as titanium dioxide (TiO₂), lithium titanium oxide (Li₄Ti₅O₁₂), a lithium-graphite intercalation compound (LiₓC₆), niobium pentoxide (Nb₂O₅), tungsten oxide (WO₂), or molybdenum oxide (MoO₂) can be used.

Alternatively, as the negative electrode active material, Li₃₋ₓMₓN (M is Co, Ni, or Cu) with a Li₃N structure, which is a composite nitride of lithium and a transition metal, can be used. For example, Li_{2.6}Co_{0.4}N₃ is preferable because of high charge and discharge capacity (900 mAh/g and 1890 mAh/cm 3).

A composite nitride of lithium and a transition metal is preferably used, in which case lithium ions are contained in the negative electrode active material and thus the negative electrode active material can be used in combination with a material for a positive electrode active material that does not contain lithium ions, such as V₂O₅ or Cr₃O₈. Note that even in the case of using a material containing lithium ions as a positive electrode active material, the composite nitride of lithium and a transition metal can be used as the negative electrode active material by extracting the lithium ions contained in the positive electrode active material in advance.

Alternatively, a material that causes a conversion reaction can be used as the negative electrode active material. For example, a transition metal oxide that does not form an alloy with lithium, such as cobalt oxide (CoO), nickel oxide (NiO), or iron oxide (FeO), may be used as the negative electrode active material. Other examples of the material which causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃.

For the conductive material and the binder that can be included in the negative electrode active material layer, materials similar to those for the conductive material and the binder that can be included in the positive electrode active material layer can be used. For the negative electrode current collector, copper or the like can be used in addition to a material similar to that for the positive electrode current collector. Note that a material that is not alloyed with carrier ions of lithium or the like is preferably used for the negative electrode current collector.

### [Electrolyte Solution]

As one mode of the electrolyte, an electrolyte solution containing a solvent and an electrolyte dissolved in the solvent can be used. As the solvent of the electrolyte solution, an aprotic organic solvent is preferably used. For example, one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more of these solvents can be used in an appropriate combination in an appropriate ratio.

Alternatively, the use of one or more ionic liquids (room temperature molten salts) which have features of non-flammability and non-volatility as the solvent of the electrolyte solution can prevent a power storage device from exploding, catching fire, and the like even when the power storage device internally shorts out or the internal temperature increases owing to overcharge or the like. An ionic liquid contains a cation and an anion, specifically, an organic cation and an anion. Examples of the organic cation used for the electrolyte solution include aliphatic onium cations such as a quaternary ammonium cation, a tertiary sulfonium cation, and a quaternary phosphonium cation, and aromatic cations such as an imidazolium cation and a pyridinium cation. Examples of the anion used for the electrolyte solution include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

As the electrolyte dissolved in the above-described solvent, one of lithium salts such as LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂) (CF₃SO₂), LiN(C₂F₅SO₂)₂, and lithium bis(oxalate)borate (Li(C₂O₄)₂, LiBOB) can be used, or two or more of these lithium salts can be used in an appropriate combination at an appropriate ratio.

The electrolyte solution used for a power storage device is preferably highly purified and contains a small number of dust particles or elements other than the constituent elements of the electrolyte solution (hereinafter, also simply referred to as impurities). Specifically, the weight ratio of impurities to the electrolyte solution is preferably less than or equal to 1%, further preferably less than or equal to 0.1%, still further preferably less than or equal to 0.01%.

Furthermore, an additive agent such as vinylene carbonate, propane sultone (PS), tert-butylbenzene (TBB), fluoroethylene carbonate (FEC), lithium bis(oxalate)borate (LiBOB), or a dinitrile compound such as succinonitrile or adiponitrile may be added to the electrolyte solution. The concentration of such an additive agent in the solvent in which the electrolyte is dissolved is, for example, higher than or equal to 0.1 wt % and lower than or equal to 5 wt %.

Alternatively, a polymer gel electrolyte obtained in such a manner that a polymer is swelled with an electrolyte solution may be used.

When a polymer gel electrolyte is used, safety against liquid leakage and the like is improved. Moreover, a secondary battery can be thinner and more lightweight.

As a polymer that undergoes gelation, a silicone gel, an acrylic gel, an acrylonitrile gel, a polyethylene oxide-based gel, a polypropylene oxide-based gel, a fluorine-based polymer gel, or the like can be used. Examples of the polymer include a polymer having a polyalkylene oxide structure, such as polyethylene oxide (PEO); PVDF; polyacrylonitrile; and a copolymer containing any of them. For example, PVDF-HFP, which is a copolymer of PVDF and hexafluoropropylene (HFP), can be used. The formed polymer may be porous.

### [Separator]

The separator can be formed using, for example, a fiber containing cellulose, such as paper, nonwoven fabric, glass fiber, ceramics, or synthetic fiber containing nylon (polyamide), vinylon (polyvinyl alcohol-based fiber), polyester, acrylic, polyolefin, or polyurethane.

The separator may have a multilayer structure. For example, an organic material film of polypropylene, polyethylene, or the like can be coated with a ceramic-based material, a fluorine-based material, a polyamide-based material, a mixture thereof, or the like. Examples of the ceramic-based material include aluminum oxide particles and silicon oxide particles. Although a material in a glass state can be used as a ceramic material, the material preferably has a low electron conductivity, unlike the glass used for an electrode. Examples of the fluorine-based material include PVDF and polytetrafluoroethylene. Examples of the polyamide-based material include nylon and aramid (meta-based aramid and para-based aramid).

When the separator is coated with the ceramic-based material, the oxidation resistance is improved; hence, deterioration of the separator in charge at high voltage can be inhibited and thus the reliability of the secondary battery can be improved. When the separator is coated with the fluorine-based material, the separator is easily brought into close contact with an electrode, resulting in high output characteristics. When the separator is coated with the polyamide-based material, in particular, aramid, the safety of the secondary battery is improved because heat resistance is improved.

For example, both surfaces of a polypropylene film may be coated with a mixed material of aluminum oxide and aramid. Alternatively, a surface of a polypropylene film that is in contact with the positive electrode may be coated with a mixed material of aluminum oxide and aramid, and a surface of the polypropylene film that is in contact with the negative electrode may be coated with the fluorine-based material.

The contents in this embodiment can be freely combined with the contents in the other embodiments.

### Embodiment 4

In this embodiment, an example in which an all-solid-state battery is fabricated using the positive electrode active material 100 obtained in the above embodiment will be described.

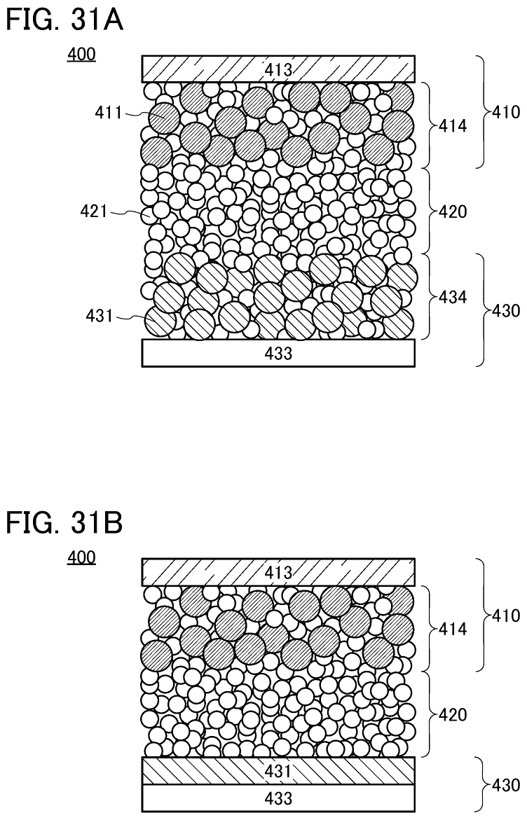

As illustrated in FIG. 31A, a secondary battery 400 of one embodiment of the present invention includes a positive electrode 410, a solid electrolyte layer 420, and a negative electrode 430.

The positive electrode 410 includes a positive electrode current collector 413 and a positive electrode active material layer 414. The positive electrode active material layer 414 includes a positive electrode active material 411 and a solid electrolyte 421. The positive electrode active material 100 obtained in the above embodiment is used as the positive electrode active material 411. The positive electrode active material layer 414 may include a conductive material and a binder.

The solid electrolyte layer 420 includes the solid electrolyte 421. The solid electrolyte layer 420 is positioned between the positive electrode 410 and the negative electrode 430 and is a region that includes neither the positive electrode active material 411 nor a negative electrode active material 431.

The negative electrode 430 includes a negative electrode current collector 433 and a negative electrode active material layer 434. The negative electrode active material layer 434 includes the negative electrode active material 431 and the solid electrolyte 421. The negative electrode active material layer 434 may include a conductive material and a binder. Note that when metal lithium is used as the negative electrode active material 431, metal lithium does not need to be processed into particles; thus, the negative electrode 430 that does not include the solid electrolyte 421 can be formed, as illustrated in FIG. 31B. The use of metal lithium for the negative electrode 430 is preferable because the energy density of the secondary battery 400 can be increased.

As the solid electrolyte 421 included in the solid electrolyte layer 420, a sulfide-based solid electrolyte, an oxide-based solid electrolyte, or a halide-based solid electrolyte can be used, for example.

The sulfide-based solid electrolyte includes a thio-LISICON-based material (e.g., Li₁₀GeP₂S₁₂ or Li_{3.25}Ge_{0.25}P_{0.75}S₄), sulfide glass (e.g., 70Li₂S·30P₂S₅, 30Li₂S·26B₂S₃·44LiI, 63Li₂S·36SiS₂·1Li₃PO₄, 57Li₂S·38SiS₂·5Li₄SiO₄, or 50Li₂S·50GeS₂), or sulfide-based crystallized glass (e.g., Li₇P₃S₁₁ or Li_{3.25}P_{0.95}S₄). The sulfide-based solid electrolyte has advantages such as high conductivity of some materials, low-temperature synthesis, and ease of maintaining a path for electrical conduction after charge and discharge because of its relative softness.

The oxide-based solid electrolyte includes a material with a perovskite crystal structure (e.g., La_{2/3-x}Li₃ₓTiO₃), a material with a NASICON crystal structure (e.g., Li_{1-Y}Al_{Y}Ti_{2-Y}(PO₄)₃), a material with a garnet crystal structure (e.g., Li₇La₃Zr₂O₁₂), a material with a LISICON crystal structure (e.g., Li₁₄ZnGe₄O₁₆), LLZO (Li₇La₃Zr₂O₁₂), oxide glass (e.g., Li₃PO₄—Li₄SiO₄ or 50Li₄SiO₄·50Li₃BO₃), or oxide-based crystallized glass (e.g., Li_{1.07}Al_{0.69}Ti_{1.46}(PO₄)₃ or Li_{1.5}Al_{0.5}Ge_{1.5}(PO₄)₃). The oxide-based solid electrolyte has an advantage of stability in the air.

Examples of the halide-based solid electrolyte include LiAlCl₄, Li₃InBr₆, LiF, LiCl, LiBr, and LiI. Moreover, a composite material in which pores of porous aluminum oxide or porous silica are filled with such a halide-based solid electrolyte can be used as the solid electrolyte.

Alternatively, different solid electrolytes may be mixed and used.

In particular, Li₁₊ₓAlₓTi₂₋ₓ(PO₄)₃ (0<x<1) having a NASICON crystal structure (hereinafter, LATP) is preferable because it contains aluminum and titanium, each of which is the element the positive electrode active material used in the secondary battery 400 of one embodiment of the present invention is allowed to contain, and thus synergy of improving the cycle performance is expected. Moreover, higher productivity due to the reduction in the number of steps is expected. Note that in this specification and the like, a NASICON crystal structure refers to a compound that is represented by M₂(XO₄)₃ (M: transition metal; X: S, P, As, Mo, W, or the like) and has a structure in which MO₆ octahedrons and XO₄ tetrahedrons that share common corners are arranged three-dimensionally.

### [Exterior Body and Shape of Secondary Battery]

An exterior body of the secondary battery 400 of one embodiment of the present invention can be formed using a variety of materials and have a variety of shapes, and preferably has a function of applying pressure to the positive electrode, the solid electrolyte layer, and the negative electrode.

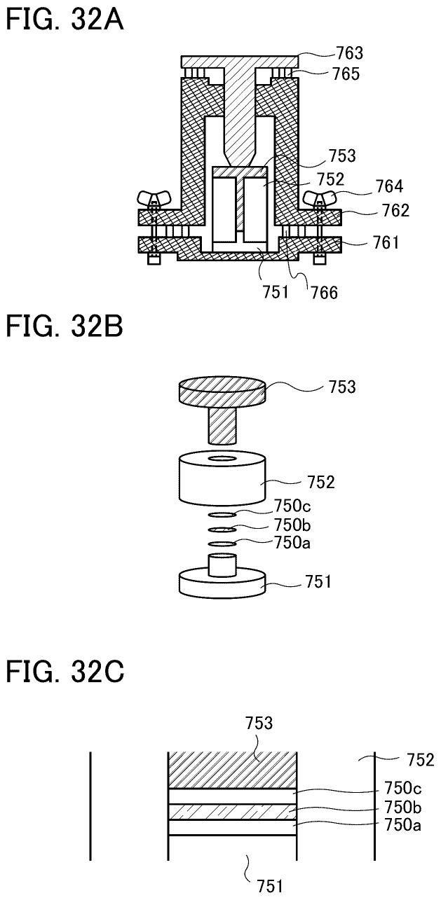

FIG. 32 illustrates an example of a cell for evaluating materials of an all-solid-state battery, for example.

FIG. 32A is a cross-sectional schematic view of the evaluation cell, and the evaluation cell includes a lower component 761, an upper component 762, and a fixation screw or a butterfly nut 764 for fixing these components; by rotating a pressure screw 763, an electrode plate 753 is pressed to fix an evaluation material. An insulator 766 is provided between the lower component 761 and the upper component 762 that are made of a stainless steel material. An O ring 765 for hermetic sealing is provided between the upper component 762 and the pressure screw 763.

The evaluation material is placed on an electrode plate 751, surrounded by an insulating tube 752, and pressed from above by the electrode plate 753. FIG. 32B is an enlarged perspective view of the evaluation material and its vicinity.

A stack of a positive electrode 750a, a solid electrolyte layer 750b, and a negative electrode 750c is illustrated here as an example of the evaluation material, and its cross-sectional view is illustrated in FIG. 32C. Note that the same portions in FIG. 32A to FIG. 32C are denoted by the same reference numerals.

The electrode plate 751 and the lower component 761 that are electrically connected to the positive electrode 750a correspond to a positive electrode terminal. The electrode plate 753 and the upper component 762 that are electrically connected to the negative electrode 750c correspond to a negative electrode terminal. The electric resistance or the like can be measured while pressure is applied to the evaluation material through the electrode plate 751 and the electrode plate 753.

A package having excellent airtightness is preferably used as the exterior body of the secondary battery of one embodiment of the present invention. For example, a ceramic package or a resin package can be used. The exterior body is sealed preferably in a closed atmosphere where the outside air is blocked, for example, in a glove box.

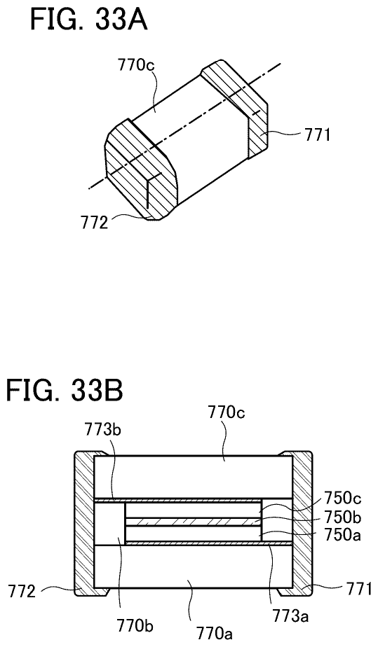

FIG. 33A illustrates a perspective view of a secondary battery of one embodiment of the present invention that has an exterior body and a shape different from those in FIG. 32. The secondary battery in FIG. 33A includes external electrodes 771 and 772 and is sealed with an exterior body including a plurality of package components.

FIG. 33B illustrates an example of a cross section along the dashed-dotted line in FIG. 33A. A stack including the positive electrode 750a, the solid electrolyte layer 750b, and the negative electrode 750c has a structure of being surrounded and sealed by a package component 770a including an electrode layer 773a on a flat plate, a frame-like package component 770b, and a package component 770c including an electrode layer 773b on a flat plate. For the package components 770a, 770b, and 770c, an insulating material, e.g., a resin material and ceramic, can be used.

The external electrode 771 is electrically connected to the positive electrode 750a through the electrode layer 773a and functions as a positive electrode terminal. The external electrode 772 is electrically connected to the negative electrode 750c through the electrode layer 773b and functions as a negative electrode terminal.

The use of the positive electrode active material 100 obtained in the above embodiment can achieve an all-solid-state secondary battery having a high energy density and favorable output characteristics.

The contents in this embodiment can be combined with the contents in the other embodiments as appropriate.

### Embodiment 5

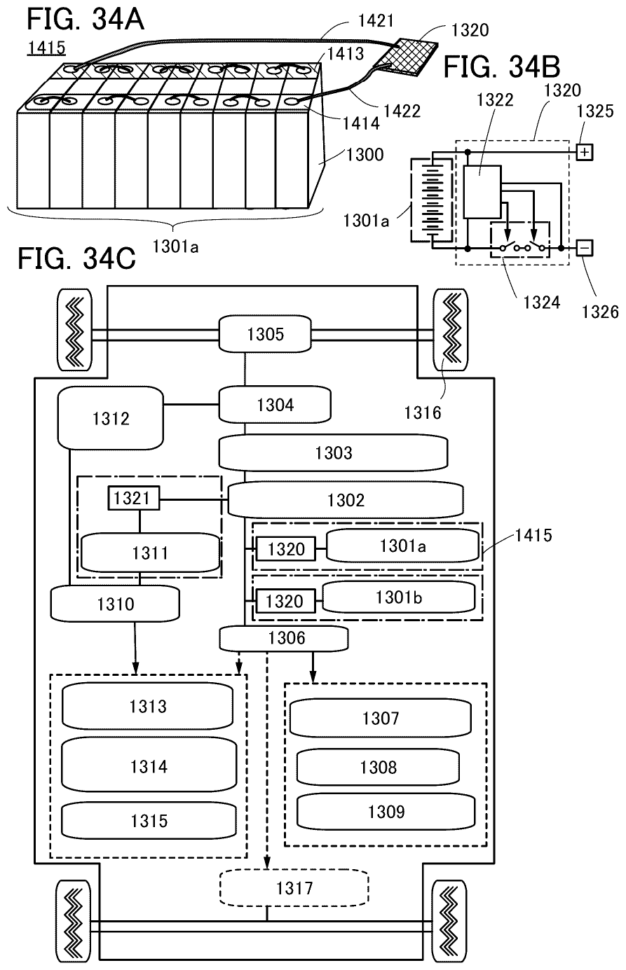

In this embodiment, an example in which a secondary battery different from the cylindrical secondary battery in FIG. 25D is used in an electric vehicle (EV) is described with reference to FIG. 34C.

The electric vehicle is provided with first batteries 1301a and 1301b as main secondary batteries for driving and a second battery 1311 that supplies electric power to an inverter 1312 for starting a motor 1304. The second battery 1311 is also referred to as a cranking battery (also referred to as a starter battery). The second battery 1311 only needs high output and high capacity is not so much needed; the capacity of the second battery 1311 is lower than that of the first batteries 1301a and 1301b.

The internal structure of the first battery 1301a may be the wound structure illustrated in FIG. 26A or FIG. 27C or the stacked-layer structure illustrated in FIG. 28A or FIG. 28B. Alternatively, the first battery 1301a may be an all-solid-state battery in Embodiment 4. The use of the all-solid-state battery in Embodiment 4 as the first battery 1301a can achieve high capacity, improvement in safety, and reduction in size and weight.

Although this embodiment describes an example in which the two first batteries 1301a and 1301b are connected in parallel, three or more batteries may be connected in parallel. In the case where the first battery 1301a can store sufficient electric power, the first battery 1301b may be omitted. By constituting a battery pack including a plurality of secondary batteries, large electric power can be extracted. The plurality of secondary batteries may be connected in parallel, connected in series, or connected in series after being connected in parallel. The plurality of secondary batteries are also referred to as an assembled battery.

In order to cut off electric power from the plurality of secondary batteries, the secondary batteries in the vehicle include a service plug or a circuit breaker that can cut off high voltage without the use of equipment. The first battery 1301a is provided with such a service plug or a circuit breaker.

Electric power from the first batteries 1301a and 1301b is mainly used to rotate the motor 1304 and is supplied to in-vehicle parts for 42 V (such as an electric power steering 1307, a heater 1308, and a defogger 1309) through a DCDC circuit 1306. Even in the case where there is a rear motor 1317 for rear wheels, the first battery 1301a is used to rotate the rear motor 1317.

The second battery 1311 supplies electric power to in-vehicle parts for 14 V (such as a stereo 1313, a power window 1314, and lamps 1315) through a DCDC circuit 1310.

The first battery 1301a will be described with reference to FIG. 34A.

FIG. 34A illustrates an example in which nine rectangular secondary batteries 1300 form one battery pack 1415. The nine rectangular secondary batteries 1300 are connected in series; one electrode of each battery is fixed by a fixing portion 1413 made of an insulator, and the other electrode thereof is fixed by a fixing portion 1414 made of an insulator. Although this embodiment describes an example in which the secondary batteries are fixed by the fixing portions 1413 and 1414, they may be stored in a battery container box (also referred to as a housing). Since a vibration or a jolt is assumed to be given to the vehicle from the outside (e.g., a road surface), the plurality of secondary batteries are preferably fixed by the fixing portions 1413 and 1414 and a battery container box, for example. Furthermore, the one electrode is electrically connected to a control circuit portion 1320 through a wiring 1421. The other electrode is electrically connected to the control circuit portion 1320 through a wiring 1422.

The control circuit portion 1320 may include a memory circuit including a transistor using an oxide semiconductor. A charge control circuit or a battery control system that includes a memory circuit including a transistor using an oxide semiconductor is referred to as a BTOS (Battery operating system or Battery oxide semiconductor) in some cases.

A metal oxide functioning as an oxide semiconductor is preferably used. For example, as the oxide, a metal oxide such as an In-M-Zn oxide (the element M is one or more kinds selected from aluminum, gallium, yttrium, copper, vanadium, beryllium, boron, titanium, iron, nickel, germanium, zirconium, molybdenum, lanthanum, cerium, neodymium, hafnium, tantalum, tungsten, magnesium, and the like) or the like is preferably used. In particular, the In-M-Zn oxide that can be used as the oxide is preferably a CAAC-OS (C-Axis Aligned Crystal Oxide Semiconductor) or a CAC-OS (Cloud-Aligned Composite Oxide Semiconductor). Alternatively, an In—Ga oxide or an In—Zn oxide may be used as the oxide. The CAAC-OS is an oxide semiconductor that has a plurality of crystal regions each of which has c-axis alignment in a particular direction. Note that the particular direction refers to the film thickness direction of a CAAC-OS film, the normal direction of the surface where the CAAC-OS film is formed, or the normal direction of the surface of the CAAC-OS film. The crystal region refers to a region having a periodic atomic arrangement. Note that when an atomic arrangement is regarded as a lattice arrangement, the crystal region also refers to a region with a uniform lattice arrangement. The CAAC-OS has a region where a plurality of crystal regions are connected in the a-b plane direction, and the region has distortion in some cases. Note that distortion refers to a portion where the orientation of a lattice arrangement changes between a region with a uniform lattice arrangement and another region with a uniform lattice arrangement in a region where a plurality of crystal regions are connected. That is, the CAAC-OS is an oxide semiconductor having c-axis alignment and having no clear alignment in the a-b plane direction. The CAC-OS refers to one composition of a material in which elements constituting a metal oxide are unevenly distributed with a size greater than or equal to 0.5 nm and less than or equal to 10 nm, preferably greater than or equal to 1 nm and less than or equal to 3 nm, or a similar size, for example. Note that a state in which one or more metal elements are unevenly distributed and regions including the metal element(s) are mixed with a size greater than or equal to 0.5 nm and less than or equal to 10 nm, preferably greater than or equal to 1 nm and less than or equal to 3 nm, or a similar size in a metal oxide is hereinafter referred to as a mosaic pattern or a patch-like pattern.

In addition, the CAC-OS has a composition in which materials are separated into a first region and a second region to form a mosaic pattern, and the first regions are distributed in the film (this composition is hereinafter also referred to as a cloud-like composition). That is, the CAC-OS is a composite metal oxide having a composition in which the first regions and the second regions are mixed.

Here, the atomic ratios of In, Ga, and Zn to the metal elements contained in the CAC-OS in an In—Ga—Zn oxide are denoted by [In], [Ga], and [Zn], respectively. For example, the first region in the CAC-OS in the In—Ga—Zn oxide is a region having [In] higher than [In] in the composition of the CAC-OS film. Moreover, the second region is a region having [Ga] higher than [Ga] in the composition of the CAC-OS film. Alternatively, for example, the first region is a region having [In] higher than [In] in the second region and [Ga] lower than [Ga] in the second region. Moreover, the second region is a region having [Ga] higher than [Ga] in the first region and [In] lower than [In] in the first region.

Specifically, the first region is a region containing an indium oxide, an indium zinc oxide, or the like as its main component. The second region is a region containing a gallium oxide, a gallium zinc oxide, or the like as its main component. That is, the first region can be rephrased as a region containing In as its main component. The second region can be rephrased as a region containing Ga as its main component.

Note that a clear boundary between the first region and the second region cannot be observed in some cases.

For example, energy dispersive X-ray spectroscopy (EDX) is used to obtain EDX mapping, and according to the EDX mapping, the CAC-OS in the In—Ga—Zn oxide can be found to have a structure in which the region containing In as its main component (the first region) and the region containing Ga as its main component (the second region) are unevenly distributed and mixed.

In the case where the CAC-OS is used for a transistor, a switching function (On/Off switching function) can be given to the CAC-OS owing to the complementary action of the conductivity derived from the first region and the insulating property derived from the second region. That is, the CAC-OS has a conducting function in part of the material and has an insulating function in another part of the material; as a whole, the CAC-OS has a function of a semiconductor. Separation of the conducting function and the insulating function can maximize each function. Accordingly, when the CAC-OS is used for a transistor, high on-state current (Ion), high field-effect mobility (μ), and excellent switching operation can be achieved.

An oxide semiconductor has various structures with different properties. Two or more kinds among an amorphous oxide semiconductor, a polycrystalline oxide semiconductor, an a-like OS, a CAC-OS, an nc-OS, and a CAAC-OS may be included in an oxide semiconductor of one embodiment of the present invention.

The control circuit portion 1320 preferably includes a transistor using an oxide semiconductor because it can be used in a high-temperature environment. For the process simplicity, the control circuit portion 1320 may be formed using transistors of the same conductivity type. A transistor using an oxide semiconductor in its semiconductor layer has an operating ambient temperature range of −40° C. to 150° C. inclusive, which is wider than that of a single crystal Si transistor, and thus shows a smaller change in characteristics than the single crystal Si transistor when the secondary battery is heated. The off-state current of the transistor using an oxide semiconductor is lower than or equal to the lower measurement limit even at 150° C. independently of the temperature; meanwhile, the off-state current characteristics of the single crystal Si transistor largely depend on the temperature. For example, at 150° C., the off-state current of the single crystal Si transistor increases, and a sufficiently high current on/off ratio cannot be obtained. The control circuit portion 1320 can improve the safety. When the control circuit portion 1320 is used in combination with a secondary battery including a positive electrode using the positive electrode active material 100 obtained in the above embodiment, the synergy on safety can be obtained.

The control circuit portion 1320 that includes a memory circuit including a transistor using an oxide semiconductor can also function as an automatic control device for the secondary battery to resolve causes of instability, such as a micro-short circuit. Examples of functions of resolving the causes of instability of a secondary battery include prevention of overcharge, prevention of overcurrent, control of overheating during charging, holding of cell balance of an assembled battery, prevention of overdischarge, a battery indicator, automatic control of charge voltage and current amount according to temperature, control of the amount of charge current according to the degree of deterioration, abnormal behavior detection for a micro-short circuit, and anomaly prediction regarding a micro-short circuit; the control circuit portion 1320 has at least one of these functions. Furthermore, the automatic control device for the secondary battery can be extremely small in size.

A micro-short circuit refers to a minute short circuit caused in a secondary battery and refers not to a state where the positive electrode and the negative electrode of a secondary battery are short-circuited so that charge and discharge are impossible, but to a phenomenon in which a slight short-circuit current flows through a minute short-circuit portion. Since a large voltage change is caused even when a micro-short circuit occurs in a relatively short time in a minute area, the abnormal voltage value might adversely affect later estimation of charge and discharge state and the like of the secondary battery.

One of the causes of a micro-short circuit is as follows: a plurality of charge and discharge cause an uneven distribution of positive electrode active materials, which leads to local concentration of current in part of the positive electrode and part of the negative electrode, whereby part of a separator stops functioning or a by-product is generated by a side reaction, which is thought to generate a micro short-circuit.

It can be said that the control circuit portion 1320 not only detects a micro-short circuit but also senses terminal voltage of the secondary battery and controls the charge and discharge state of the secondary battery. For example, to prevent overcharge, an output transistor of a charge circuit and an interruption switch can be turned off substantially at the same time.

FIG. 34B illustrates an example of a block diagram of the battery pack 1415 illustrated in FIG. 34A.

The control circuit portion 1320 includes a switch portion 1324 that includes at least a switch for preventing overcharge and a switch for preventing overdischarge, a control circuit 1322 for controlling the switch portion 1324, and a portion for measuring the voltage of the first battery 1301a. The control circuit portion 1320 is set to have the upper limit voltage and the lower limit voltage of the secondary battery to be used, and imposes the upper limit of current from the outside, the upper limit of output current to the outside, and the like. The range from the lower limit voltage to the upper limit voltage of the secondary battery falls within the recommended voltage range; when a voltage falls outside the range, the switch portion 1324 operates and functions as a protection circuit. The control circuit portion 1320 can also be referred to as a protection circuit because it controls the switch portion 1324 to prevent overdischarge and overcharge. For example, when the control circuit 1322 detects a voltage that is likely to cause overcharge, current is interrupted by turning off the switch in the switch portion 1324. Furthermore, a function of interrupting current in accordance with a temperature rise may be set by providing a PTC element in the charge and discharge path. The control circuit portion 1320 includes an external terminal 1325 (+IN) and an external terminal 1326 (−IN).

The switch portion 1324 can be formed by a combination of an n-channel transistor and a p-channel transistor. The switch portion 1324 is not limited to a switch including a Si transistor using single crystal silicon; the switch portion 1324 may be formed using, for example, a power transistor containing Ge (germanium), SiGe (silicon germanium), GaAs (gallium arsenide), GaAlAs (gallium aluminum arsenide), InP (indium phosphide), SiC (silicon carbide), ZnSe (zinc selenide), GaN (gallium nitride), GaOₓ (gallium oxide, where x is a real number greater than 0), or the like. A memory element using an OS transistor can be freely placed by being stacked over a circuit using a Si transistor, for example; hence, integration can be easy. Furthermore, an OS transistor can be fabricated with a manufacturing apparatus similar to that for a Si transistor and thus can be fabricated at low cost. That is, the control circuit portion 1320 using an OS transistor can be stacked over the switch portion 1324 so that they can be integrated into one chip. Since the volume occupied by the control circuit portion 1320 can be reduced, a reduction in size is possible.

The first batteries 1301a and 1301b mainly supply electric power to in-vehicle devices for 42 V (for a high-voltage system), and the second battery 1311 supplies electric power to in-vehicle devices for 14 V (for a low-voltage system).

In this embodiment, an example in which a lithium-ion secondary battery is used as both the first battery 1301a and the second battery 1311 is described. As the second battery 1311, a lead storage battery, an all-solid-state battery, or an electric double layer capacitor may be used. For example, the all-solid-state battery in Embodiment 4 may be used. The use of the all-solid-state battery in Embodiment 4 as the second battery 1311 can achieve high capacity and reduction in size and weight.

Regenerative energy generated by rolling of tires 1316 is transmitted to the motor 1304 through a gear 1305, and is stored in the second battery 1311 from a motor controller 1303 and a battery controller 1302 through a control circuit portion 1321. Alternatively, the regenerative energy is stored in the first battery 1301a from the battery controller 1302 through the control circuit portion 1320. Alternatively, the regenerative energy is stored in the first battery 1301b from the battery controller 1302 through the control circuit portion 1320. For efficient charge with regenerative energy, the first batteries 1301a and 1301b are desirably capable of fast charge.

The battery controller 1302 can set the charge voltage, charge current, and the like of the first batteries 1301a and 1301b. The battery controller 1302 can set charge conditions in accordance with charge characteristics of a secondary battery to be used, so that fast charge can be performed.

Although not illustrated, when the electric vehicle is connected to an external charger, an outlet of the charger or a connection cable of the charger is electrically connected to the battery controller 1302. Electric power supplied from the external charger is stored in the first batteries 1301a and 1301b through the battery controller 1302. Some chargers are provided with a control circuit, in which case the function of the battery controller 1302 is not used; to prevent overcharge, the first batteries 1301a and 1301b are preferably charged through the control circuit portion 1320. In addition, the outlet of the charger or the connection cable of the charger is sometimes provided with a control circuit. The control circuit portion 1320 is also referred to as an ECU (Electronic Control Unit). The ECU is connected to a CAN (Controller Area Network) provided in the electric vehicle. The CAN is a type of a serial communication standard used as an in-vehicle LAN. The ECU includes a microcomputer. Moreover, the ECU uses a CPU or a GPU.

External chargers installed at charge stations and the like have a 100 V outlet, a 200 V outlet, and a three-phase 200 V outlet with 50 kW, for example. Furthermore, charge can be performed with electric power supplied from external charge equipment by a contactless power feeding method or the like.

For fast charge, secondary batteries that can withstand high-voltage charge have been desired to perform charge in a short time.

The above-described secondary battery in this embodiment uses the positive electrode active material 100 obtained in the above embodiment. Moreover, it is possible to achieve a secondary battery in which graphene is used as a conductive material, an electrode layer is formed thick to increase the loading amount while suppressing a reduction in capacity, and the electrical characteristics are significantly improved in synergy with maintenance of high capacity. This secondary battery is particularly effectively used in a vehicle; it is possible to provide a vehicle that has a long cruising range, specifically one charge mileage of 500 km or greater, without increasing the proportion of the weight of the secondary battery to the weight of the entire vehicle.

Specifically, in the above-described secondary battery in this embodiment, the use of the positive electrode active material 100 described in the above embodiment can increase the operating voltage of the secondary battery, and the increase in charge voltage can increase the available capacity. Moreover, using the positive electrode active material 100 described in the above embodiment in the positive electrode can provide an automotive secondary battery having excellent cycle performance.

Next, examples in which the secondary battery of one embodiment of the present invention is mounted on a vehicle, typically a transport vehicle, will be described.

Mounting the secondary battery illustrated in any one of FIG. 25D, FIG. 27C, and FIG. 34A on vehicles can achieve next-generation clean energy vehicles such as hybrid vehicles (HVs), electric vehicles (EVs), and plug-in hybrid vehicles (PHVs). The secondary battery can also be mounted on transport vehicles such as agricultural machines, motorized bicycles including motor-assisted bicycles, motorcycles, electric wheelchairs, electric carts, boats and ships, submarines, aircraft such as fixed-wing aircraft and rotary-wing aircraft, rockets, artificial satellites, space probes, planetary probes, and spacecraft. The secondary battery of one embodiment of the present invention can be a secondary battery with high capacity. Thus, the secondary battery of one embodiment of the present invention is suitable for reduction in size and reduction in weight and is preferably used in transport vehicles.

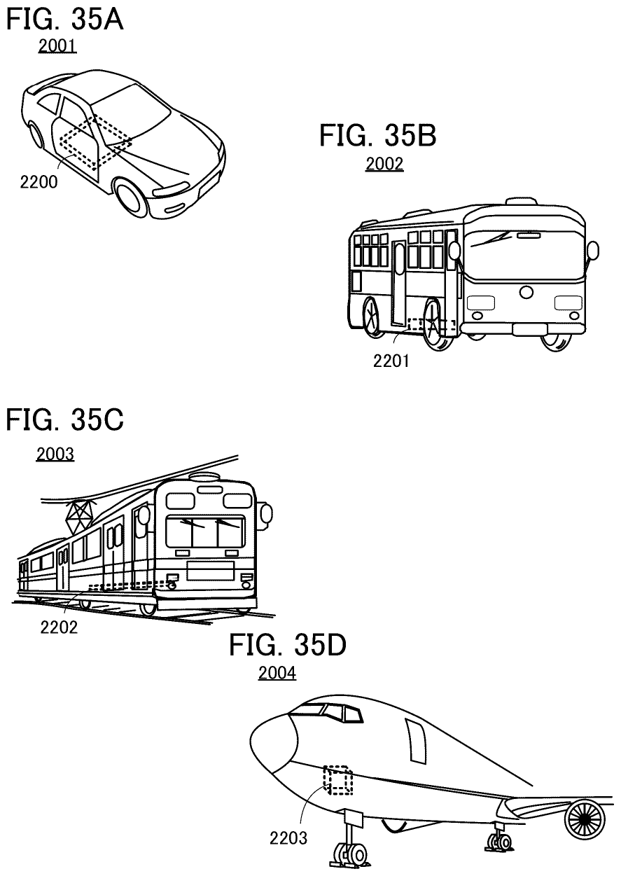

FIG. 35A to FIG. 35D illustrate examples of transport vehicles as examples of vehicles using one embodiment of the present invention. A motor vehicle 2001 illustrated in FIG. 35A is an electric vehicle that runs using an electric motor as a driving power source. Alternatively, the motor vehicle 2001 is a hybrid vehicle that can appropriately select an electric motor or an engine as a driving power source. In the case where the secondary battery is mounted on the vehicle, an example of the secondary battery described in Embodiment 3 is provided at one position or several positions. The motor vehicle 2001 illustrated in FIG. 35A includes a battery pack 2200, and the battery pack includes a secondary battery module in which a plurality of secondary batteries are connected to each other. Moreover, the battery pack preferably includes a charge control device that is electrically connected to the secondary battery module.

The motor vehicle 2001 can be charged when the secondary battery included in the motor vehicle 2001 is supplied with electric power from external charge equipment by a plug-in system, a contactless charge system, or the like. In charging, a given method such as CHAdeMO (registered trademark) or Combined Charging System may be employed as a charge method, the standard of a connector, and the like as appropriate. A charge apparatus may be a charge station provided in a commerce facility or a household power supply. For example, with the use of the plug-in system, the power storage device mounted on the motor vehicle 2001 can be charged by being supplied with electric power from the outside. Charge can be performed by converting AC power into DC power through a converter such as an ACDC converter.

Although not illustrated, the vehicle can include a power receiving device so as to be charged by being supplied with electric power from an above-ground power transmitting device in a contactless manner. For the contactless power feeding system, by fitting a power transmitting device in a road or an exterior wall, charge can be performed not only when the vehicle is stopped but also when driven. In addition, the contactless power feeding system may be utilized to perform transmission and reception of electric power between two vehicles. Furthermore, a solar cell may be provided in the exterior of the vehicle to charge the secondary battery when the vehicle stops and moves. To supply electric power in such a contactless manner, an electromagnetic induction method or a magnetic resonance method can be used.

FIG. 35B illustrates a large transporter 2002 having a motor controlled by electricity, as an example of a transport vehicle. The secondary battery module of the transporter 2002 has a cell unit of four secondary batteries with a nominal voltage of 3.0 V or higher and 5.0 V or lower, and 48 cells are connected in series to have 170 V as the maximum voltage. A battery pack 2201 has the same function as that in FIG. 35A except, for example, the number of secondary batteries configuring the secondary battery module; thus, the description is omitted.

FIG. 35C illustrates a large transport vehicle 2003 having a motor controlled by electricity as an example. A secondary battery module of the transport vehicle 2003 has 100 or more secondary batteries with a nominal voltage of 3.0 V or higher and 5.0 V or lower connected in series, and the maximum voltage is 600 V, for example. When a secondary battery including the positive electrode active material 100 described in the above embodiment for a positive electrode is used, a secondary battery having favorable rate performance and charge and discharge cycle performance can be manufactured, which can contribute to higher performance and a longer lifetime of the transport vehicle 2003. A battery pack 2202 has the same function as that in FIG. 35A except, for example, the number of secondary batteries configuring the secondary battery module; thus, the description is omitted.

FIG. 35D illustrates an aircraft 2004 having a combustion engine as an example. The aircraft 2004 illustrated in FIG. 35D can be regarded as a kind of transport vehicles since it is provided with wheels for takeoff and landing, and has a battery pack 2203 including a secondary battery module and a charge control device; the secondary battery module includes a plurality of connected secondary batteries.

The secondary battery module of the aircraft 2004 has eight 4 V secondary batteries connected in series, which has the maximum voltage of 32 V, for example. The battery pack 2203 has the same function as that in FIG. 35A except, for example, the number of secondary batteries configuring the secondary battery module; thus, the description is omitted.

The contents in this embodiment can be combined with the contents in the other embodiments as appropriate.

### Embodiment 6

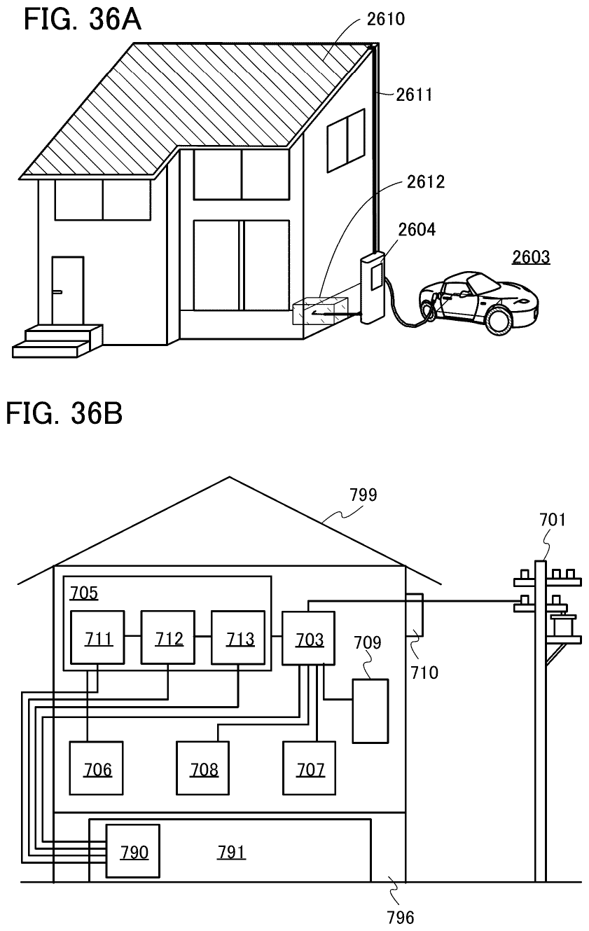

In this embodiment, examples in which the secondary battery of one embodiment of the present invention is mounted on a building will be described with reference to FIG. 36A and FIG. 36B.

A house illustrated in FIG. 36A includes a power storage device 2612 including the secondary battery of one embodiment of the present invention and a solar panel 2610. The power storage device 2612 is electrically connected to the solar panel 2610 through a wiring 2611 or the like. The power storage device 2612 may be electrically connected to ground-based charge apparatus 2604. The power storage device 2612 can be charged with electric power generated by the solar panel 2610. A secondary battery included in a vehicle 2603 can be charged with the electric power stored in the power storage device 2612 through the charge apparatus 2604. The power storage device 2612 is preferably provided in an underfloor space. The power storage device 2612 is provided in the underfloor space, in which case the space on the floor can be effectively used. Alternatively, the power storage device 2612 may be provided on the floor.

The electric power stored in the power storage device 2612 can also be supplied to other electronic devices in the house. Thus, with the use of the power storage device 2612 of one embodiment of the present invention as an uninterruptible power source, electronic devices can be used even when electric power cannot be supplied from a commercial power source due to power failure or the like.

FIG. 36B illustrates an example of a power storage device of one embodiment of the present invention. As illustrated in FIG. 36B, a power storage device 791 of one embodiment of the present invention is provided in an underfloor space 796 of a building 799. The power storage device 791 may be provided with the control circuit described in Embodiment 5, and the use of a secondary battery including a positive electrode using the positive electrode active material 100 obtained in the above embodiment for the power storage device 791 enables the power storage device 791 to have a long lifetime.

The power storage device 791 is provided with a control device 790, and the control device 790 is electrically connected to a distribution board 703, a power storage controller 705 (also referred to as a control device), an indicator 706, and a router 709 through wirings.

Electric power is transmitted from a commercial power source 701 to the distribution board 703 through a service wire mounting portion 710. Moreover, electric power is transmitted to the distribution board 703 from the power storage device 791 and the commercial power source 701, and the distribution board 703 supplies the transmitted electric power to a general load 707 and a power storage load 708 through outlets (not illustrated).

The general load 707 is, for example, an electric device such as a TV or a personal computer. The power storage load 708 is, for example, an electric device such as a microwave, a refrigerator, or an air conditioner.

The power storage controller 705 includes a measuring portion 711, a predicting portion 712, and a planning portion 713. The measuring portion 711 has a function of measuring the amount of electric power consumed by the general load 707 and the power storage load 708 during a day (e.g., from midnight to midnight). The measuring portion 711 may have a function of measuring the amount of electric power of the power storage device 791 and the amount of electric power supplied from the commercial power source 701. The predicting portion 712 has a function of predicting, on the basis of the amount of electric power consumed by the general load 707 and the power storage load 708 during a given day, the demand for electric power consumed by the general load 707 and the power storage load 708 during the next day. The planning portion 713 has a function of making a charge and discharge plan of the power storage device 791 on the basis of the demand for electric power predicted by the predicting portion 712.

The amount of electric power consumed by the general load 707 and the power storage load 708 and measured by the measuring portion 711 can be checked with the indicator 706. It can be checked with an electric device such as a TV or a personal computer through the router 709. Furthermore, it can be checked with a portable electronic terminal such as a smartphone or a tablet through the router 709. With the indicator 706, the electric device, or the portable electronic terminal, for example, the demand for electric power depending on a time period (or per hour) that is predicted by the predicting portion 712 can be checked.

The contents in this embodiment can be combined with the contents in the other embodiments as appropriate.

### Embodiment 7

In this embodiment, examples in which a motorcycle and a bicycle are each provided with the power storage device of one embodiment of the present invention will be described.

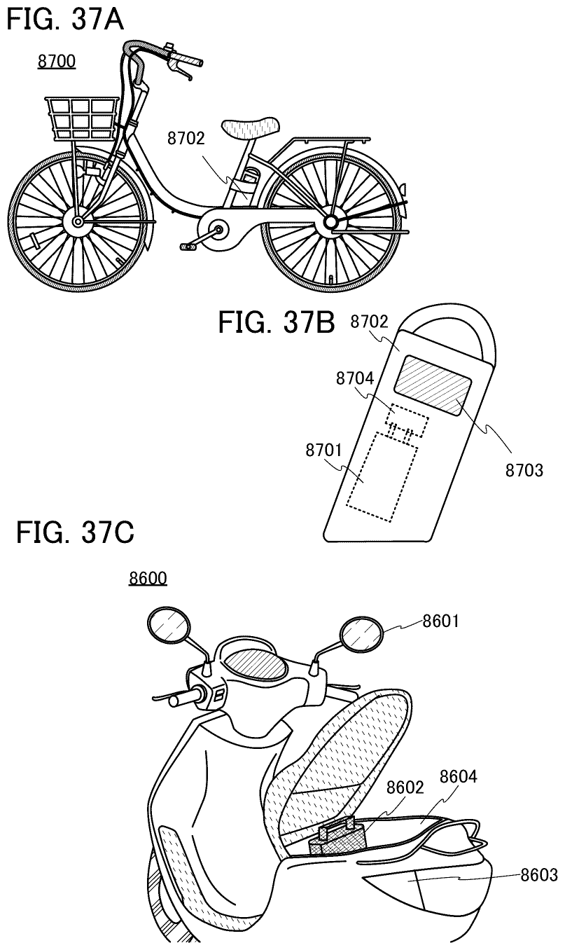

FIG. 37A illustrates an example of an electric bicycle using the power storage device of one embodiment of the present invention. The power storage device of one embodiment of the present invention can be used for an electric bicycle 8700 illustrated in FIG. 37A. The power storage device of one embodiment of the present invention includes a plurality of storage batteries and a protection circuit, for example.

The electric bicycle 8700 includes a power storage device 8702. The power storage device 8702 can supply electricity to a motor that assists a rider. The power storage device 8702 is portable, and FIG. 37B illustrates the state where the power storage device 8702 is detached from the bicycle. A plurality of storage batteries 8701 included in the power storage device of one embodiment of the present invention are incorporated in the power storage device 8702, and the remaining battery capacity and the like can be displayed on a display portion 8703. The power storage device 8702 includes a control circuit 8704 capable of charge control or anomaly detection for the secondary battery, which is exemplified in Embodiment 5. The control circuit 8704 is electrically connected to a positive electrode and a negative electrode of the storage battery 8701. The control circuit 8704 may be provided with the small solid-state secondary battery illustrated in FIG. 33A and FIG. 33B. When the small solid-state secondary battery illustrated in FIG. 33A and FIG. 33B is provided in the control circuit 8704, electric power can be supplied to store data in a memory circuit included in the control circuit 8704 for a long time. When the control circuit 8704 is used in combination with the secondary battery including the positive electrode active material 100 obtained in the above embodiment in the positive electrode, the synergy on safety can be obtained. The secondary battery including the positive electrode active material 100 obtained in the above embodiment in the positive electrode and the control circuit 8704 can greatly contribute to elimination of accidents due to secondary batteries, such as fires.

FIG. 37C illustrates an example of a motorcycle using the power storage device of one embodiment of the present invention. A motor scooter 8600 illustrated in FIG. 37C includes a power storage device 8602, side mirrors 8601, and indicator lights 8603. The power storage device 8602 can supply electricity to the indicator lights 8603. The power storage device 8602 including a plurality of secondary batteries including a positive electrode using the positive electrode active material 100 obtained in the above embodiment can have high capacity and contribute to a reduction in size.

In the motor scooter 8600 illustrated in FIG. 37C, the power storage device 8602 can be stored in an under-seat storage unit 8604. The power storage device 8602 can be stored in the under-seat storage unit 8604 even with a small size.

The contents in this embodiment can be combined with the contents in the other embodiments as appropriate.

### Embodiment 8

In this embodiment, examples of electronic devices each including the secondary battery of one embodiment of the present invention will be described. Examples of the electronic device including the secondary battery include a television device (also referred to as a television or a television receiver), a monitor of a computer and the like, a digital camera, a digital video camera, a digital photo frame, a mobile phone (also referred to as a cellular phone or a mobile phone device), a portable game machine, a portable information terminal, an audio reproducing device, and a large-sized game machine such as a pachinko machine. Examples of the portable information terminal include a laptop personal computer, a tablet terminal, an e-book reader, and a mobile phone.

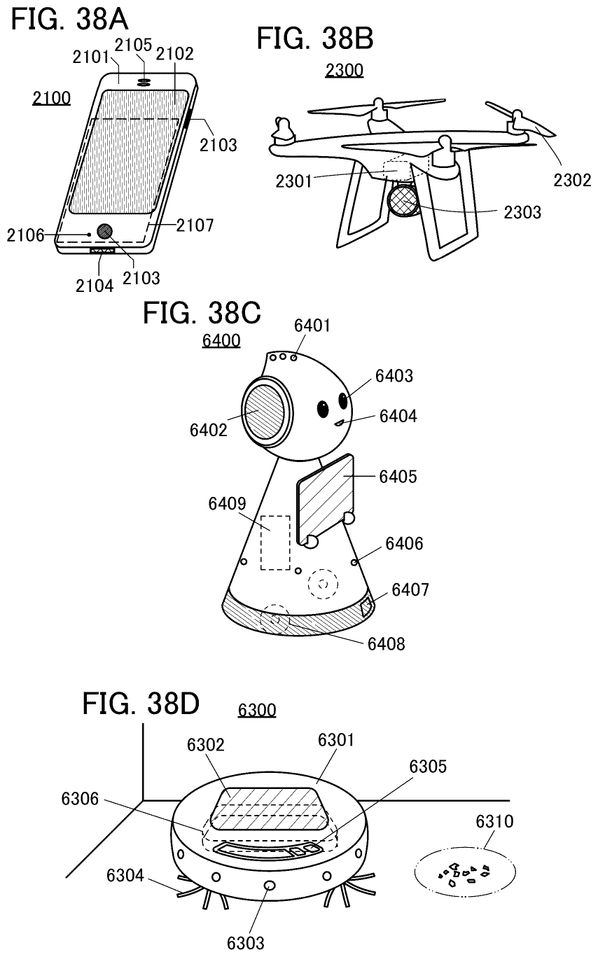

FIG. 38A illustrates an example of a mobile phone. A mobile phone 2100 includes a housing 2101 in which a display portion 2102 is incorporated, operation buttons 2103, an external connection port 2104, a speaker 2105, a microphone 2106, and the like. The mobile phone 2100 includes a secondary battery 2107. The use of the secondary battery 2107 including a positive electrode using the positive electrode active material 100 described in the above embodiment achieves high capacity and a structure that accommodates space saving due to a reduction in size of the housing.

The mobile phone 2100 is capable of executing a variety of applications such as mobile phone calls, e-mailing, viewing and editing texts, music reproduction, Internet communication, and a computer game.

With the operation button 2103, a variety of functions such as time setting, power on/off, on/off of wireless communication, setting and cancellation of a silent mode, and setting and cancellation of a power saving mode can be performed. For example, the functions of the operation button 2103 can be set freely by the operating system incorporated in the mobile phone 2100.

The mobile phone 2100 can employ near field communication conformable to a communication standard. For example, mutual communication between the mobile phone 2100 and a headset capable of wireless communication enables hands-free calling.

Moreover, the mobile phone 2100 includes the external connection port 2104, and data can be directly transmitted to and received from another information terminal via a connector. In addition, charge can be performed via the external connection port 2104. Note that the charge operation may be performed by wireless power feeding without using the external connection port 2104.

The mobile phone 2100 preferably includes a sensor. As the sensor, a human body sensor such as a fingerprint sensor, a pulse sensor, or a temperature sensor, a touch sensor, a pressure sensitive sensor, or an acceleration sensor is preferably mounted, for example.

FIG. 38B illustrates an unmanned aircraft 2300 including a plurality of rotors 2302. The unmanned aircraft 2300 is sometimes also referred to as a drone. The unmanned aircraft 2300 includes a secondary battery 2301 of one embodiment of the present invention, a camera 2303, and an antenna (not illustrated). The unmanned aircraft 2300 can be remotely controlled through the antenna. A secondary battery including a positive electrode using the positive electrode active material 100 obtained in the above embodiment has high energy density and a high level of safety, and thus can be used safely for a long time over a long period of time and is preferable as the secondary battery included in the unmanned aircraft 2300.

FIG. 38C illustrates an example of a robot. A robot 6400 illustrated in FIG. 38C includes a secondary battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like.

The microphone 6402 has a function of detecting a speaking voice of a user, an environmental sound, and the like. The speaker 6404 has a function of outputting sound. The robot 6400 can communicate with the user using the microphone 6402 and the speaker 6404.

The display portion 6405 has a function of displaying various kinds of information. The robot 6400 can display information desired by the user on the display portion 6405. The display portion 6405 may be provided with a touch panel. Moreover, the display portion 6405 may be a detachable information terminal, in which case charge and data communication can be performed when the display portion 6405 is set at the home position of the robot 6400.

The upper camera 6403 and the lower camera 6406 each have a function of taking an image of the surroundings of the robot 6400. The obstacle sensor 6407 can detect an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 further includes, in its inner region, the secondary battery 6409 of one embodiment of the present invention and a semiconductor device or an electronic component. A secondary battery including a positive electrode using the positive electrode active material 100 obtained in the above embodiment has high energy density and a high level of safety, and thus can be used safely for a long time over a long period of time and is preferable as the secondary battery 6409 included in the robot 6400.

FIG. 38D illustrates an example of a cleaning robot. A cleaning robot 6300 includes a display portion 6302 placed on the top surface of a housing 6301, a plurality of cameras 6303 placed on the side surface of the housing 6301, a brush 6304, operation buttons 6305, a secondary battery 6306, a variety of sensors, and the like. Although not illustrated, the cleaning robot 6300 is provided with a tire, an inlet, and the like. The cleaning robot 6300 is self-propelled, detects dust 6310, and sucks up the dust through the inlet provided on the bottom surface.

For example, the cleaning robot 6300 can determine whether there is an obstacle such as a wall, furniture, or a step by analyzing images taken by the cameras 6303. In the case where the cleaning robot 6300 detects an object, such as a wire, that is likely to be caught in the brush 6304 by image analysis, the rotation of the brush 6304 can be stopped. The cleaning robot 6300 includes, in its inner region, the secondary battery 6306 of one embodiment of the present invention and a semiconductor device or an electronic component. A secondary battery including a positive electrode using the positive electrode active material 100 obtained in the above embodiment has high energy density and a high level of safety, and thus can be used safely for a long time over a long period of time and is preferable as the secondary battery 6306 included in the cleaning robot 6300.

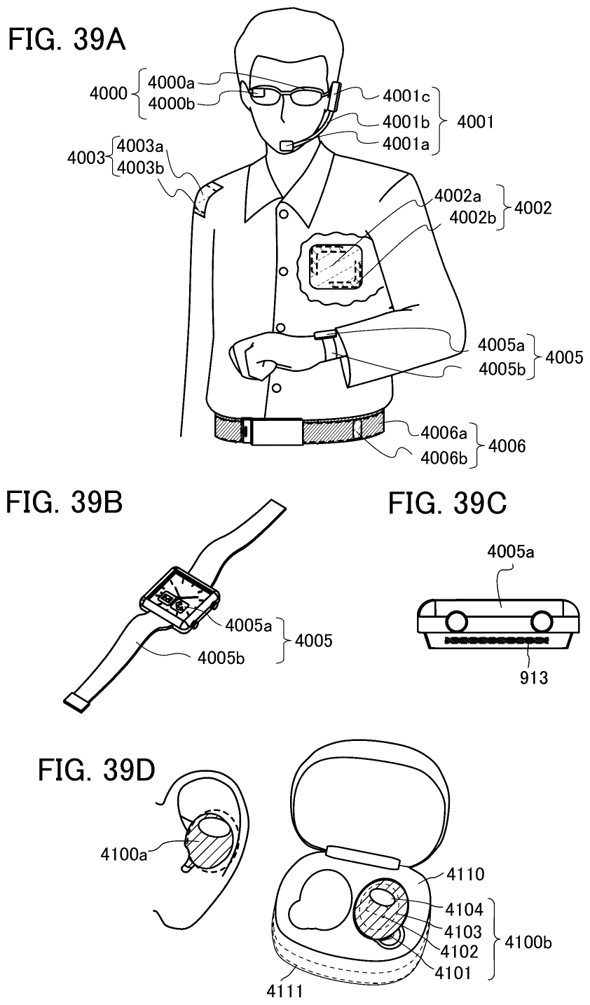

FIG. 39A illustrates examples of wearable devices. A secondary battery is used as a power source of a wearable device. To have improved splash resistance, water resistance, or dust resistance in daily use or outdoor use by a user, a wearable device is desirably capable of being charged with and without a wire whose connector portion for connection is exposed. For example, the secondary battery of one embodiment of the present invention can be provided in a glasses-type device 4000 illustrated in FIG. 39A. The glasses-type device 4000 includes a frame 4000a and a display portion 4000b. The secondary battery is provided in a temple portion of the frame 4000a having a curved shape, whereby the glasses-type device 4000 can be lightweight, can have a well-balanced weight, and can be used continuously for a long time. A secondary battery including a positive electrode using the positive electrode active material 100 obtained in the above embodiment has high energy density and achieves a structure that accommodates space saving due to a reduction in size of the housing.

The secondary battery of one embodiment of the present invention can be provided in a headset-type device 4001. The headset-type device 4001 includes at least a microphone portion 4001a, a flexible pipe 4001b, and an earphone portion 4001c. The secondary battery can be provided in the flexible pipe 4001b or the earphone portion 4001c. A secondary battery including a positive electrode using the positive electrode active material 100 obtained in the above embodiment has high energy density and achieves a structure that accommodates space saving due to a reduction in size of the housing.

The secondary battery of one embodiment of the present invention can be provided in a device 4002 that can be attached directly to a body. A secondary battery 4002b can be provided in a thin housing 4002a of the device 4002. A secondary battery including a positive electrode using the positive electrode active material 100 obtained in the above embodiment has high energy density and achieves a structure that accommodates space saving due to a reduction in size of the housing.

The secondary battery of one embodiment of the present invention can be provided in a device 4003 that can be attached to clothes. A secondary battery 4003b can be provided in a thin housing 4003a of the device 4003. A secondary battery including a positive electrode using the positive electrode active material 100 obtained in the above embodiment has high energy density and achieves a structure that accommodates space saving due to a reduction in size of the housing.

The secondary battery of one embodiment of the present invention can be provided in a belt-type device 4006. The belt-type device 4006 includes a belt portion 4006a and a wireless power feeding and receiving portion 4006b, and the secondary battery can be provided in the inner region of the belt portion 4006a. A secondary battery including a positive electrode using the positive electrode active material 100 obtained in the above embodiment has high energy density and achieves a structure that accommodates space saving due to a reduction in size of the housing.

The secondary battery of one embodiment of the present invention can be provided in a watch-type device 4005. The watch-type device 4005 includes a display portion 4005a and a belt portion 4005b, and the secondary battery can be provided in the display portion 4005a or the belt portion 4005b. A secondary battery including a positive electrode using the positive electrode active material 100 obtained in the above embodiment has high energy density and achieves a structure that accommodates space saving due to a reduction in size of the housing.

The display portion 4005a can display various kinds of information such as time and reception information of an e-mail and an incoming call.

The watch-type device 4005 is a wearable device that is wound around an arm directly; thus, a sensor that measures the pulse, the blood pressure, or the like of the user may be incorporated therein. Data on the exercise quantity and health of the user can be stored to be used for health maintenance.

FIG. 39B illustrates a perspective view of the watch-type device 4005 that is detached from an arm.

FIG. 39C illustrates a side view. FIG. 39C illustrates a state where the secondary battery 913 is incorporated in the inner region. The secondary battery 913 is the secondary battery described in Embodiment 3. The secondary battery 913 is provided to overlap with the display portion 4005a, can have high density and high capacity, and is small and lightweight.

Since the secondary battery in the watch-type device 4005 is required to be small and lightweight, the use of the positive electrode active material 100 obtained in the above embodiment in the positive electrode of the secondary battery 913 enables the secondary battery 913 to have high energy density and a small size.

FIG. 39D illustrates an example of wireless earphones. The wireless earphones illustrated here as an example consist of, but not limited to, a pair of main bodies 4100a and 4100b.

The main bodies 4100a and 4100b each include a driver unit 4101, an antenna 4102, and a secondary battery 4103. A display portion 4104 may also be included. Moreover, a substrate where a circuit such as a wireless IC is provided, a terminal for charge, and the like are preferably included. Furthermore, a microphone may be included.

A case 4110 includes a secondary battery 4111. Moreover, a substrate where a circuit such as a wireless IC or a charge control IC is provided, and a terminal for charge are preferably included. Furthermore, a display portion, a button, and the like may be included.

The main bodies 4100a and 4100b can communicate wirelessly with another electronic device such as a smartphone. Thus, sound data and the like transmitted from another electronic device can be played through the main bodies 4100a and 4100b. When the main bodies 4100a and 4100b include a microphone, sound captured by the microphone is transmitted to another electronic device, and sound data obtained by processing with the electronic device can be transmitted to and played through the main bodies 4100a and 4100b. Hence, the wireless earphones can be used as a translator, for example.

The secondary battery 4103 included in the main body 4100a can be charged by the secondary battery 4111 included in the case 4110. As the secondary battery 4111 and the secondary battery 4103, the coin-type secondary battery or the cylindrical secondary battery of the foregoing embodiment, for example, can be used. A secondary battery including a positive electrode using the positive electrode active material 100 obtained in the above embodiment has a high energy density; thus, with the use of the secondary battery as the secondary battery 4103 and the secondary battery 4111, a structure that accommodates space saving due to a reduction in size of the wireless earphones can be achieved.

This embodiment can be implemented in appropriate combination with the other embodiments.

### REFERENCE NUMERALS

81: cobalt source, 82: first additive element source, 83: chelate agent, 84: alkaline solution, 85: water, 88: lithium source, 89: second additive element source, 90: third additive element source, 91: acidic solution, 92: precipitate, 94: mixture, 95: cobalt compound, 97: mixture, 98: composite oxide, 99: composite oxide, 100: positive electrode active material, 100a: surface portion, 100b: inner portion

1-3. (canceled)

4. A method for forming a positive electrode active material, comprising the steps of:
mixing a cobalt source and a first additive element source to form an acidic solution;
making the acidic solution and an alkaline solution react to form a cobalt compound;
mixing the cobalt compound and a lithium source to form a first mixture;
heating the first mixture to form a composite oxide;
mixing the composite oxide and a second additive element source to form a second mixture; and
heating the second mixture,
wherein the first additive element source comprises one or more selected from gallium, aluminum, boron, nickel, and indium, and
wherein the second additive element source comprises one or more selected from nickel, cobalt, magnesium, calcium, fluorine, aluminum, manganese, titanium, zirconium, yttrium, vanadium, chromium, niobium, lanthanum, hafnium, zinc, silicon, sulfur, phosphorus, and boron.

5. A method for forming a positive electrode active material, comprising the steps of:
making a cobalt source and an alkaline solution react to form a cobalt compound;
mixing the cobalt compound and a lithium source to form a first mixture;
heating the first mixture to form a composite oxide;
mixing the composite oxide, a first additive element source, and a second additive element source to form a second mixture; and
heating the second mixture,
wherein the first additive element source comprises one or more selected from gallium, aluminum, boron, nickel, and indium, and
wherein the second additive element source comprises one or more selected from nickel, cobalt, magnesium, calcium, fluorine, aluminum, manganese, titanium, zirconium, yttrium, vanadium, chromium, niobium, lanthanum, hafnium, zinc, silicon, sulfur, phosphorus, and boron.

6. A method for forming a positive electrode active material, comprising the steps of:
mixing a cobalt source and a first additive element source to form an acidic solution;
making the acidic solution and an alkaline solution react to form a cobalt compound;
mixing the cobalt compound and a lithium source to form a first mixture;
heating the first mixture to form a first composite oxide;
mixing the first composite oxide and a second additive element source to form a second mixture;
heating the second mixture to form a second composite oxide;
mixing the second composite oxide and a third additive element source to form a third mixture; and
heating the third mixture,
wherein the first additive element source comprises one or more selected from gallium, aluminum, boron, nickel, and indium,
wherein the second additive element source and the third additive element source comprise one or more selected from nickel, cobalt, magnesium, calcium, fluorine, aluminum, manganese, titanium, zirconium, yttrium, vanadium, chromium, niobium, lanthanum, hafnium, zinc, silicon, sulfur, phosphorus, and boron, and
wherein an element included in the second additive element source is different from an element included in the third additive element source.

7. A method for forming a positive electrode active material, comprising the steps of:
making a cobalt source and an alkaline solution react to form a cobalt compound;
mixing the cobalt compound and a lithium source to form a first mixture;
heating the first mixture to form a first composite oxide;
mixing the first composite oxide and a first additive element source to form a second mixture;
heating the second mixture to form a second composite oxide;
mixing the second composite oxide, a second additive element source, and a third additive element source to form a third mixture; and
heating the third mixture,
wherein the first additive element source and the third additive element source comprise one or more selected from nickel, cobalt, magnesium, calcium, fluorine, aluminum, manganese, titanium, zirconium, yttrium, vanadium, chromium, niobium, lanthanum, hafnium, zinc, silicon, sulfur, phosphorus, and boron,
wherein an element included in the first additive element source is different from an element included in the third additive element source, and
wherein the second additive element source comprises one or more selected from gallium, aluminum, boron, nickel, and indium.

8. The method for forming a positive electrode active material according to claim 4,
wherein the alkaline solution comprises an aqueous solution comprising sodium hydroxide, potassium hydroxide, lithium hydroxide, or ammonia.

9. The method for forming a positive electrode active material according to claim 8,
wherein resistivity of water used for the aqueous solution is 1 MΩ·cm or higher.

10. (canceled)

11. The method for forming a positive electrode active material according to claim 4,
wherein the first additive element source comprises gallium sulfate, gallium chloride, or gallium nitrate.

12. The method for forming a positive electrode active material according to claim 7,
wherein the second additive element source comprises gallium sulfate, gallium chloride, or gallium nitrate.

13. The method for forming a positive electrode active material according to claim 4,
wherein a temperature at which the second mixture is heated is lower than a temperature at which the first mixture is heated.

14. The method for forming a positive electrode active material according to claim 6,
wherein a temperature at which the third mixture is heated is lower than a temperature at which the first mixture is heated.

15. The method for forming a positive electrode active material according to 5,
wherein the alkaline solution comprises an aqueous solution comprising sodium hydroxide, potassium hydroxide, lithium hydroxide, or ammonia.

16. The method for forming a positive electrode active material according to claim 15,
wherein resistivity of water used for the aqueous solution is 1 MΩ·cm or higher.

17. The method for forming a positive electrode active material according to 6,
wherein the alkaline solution comprises an aqueous solution comprising sodium hydroxide, potassium hydroxide, lithium hydroxide, or ammonia.

18. The method for forming a positive electrode active material according to claim 17,
wherein resistivity of water used for the aqueous solution is 1 MΩ·cm or higher.

19. The method for forming a positive electrode active material according to 7,
wherein the alkaline solution comprises an aqueous solution comprising sodium hydroxide, potassium hydroxide, lithium hydroxide, or ammonia.

20. The method for forming a positive electrode active material according to claim 19,
wherein resistivity of water used for the aqueous solution is 1 MΩ·cm or higher.

21. The method for forming a positive electrode active material according to claim 5,
wherein the first additive element source comprises gallium sulfate, gallium chloride, or gallium nitrate.

22. The method for forming a positive electrode active material according to claim 6,
wherein the first additive element source comprises gallium sulfate, gallium chloride, or gallium nitrate.

23. The method for forming a positive electrode active material according to claim 5,
wherein a temperature at which the second mixture is heated is lower than a temperature at which the first mixture is heated.

24. The method for forming a positive electrode active material according to claim 7,
wherein a temperature at which the third mixture is heated is lower than a temperature at which the first mixture is heated.
